(19) United States
(12) Patent Application Publication
(10) Pub. No.: US 2024/0322465 A1
(43) Pub. Date: Sep. 26, 2024

(54) HIGH DENSITY CARD EDGE CONNECTOR WITH HYBRID INTERFACE

(71) Applicant: Amphenol Commercial Products (Chengdu) Co., Ltd., Chengdu (CN)

(72) Inventors: Peng Huang, Chengdu (CN); Luyun Yi, Chengdu (CN); Zhineng Fan, Volente, TX (US); Chao Zou, Chengdu (CN)

(73) Assignee: Amphenol Commercial Products (Chengdu) Co., Ltd., Chengdu (CN)

(21) Appl. No.: 18/610,079

(22) Filed: Mar. 19, 2024

(30) Foreign Application Priority Data
Mar. 20, 2023 (CN) 202320548593.X
Sep. 27, 2023 (CN) 202311267334.0
Sep. 27, 2023 (CN) 202322635316.5

(51) Int. Cl. H01R 12/72; H01R 13/04; H01R 13/502; H01R 13/6471

(52) U.S. Cl. CPC H01R 12/721; H01R 13/04; H01R 13/502; H01R 13/6471

(57) ABSTRACT

High density card edge connectors with hybrid interface for both signal and power transmissions. The connectors can provide both high-quality, high-speed signal transmission and high power transmission, while being backward compatible with physical requirements set by already defined industry standards (e.g., current version of SFF-TA-1002—Rev 1.3). A connector can have a type of conductive elements configured for high speed signal transmission (e.g., up to 112 GT/s), and another type of conductive elements configured for high power transmission (e.g., up to 200 W) while still satisfying the requirements on the quality of signals transmitted by the signal conductive elements at high speed. The connector housing can have multiple ports and wider channels in at least one port, such that signal and power conductive elements can be disposed in a same port with the power conductive elements disposed in the wider channels and signal conductive elements disposed outside the wider channels.

### CROSS-REFERENCE TO RELATED APPLICATIONS

This application claims priority to and the benefit of Chinese Patent Application No. 202322635316.5, filed on Sep. 27, 2023. This application also claims priority to and the benefit of Chinese Patent Application No. 202311267334.0, filed on Sep. 27, 2023. This application also claims priority to and the benefit of Chinese Patent Application No. 202320548593.X, filed on Mar. 20, 2023. The contents of these applications are incorporated herein by reference in their entirety.

### FIELD

The present application relates to interconnection systems, such as those including electrical connectors, configured to interconnect electronic assemblies.

### BACKGROUND

Electrical connectors are used in many electrical systems. Electronic devices have been provided with assorted types of connectors whose primary purpose is to enable data, commands, power and/or other signals to pass between electronic assemblies. A connector that carries both signals and power is sometimes called a hybrid connector. It is generally easier and more cost effective to manufacture an electrical system as separate electronic assemblies that may be joined with electrical connectors. For example, one type of electronic assembly is a printed circuit board (“PCB”). The terms “card” and “PCB” may be used interchangeably herein.

In some scenarios, a two-piece connector is used to join two assemblies. One connector may be mounted to each of the assemblies. The connectors may be mated, forming connections between the two assemblies.

In some other scenarios, a PCB may be joined directly to another electronic assembly via a one-piece connector, which may be configured as a card edge connector. The PCB may have pads along an edge that is designed to be inserted into an electrical connector attached to another assembly. Contacts within the electrical connector may contact the pads, thus connecting the PCB to the other assembly.

As will be appreciated, the connections provided by the electrical connectors are electrical connections that may communicate electrical signals and/or electrical power (e.g., electrical current and/or voltage).

The connectors and PCBs are typically designed and manufactured according to industry standards regarding aspects such as the mating interfaces with each other and signal and power requirements. For example, current version of SFF-TA-1002 (Rev 1.3) uses the same types of conductive elements for signals and power.

### BRIEF SUMMARY

Aspects of the present application relate to high density card edge connector with hybrid interface.

Some embodiments relate to an electrical connector. The electrical connector may include a housing comprising a mating face having an upper wall and a lower wall, first and second slots in the mating face and between the upper wall and lower wall, and a divider joining the upper wall and lower wall and separating the first slot and second slot, wherein the upper wall comprises a first channel connected to the first slot, and the lower wall comprises a second channel connected to the first slot; and a plurality of conductive elements held by the housing, each of the plurality of conductive elements comprising a mating end having a mating contact portion curving into the first slot or the second slot, a mounting end opposite to the mating end, and an intermediate portion joining the mating end and the mounting end. The plurality of conductive elements may comprise first conductive elements and second conductive elements. Each first conductive element may be wider than each second conductive element. The first conductive elements may be disposed in the first channel or second channel.

Optionally, the first conductive elements are configured for power transmission in the range of 25 W to 200 W; and the second conductive elements are configured for signal transmission at a speed in the range of 25 GT/s to 112 GT/s.

Optionally, the first conductive elements are disposed between a first portion of the second conductive elements and a second portion of the second conductive elements; the mating contact portions of the mating ends of the first portion of the second conductive elements and the first conductive elements curve into the first slot; and the mating contact portions of the mating ends of the second portion of the second conductive elements curve into the second slot.

Optionally, the mating contact portions of the plurality of first conductive elements are disposed in first rows on opposite sides of the first slot; the mating contact portions of the plurality of second conductive elements are disposed in second rows aligned with respective first rows; and the mating contact portion of each first conductive element is wider than the mating contact portion of each second conductive element.

Optionally, for each first conductive element: the mating end comprises a first contact finger and two second contact fingers; the first contact finger comprises a mating contact portion; each of the two second contact fingers comprises a mating contact portion narrower than the mating contact portion of the first contact finger; and the first contact finger is disposed closer to the divider than the two second contact fingers.

Optionally, the mating contact portions of the first contact finger and an adjacent second contact finger of the two second contact fingers are separated from each other by a first pitch; and the mating contact portions of the two second contact fingers are separated from each other by a second pitch that is less than the first pitch.

Optionally, the mounting end comprises mounting legs extending from the intermediate portion out of the housing, and the intermediate portion comprises an edge extending between the mounting legs.

Optionally, the housing comprises an integral member configured to retain the first conductive element in the housing; and the integral member of the housing comprises openings through which the mounting legs extend out of the housing.

Optionally, the electrical connector may further include an insulative member inserted in the housing, wherein: the housing further comprises a second face opposite to the mating face, and a mounting slot in the second face and connected to the first channel and the second channel; and the insulative member comprises a supporting portion disposed in the mounting slot such that the intermediate portion of the first conductive element is disposed between the supporting portion of the insulative member and a respective one of the first and second bulges of the upper and lower walls of the housing.

Optionally, the supporting portion of the insulative member comprises a first protrusion extending into a space between the mounting legs and engaging the edge of the intermediate portion extending therebetween so as to restrain movement of the intermediate portion toward the second face of the housing.

Optionally, the upper wall of the housing comprises a first bulge bounding the first channel; and the lower wall of the housing comprises a second bulge bounding the second channel.

Optionally, each first conductive element comprises a plurality of metal sheets.

Optionally, each first conductive element is thicker than each second conductive element.

Some embodiments relate to an electronic system. The electronic system may include any of the electrical connector described herein; and a printed circuit board comprising an edge inserted into the electrical connector, the edge of the printed circuit board comprising a first portion inserted into the first slot of the electrical connector, a second portion inserted into the second slot of the electrical connector, and a notch receiving the divider, the first portion of the edge comprising signal contact pads and at least one power contact pad aligned along the edge. Each of the at least one power contact pad may span a width that corresponds to a plurality of the signal contact pads.

Some embodiments relate to a lead assembly. The lead assembly may include a unitary housing comprising a first segment and a second segment extending from the first segment; a plurality of first conductive elements held by the first segment of the housing, each of the plurality of first conductive element comprising a mating end having a mating contact portion, a mounting end opposite to the mating end, and an intermediate portion joining the mating end to the mounting end; and a plurality of second conductive elements held by the second segment of the housing, each of the plurality of second conductive element comprising a mating end having a plurality of mating contact portions, a mounting end opposite to the mating end, and an intermediate portion joining the mating end to the mounting end. The mating contact portions of the plurality of second conductive elements may be separated from each other by a center-to-center distance. For each of the plurality of first conductive elements, the mating contact portions may be separated from each other by a center-to-center distance that is greater than the center-to-center distance of the mating contact portions of the plurality of second conductive elements.

Optionally, each mating contact portion of the plurality of first conductive element is wider than the mating contact portion of each of the plurality of second conductive element.

Optionally, each of the plurality of first conductive elements is configured for power transmission; and at least a portion of the plurality of second conductive elements is configured for signal transmission.

Optionally, for each first conductive element: the mating end comprises a first contact finger and a second contact finger narrower than the first contact finger and disposed closer to the plurality of second conductive elements than the first contact finger.

Optionally, the first contact finger comprises a mating contact portion; the mating end comprises two second contact fingers each comprising a mating contact portion; and the two second contact fingers are disposed closer to the plurality of second conductive elements than the first contact finger.

Optionally, the mating contact portions of the first contact finger and an adjacent second contact finger of the two second contact fingers are separated from each other by a first pitch; and the mating contact portions of the two second contact fingers are separated from each other by a second pitch that is less than the first pitch.

Optionally, the intermediate portion is disposed on the first segment of the housing; each of the first contact finger and second contact finger comprises a straight portion, a curved portion, and a mating contact portion; and for each of the first contact finger and second contact finger: the straight portion extends from the intermediate portion away from the first segment of the housing; the curved portion connects the straight portion and the contact portion; and the mating contact portion extends from the curved portion towards the first segment of the housing.

Optionally, for each first conductive element: the mounting end comprises two mounting legs each extending from the intermediate portion, the two mounting legs comprising opposing edges; the intermediate portion comprises an edge extending between the two mounting legs; and the first segment of the housing comprises a supporting portion having a protrusion extending into a space between the two mounting legs and abutting both the opposing edges of the two mounting legs and the edge of the intermediate portion.

Optionally, the first segment of the housing further comprises a retaining portion extending from the supporting portion; and the retaining portion surrounds and retains a portion of each of the two mounting legs of the first conductive element.

Some embodiments relate to a printed circuit board. The printed circuit board may include a first surface; a second surface opposite the first surface; and an edge joining the first surface and second surface. Each of the first surface and second surface may comprise a plurality of contact pads aligned along the edge joining the first surface and second surface. A first portion of the plurality of contact pads may be disposed according to a standard and comprise a power contact pad spanning locations of a plurality of contact pads according to the standard.

Some embodiments relate to an electrical connector. The electrical connector may include an insulative housing comprising: first face; a first slot and a second slot recessed into the insulative housing from the first face in a lateral direction, respectively, and separated in a longitudinal direction perpendicular to the lateral direction by a divider of the insulative housing; a first wall and a second wall separated in a vertical direction perpendicular to the lateral direction and the longitudinal direction by the first slot, a portion of the first wall adjacent to the divider protruding outwardly away from the first slot to form a first bulge, and a portion of the second wall adjacent to the divider protruding outwardly away from the first slot to form a second bulge; and a first channel and a second channel extending into the first bulge and the second bulge, respectively, from the first slot in the vertical direction; a plurality of conductive elements each comprising a mating end having a mating contact portion, a mounting end opposite to the mating end, and an intermediate portion joining the mating end and the mounting end, the plurality of conductive elements held in the insulative housing with the mating contact portions of the mating ends exposed in the first slot and the second slot, wherein a plurality of first conductive elements of the plurality of conductive elements are disposed in the first channel and the second channel.

Optionally, the first slot comprises a first portion corresponding to the first channel and the second channel and a second portion extending from the first portion away from the divider in the longitudinal direction; the mating contact portions of the mating ends of the plurality of first conductive elements are exposed in the first portion; a plurality of second conductive elements of the plurality of conductive elements are disposed in the insulative housing in correspondence with the second portion with the mating contact portions of the plurality of second conductive elements exposed in the second portion; and each of the plurality of first conductive elements is configured for transmitting power, and at least a portion of the plurality of second conductive elements is configured for transmitting signal.

Optionally, a first portion of the plurality of second conductive elements is configured for transmitting signal, and a second portion of the plurality of second conductive elements is configured for transmitting power; and the second portion is positioned between the first portion and the plurality of first conductive elements in the longitudinal direction.

Optionally, the mating contact portions of the plurality of first conductive elements are arranged in at least two first rows in the longitudinal direction, and the mating contact portions of the plurality of second conductive elements are arranged in at least two second rows in the longitudinal direction, each of the at least two first rows and a corresponding one of the at least two second rows are aligned with and spaced apart from each other in the longitudinal direction; a pitch by which two adjacent mating contact portions in each first row are separated center-to-center from each other in the longitudinal direction is greater than a pitch by which two adjacent mating contact portions in each second row are separated center-to-center from each other in the longitudinal direction; and a width of the mating contact portion of each first conductive element in the longitudinal direction is greater than a width of the mating contact portion of each second conductive element in the longitudinal direction.

Optionally, the space by which two adjacent mating contact portions in each second row are separated center-to-center from each other in the longitudinal direction is 0.6 mm.

Optionally, the space by which two adjacent mating contact portions in each first row are separated center-to-center from each other in the longitudinal direction is greater than 1.5 times the space by which two adjacent mating contact portions in each second row are separated center-to-center from each other in the longitudinal direction.

Optionally, each of the first conductive elements comprises a first terminal member and a second terminal member, the first terminal member comprises a first base portion, and the second terminal member comprises a second base portion; and the first base portion and the second base portion are stacked on top of each other in the vertical direction, jointly forming the intermediate portion of the first conductive element.

Optionally, the insulative housing further comprises a second face opposite to the first face in the lateral direction and a plurality of arms extending from the second face in the lateral direction away from the insulative housing; and for each first conductive element, the intermediate portion is disposed between corresponding adjacent two arms of the plurality of arms and is held in position by the corresponding adjacent two arms relative to the insulative housing, such that the mating end is disposed in a corresponding one of the first channel and the second channel.

Optionally, the plurality of arms comprises adjacent first and second arms, and the first channel and the second channel are aligned with a space between the first and second arms in the lateral direction.

Optionally, for each first conductive element: the first terminal member further comprises at least one first contact finger extending into the first slot from the first base portion in the lateral direction, each first contact finger comprises a first end connected to the first base portion and a second end opposite to the first end; the second terminal member further comprises at least two second contact fingers extending into the first slot from the second base portion in the lateral direction, each second contact finger comprises a first end connected to the second base portion and a second end opposite to the first end; the at least one first contact finger and the at least two second contact fingers jointly form the mating end of the first conductive element, and each of the second ends of the at least one first contact finger and the at least two second contact fingers has a mating contact portion extending into the first slot; and the second ends of several first contact fingers of the at least one first contact finger are positioned between the second ends of corresponding adjacent two of the at least two second contact fingers.

Optionally, the mating contact portion of the second end of the at least one first contact finger and the mating contact portions of the second ends of the at least two second contact fingers are aligned with each other in the longitudinal direction, and a contact surface of the mating contact portion of the second end of the at least one first contact finger and contact surfaces of the mating contact portions of the second ends of the at least two second contact fingers are coplanar with each other.

Optionally, the first channel and the second channel extend from the first face through the insulative housing to a second face opposite to the first face in the lateral direction, respectively.

Optionally, the first channel and the second channel are aligned with each other in the vertical direction.

Optionally, the plurality of first conductive elements comprises a pair of first conductive elements, one of the pair of first conductive elements is disposed in the first channel and the other is disposed in the second channel.

Optionally, a plurality of third conductive elements of the plurality of conductive elements are disposed in the insulative housing in correspondence with the second slot with the mating contact portions of the mating ends of the plurality of third conductive elements exposed in the second slot, and at least a portion of the plurality of third conductive elements is configured for transmitting signal.

Optionally, for each first conductive element: the mating end of the first conductive element comprises at least one first contact finger and at least two second contact fingers, each of the at least one first contact finger and the at least two second contact fingers has a mating contact portion; the mating contact portion of each first contact finger has a first width in the longitudinal direction, and the mating contact portion of each second contact finger has a second width in the longitudinal direction, the first width is greater than the second width; and the at least one first contact finger is closer to the divider in the longitudinal direction than the at least two second contact fingers.

Optionally, for each first conductive element: the at least one first contact finger and the at least two second contact fingers are aligned with and spaced apart from each other in the longitudinal direction; and the mating contact portions of adjacent first and second contact fingers of the at least one first contact finger and the at least two second contact fingers are separated center-to-center from each other by a first pitch in the longitudinal direction, and the mating contact portions of two adjacent ones of the at least two second contact fingers are separated center-to-center from each other by a second pitch in the longitudinal direction, the first pitch is greater than the second pitch.

Optionally, for each first conductive element: the intermediate portion of the first conductive element is disposed in a corresponding one of the first channel and the second channel; and each of the at least one first contact finger and the at least two second contact fingers comprises a straight portion, a curved portion and a contact portion, the straight portion extends from the intermediate portion towards the first face in the lateral direction in the corresponding channel, the curved portion is connected between the straight portion and the contact portion, the contact portion extends from the curved portion away from the first face in the lateral direction and extends into the first slot, the mating contact portion is on the contact portion.

Optionally, for each first conductive element, the mating contact portions of the at least one first contact finger and the at least two second contact fingers are aligned with and spaced apart from each other in the longitudinal direction, and contact surfaces of the mating contact portions of the at least one first contact finger and the at least two second contact fingers are coplanar with each other.

Optionally, for each first conductive element, the straight portions of the at least one first contact finger and the at least two second contact fingers are aligned with and spaced apart from each other in the longitudinal direction.

Optionally, for each first conductive element, the widths of the straight, curved and contact portions of each first contact finger in the longitudinal direction are the same as each other.

Optionally, for each first conductive element, the widths of the straight, curved and contact portions of each second contact finger in the longitudinal direction are the same as each other.

Optionally, for each first conductive element, the at least one first contact finger and the at least two second contact fingers are aligned with each other in the longitudinal direction, each first contact finger has a first cross-section profile perpendicular to the longitudinal direction, and each second contact finger has a second cross-section profile perpendicular to the longitudinal direction, the first cross-section profile is the same as the second cross-section profile.

Optionally, for each first conductive element, the first conductive element is formed from a single piece of conductive material.

Optionally, for each first conductive element, the first width is at least 1.5 times the second width.

Optionally, for each first conductive element, the at least one first contact finger is a single first contact finger, and the at least two second contact fingers are two second contact fingers.

Optionally, the electrical connector further comprises an insulative assembly housing, the plurality of first conductive elements are held by the assembly housing, and the assembly housing is mounted to the insulative housing to retain the plurality of first conductive elements in the insulative housing.

Optionally, the insulative housing further comprises a second face opposite to the first face in the lateral direction, and a mounting slot recessed into the insulative housing from the second face in the lateral direction, the mounting slot is connected with the first channel and the second channel; and the assembly housing comprises a supporting portion, the intermediate portion of each of the plurality of first conductive elements is disposed on the supporting portion, and the supporting portion is inserted into the mounting slot such that the intermediate portion of each of the first conductive elements is sandwiched between the supporting portion and a bottom wall of a corresponding one of the first channel and the second channel.

Optionally, for each first conductive element: the mounting end of the first conductive element comprises at least two mounting legs each extending from the intermediate portion opposite to the mating end, the at least two mounting legs are aligned with and spaced apart from each other in the longitudinal direction, the intermediate portion comprises an edge portion extending between two adjacent ones of the at least two mounting legs; and the supporting portion comprises at least one first protrusion each extending into a space between corresponding adjacent two of the at least two mounting legs of the first conductive element and engaging with the edge portion of the intermediate portion between the corresponding adjacent two mounting legs to limit movement of the intermediate portion towards the second face relative to the insulative housing in the lateral direction.

Optionally, for each first conductive element, the corresponding adjacent two mounting legs comprise two side edges opposing to each other in the longitudinal direction, and the first protrusion engages the two side edges of the corresponding adjacent two mounting legs to limit the movement of the corresponding adjacent two mounting legs relative to the insulative housing in the longitudinal direction.

Optionally, for each first conductive element: the at least two mounting legs are arranged in a row in the longitudinal direction, the row has two ends opposite to each other in the longitudinal direction; and the supporting portion comprises two second protrusions each engaging, at a respective end of the two ends, with a side edge of a corresponding mounting leg located at the respective end to sandwich the row between the two second protrusions and to limit the movement of the row relative to the insulative housing in the longitudinal direction.

Optionally, for each first conductive element, each of the at least two mounting legs is disposed between corresponding adjacent two protrusions of the at least one first protrusion and the two second protrusions and is clamped by the corresponding adjacent two protrusions to limit the movement of the mounting legs relative to the insulative housing in the longitudinal direction.

Optionally, for each first conductive element, each of the at least two mounting legs comprises a first straight portion, a second straight portion and a curved portion, the first straight portion extends beyond the second face of the insulative housing from the intermediate portion in the lateral direction, the curved portion connects the first straight portion and the second straight portion and is curved such that the second straight portion is oriented in the vertical direction, the intermediate portion and the first straight portions of the at least two mounting legs are disposed on a supporting surface of the supporting portion, and the at least one first protrusion protrudes from the supporting surface; and the assembly housing further comprises a retaining portion extending from the supporting portion in the lateral direction, the retaining portion surrounds and retains a portion of the second straight portion of each of the at least two mounting legs of each of the plurality of first conductive elements to limit movement of the mounting leg towards the first face relative to the insulative housing in the lateral direction.

Optionally, the supporting portion comprises a first supporting surface and a second supporting surface opposite to each other in the vertical direction, the first supporting surface and the second supporting surface face the first channel and the second channel, respectively; and the plurality of first conductive elements comprise an upper first conductive element and a lower first conductive element, the upper first conductive element and the lower first conductive element are held in the first channel and the second channel by the assembly housing, respectively, with the intermediate portion of the upper first conductive element sandwiched between the first supporting surface and the bottom wall of the first channel, and with the intermediate portion of the lower first conductive element sandwiched between the second supporting surface and the bottom wall of the second channel.

Optionally, the curved portions of the at least two mounting legs of the lower first conductive element and the upper first conductive element are curved in the same direction, and the second straight portions of the at least two mounting legs of the lower first conductive element are closer to the second face of the insulative housing in the lateral direction than the second straight portions of the at least two mounting legs of the upper first conductive element; and the retaining portion comprises: a proximal portion adjacent to the second face, wherein the proximal portion is formed with at least two receiving slots, and the curved portion and a portion of the second straight portion adjacent to the curved portion of each of the at least two mounting legs of the lower first conductive element are disposed in a corresponding one of the at least two receiving slots so as to be surrounded and retained by the proximal portion; and/or a distal portion away from the second face, wherein the distal portion is formed with at least two receiving holes extending in the vertical direction, and the second straight portion of each of the at least two mounting legs of the upper first conductive element extends through a corresponding one of the at least two receiving hole so as to be surrounded and retained by the distal portion.

Optionally, the first slot comprises a first portion corresponding to the first channel and the second channel and a second portion extending from the first portion away from the divider in the longitudinal direction; the mating contact portions of the mating ends of the plurality of first conductive elements are exposed in the first portion; a plurality of second conductive elements of the plurality of conductive elements are disposed in the insulative housing in correspondence with the second portion with the mating contact portions of the plurality of second conductive elements exposed in the second portion; each of the plurality of first conductive elements is configured for transmitting power, and at least a portion of the plurality of second conductive elements is configured for transmitting signal; and the plurality of first conductive elements are held by a first segment of the assembly housing, and the assembly housing further comprises a second segment extending from the first segment in the longitudinal direction, the plurality of second conductive elements are held by the second segment.

Optionally, the insulative housing comprises a pair of retention arms extending from the second face in the lateral direction, the assembly housing is retained therebetween by the pair of retention arms so as to be mounted to the insulative housing.

Some embodiments relate to an electrical connector. The electrical connector may include an insulative housing comprising: a first face; a first slot and a second slot recessed into the insulative housing from the first face in a lateral direction, respectively, and separated in a longitudinal direction perpendicular to the lateral direction by a divider of the insulative housing; a first wall and a second wall separated by the first slot in a vertical direction perpendicular to the horizontal direction and the longitudinal direction; and a first channel and a second channel adjacent to the divider and extending into the first wall and the second wall from the first slot in the vertical direction, respectively; a plurality of first conductive elements each comprising a mating end, a mounting end opposite to the mating end, and an intermediate portion connecting the mating end and the mounting end, wherein the plurality of first conductive elements are disposed in the first accommodating groove and the second accommodating groove, and for each first conductive element: the mating end of the first conductive element comprises at least one first contact finger and at least two second contact fingers, each of the at least one first contact finger and the at least two second contact fingers has a mating contact portion exposed in the first slot; the mating contact portion of each first contact finger has a first width in the longitudinal direction, and the mating contact portion of each second contact finger has a second width in the longitudinal direction, the first width is greater than the second width; and the at least one first contact finger is closer to the divider in the longitudinal direction than the at least two second contact fingers.

Optionally, the first slot comprises a first portion corresponding to the first channel and the second channel and a second portion extending from the first portion away from the divider in the longitudinal direction; the mating contact portions of the mating ends of the plurality of first conductive elements are exposed in the first portion; the electrical connector further comprises a plurality of second conductive elements each comprising a mating end having a mating contact portion, a mounting end opposite to the mating end, and an intermediate portion connecting the mating end and the mounting end, the plurality of second conductive elements are disposed in the insulative housing in correspondence with the second portion with the mating contact portions of the plurality of second conductive elements exposed in the second portion; and each of the plurality of first conductive elements is configured for transmitting power, and at least a portion of the plurality of second conductive elements is configured for transmitting signal.

Optionally, a first portion of the plurality of second conductive elements is configured for transmitting signal, and a second portion of the plurality of second conductive elements is configured for transmitting power; and the second portion is positioned between the first portion and the plurality of first conductive elements in the longitudinal direction.

Optionally, the mating contact portions of the plurality of first conductive elements are arranged in at least two first rows in the longitudinal direction, and the mating contact portions of the plurality of second conductive elements are arranged in at least two second rows in the longitudinal direction, each of the at least two first rows and a corresponding one of the at least two second rows are aligned with and spaced apart from each other in the longitudinal direction; a pitch by which two adjacent mating contact portions in each first row are separated center-to-center from each other in the longitudinal direction is greater than a pitch by which two adjacent mating contact portions in each second row are separated center-to-center from each other in the longitudinal direction; and a width of the mating contact portion of each first conductive element in the longitudinal direction is greater than a width of the mating contact portion of each second conductive element in the longitudinal direction.

Optionally, the space by which two adjacent mating contact portions in each first row are separated center-to-center from each other in the longitudinal direction is greater than 1.5 times the space by which two adjacent mating contact portions in each second row are separated center-to-center from each other in the longitudinal direction.

Optionally, for each first conductive element: the at least one first contact finger and the at least two second contact fingers are aligned with and spaced apart from each other in the longitudinal direction; and the mating contact portions of adjacent first and second contact fingers of the at least one first contact finger and the at least two second contact fingers are separated center-to-center from each other by a first pitch in the longitudinal direction, and the mating contact portions of two adjacent ones of the at least two second contact fingers are separated center-to-center from each other by a second pitch in the longitudinal direction, the first pitch is greater than the second pitch.

Optionally, for each first conductive element: the intermediate portion of the first conductive element is disposed in a corresponding one of the first channel and the second channel; and each of the at least one first contact finger and the at least two second contact fingers comprises a straight portion, a curved portion and a contact portion, the straight portion extends from the intermediate portion towards the first face in the lateral direction in the corresponding channel, the curved portion is connected between the straight portion and the contact portion, the contact portion extends from the curved portion away from the first face in the lateral direction and extends into the first slot, the mating contact portion is on the contact portion.

Optionally, for each first conductive element, the mating contact portions of the at least one first contact finger and the at least two second contact fingers are aligned with and spaced apart from each other in the longitudinal direction, and contact surfaces of the mating contact portions of the at least one first contact finger and the at least two second contact fingers are coplanar with each other.

Optionally, for each first conductive element, the straight portions of the at least one first contact finger and the at least two second contact fingers are aligned with and spaced apart from each other in the longitudinal direction.

Optionally, for each first conductive element, the widths of the straight, curved and contact portions of each first contact finger in the longitudinal direction are the same as each other.

Optionally, for each first conductive element, the widths of the straight, curved and contact portions of each second contact finger in the longitudinal direction are the same as each other.

Optionally, for each first conductive element, the at least one first contact finger and the at least two second contact fingers are aligned with each other in the longitudinal direction, each first contact finger has a first cross-section profile perpendicular to the longitudinal direction, and each second contact finger has a second cross-section profile perpendicular to the longitudinal direction, the first cross-section profile is the same as the second cross-section profile.

Optionally, for each first conductive element, the first conductive element is formed from a single piece of conductive material.

Optionally, for each first conductive element, the first width is at least 1.5 times the second width.

Optionally, for each first conductive element, the at least one first contact finger is a single first contact finger and the at least two second contact fingers are two second contact fingers.

Optionally, the electrical connector further comprises an insulative assembly housing, the plurality of first conductive elements are held by the assembly housing, and the assembly housing is mounted to the insulative housing to retain the plurality of first conductive elements in the insulative housing.

Optionally, the insulative housing further comprises a second face opposite to the first face in the lateral direction, and a mounting slot recessed into the insulative housing from the second face in the lateral direction, the mounting slot is connected with the first channel and the second channel; and the assembly housing comprises a supporting portion, the intermediate portion of each of the plurality of first conductive elements is disposed on the supporting portion, and the supporting portion is inserted into the mounting slot such that the intermediate portion of each of the first conductive elements is sandwiched between the supporting portion and a bottom wall of a corresponding one of the first channel and the second channel.

Optionally, for each first conductive element: the mounting end of the first conductive element comprises at least two mounting legs each extending from the intermediate portion opposite to the mating end, the at least two mounting legs are aligned with and spaced apart from each other in the longitudinal direction, the intermediate portion comprises an edge portion extending between adjacent mounting two of the at least two mounting legs; and the supporting portion comprises at least one first protrusion each extending into a space between corresponding adjacent two of the at least two mounting legs of the first conductive element and engaging with the edge portion of the intermediate portion between the corresponding adjacent two mounting legs to limit movement of the intermediate portion towards the second face relative to the insulative housing in the lateral direction.

Optionally, for each first conductive element, the corresponding adjacent two mounting legs comprise two side edges opposing to each other in the longitudinal direction, and the first protrusion engages the two side edges of the corresponding adjacent two mounting legs to limit the movement of the corresponding adjacent two mounting legs relative to the insulative housing in the longitudinal direction.

Optionally, for each first conductive element: the at least two mounting legs are arranged in a row in the longitudinal direction, the row has two ends opposite to each other in the longitudinal direction; and the supporting portion comprises two second protrusions each engaging, at a respective end of the two ends, with a side edge of the mounting leg located at the respective end to sandwich the row between the two second protrusions and to limit the movement of the row relative to the insulative housing in the longitudinal direction.

Optionally, for each first conductive element: each of the at least two mounting legs is disposed between corresponding adjacent two protrusions of the at least one first protrusion and the two second protrusions and is clamped by the corresponding adjacent two protrusions to limit the movement of the mounting legs relative to the insulative housing in the longitudinal direction.

Optionally, for each first conductive element, each of the at least two mounting legs comprises a first straight portion, a second straight portion and a curved portion, the first straight portion extends beyond the second face of the insulative housing from the intermediate portion in the lateral direction, the curved portion connects the first straight portion and the second straight portion and is curved such that the second straight portion is oriented in the vertical direction, the intermediate portion and the first straight portions of the at least two mounting legs are disposed on a supporting surface of the supporting portion, and the at least one first protrusion protrudes from the supporting surface; and the assembly housing further comprises a retaining portion extending from the supporting portion in the lateral direction, the retaining portion surrounds and retains a portion of the second straight portion of each of the at least two mounting legs of each of the plurality of first conductive elements to limit movement of the mounting leg towards the first face relative to the insulative housing in the lateral direction.

Optionally, the supporting portion comprises a first supporting surface and a second supporting surface opposite to each other in the vertical direction, the first supporting surface and the second supporting surface face the first channel and the second channel, respectively; and the plurality of first conductive elements comprises an upper first conductive element and a lower first conductive element, the upper first conductive element and the lower first conductive element are held in the first channel and the second channel by the assembly housing, respectively, with the intermediate portion of the upper first conductive element sandwiched between the first supporting surface and the bottom wall of the first channel, and with the intermediate portion of the lower first conductive element sandwiched between the second supporting surface and the bottom wall of the second channel.

Optionally, the curved portions of the at least two mounting legs of the lower first conductive element and the upper first conductive element are curved in the same direction, and the second straight portions of the at least two mounting legs of the lower first conductive element are closer to the second face of the insulative housing in the lateral direction than the second straight portions of the at least two mounting legs of the upper first conductive element; and the retaining portion comprises: a proximal portion adjacent to the second face, wherein the proximal portion is formed with at least two receiving slots, and the curved portion and a portion of the second straight portion adjacent to the curved portion of each of the at least two mounting legs of the lower first conductive element are disposed in a corresponding one of the at least two receiving slots so as to be surrounded and retained by the proximal portion; and/or a distal portion away from the second face, wherein the distal portion is formed with at least two receiving holes extending in the vertical direction, and the second straight portion of each of the at least two mounting legs of the upper first conductive element extends through a corresponding one of the at least two receiving hole so as to be surrounded and retained by the distal portion.

Optionally, the first slot comprises a first portion corresponding to the first channel and the second channel and a second portion extending from the first portion away from the divider in the longitudinal direction; the mating contact portions of the mating ends of the plurality of first conductive elements are exposed in the first portion; the electrical connector further comprises a plurality of second conductive elements each comprising a mating end having a mating contact portion, a mounting end opposite to the mating end, and an intermediate portion connecting the mating end and the mounting end, the plurality of second conductive elements are disposed in the insulative housing in correspondence with the second portion with the mating contact portions of the plurality of second conductive elements exposed in the second portion; each of the plurality of first conductive elements is configured for transmitting power, and at least a portion of the plurality of second conductive elements is configured for transmitting signal; and the plurality of first conductive elements are held by a first segment of the assembly housing, and the assembly housing further comprises a second segment extending from the first portion in the longitudinal direction, the plurality of second conductive elements are held by the second segment.

Optionally, the insulative housing comprises a pair of retention arms extending from the second face in the lateral direction, the assembly housing is retained therebetween by the pair of retention arms so as to be mounted to the insulative housing.

Optionally, the first channel and the second channel extend from the first face through the insulative housing to a second face opposite to the first face in the lateral direction, respectively.

Optionally, the first channel and the second channel are aligned with each other in the vertical direction.

Optionally, the plurality of first conductive elements comprises a pair of first conductive elements, one of the pair of first conductive elements is disposed in the first channel and the other is disposed in the second channel.

Optionally, the electrical connector further comprises a plurality of third conductive elements disposed in the insulative housing in correspondence with the second slot with the mating contact portions of the mating ends of the plurality of third conductive elements exposed in the second slot, and at least a portion of the plurality of third conductive elements is configured for transmitting signal.

Some embodiments relate to a lead assembly for an electrical connector. The lead assembly may include an insulative assembly housing comprising a first segment and a second segment extending from the first segment in a longitudinal direction; a plurality of first conductive elements held by the first segment, each first conductive element comprising a mating end having a mating contact portion, a mounting end opposite to the mating end, and an intermediate portion connecting the mating end to the mounting end; and a plurality of second conductive elements held by the second segment, each second conductive element comprising a mating end having a mating contact portion, a mounting end opposite to the mating end, and an intermediate portion connecting the mating end to the mounting end; the mating contact portions of the plurality of first conductive elements are arranged in at least two first rows in the longitudinal direction, and the mating contact portions of the plurality of second conductive elements are arranged in at least two second rows in the longitudinal direction, each of the at least two first rows and a corresponding one of the at least two second rows are aligned with and spaced apart from each other in the longitudinal direction; a pitch by which two adjacent mating contact portions in each first row are separated center-to-center from each other in the longitudinal direction is greater than a pitch by which two adjacent mating contact portions in each second row are separated center-to-center from each other in the longitudinal direction; and a width of the mating contact portion of each first conductive element in the longitudinal direction is greater than a width of the mating contact portion of each second conductive element in the longitudinal direction.

Optionally, each of the plurality of first conductive elements is configured for transmitting power, and at least a portion of the plurality of second conductive elements is configured for transmitting signal.

Optionally, a first portion of the plurality of second conductive elements is configured for transmitting signal, and a second portion of the plurality of second conductive elements is configured for transmitting power; and the second portion is positioned between the first portion and the plurality of first conductive elements in the longitudinal direction.

Optionally, the space by which two adjacent mating contact portions in each first row are separated center-to-center from each other in the longitudinal direction is greater than 1.5 times the space by which two adjacent mating contact portions in each second row are separated center-to-center from each other in the longitudinal direction.

Optionally, for each first conductive element: the mating end of the first conductive element comprises at least one first contact finger and at least two second contact fingers, each of the at least one first contact finger and the at least two second contact fingers has a mating contact portion; the mating contact portion of each first contact finger has a first width in the longitudinal direction, and the mating contact portion of each second contact finger has a second width in the longitudinal direction, the first width is greater than the second width; and the at least two second contact fingers are closer to the plurality of second conductive elements in the longitudinal direction than the at least one first contact finger.

Optionally, for each first conductive element: the at least one first contact finger and the at least two second contact fingers are aligned with and spaced apart from each other in the longitudinal direction; and the mating contact portions of adjacent first and second contact fingers of the at least one first contact finger and the at least two second contact fingers are separated center-to-center from each other by a first pitch in the longitudinal direction, and the mating contact portions of two adjacent ones of the at least two second contact fingers are separated center-to-center from each other by a second pitch in the longitudinal direction, the first pitch is greater than the second pitch.

Optionally, for each first conductive element: the intermediate portion of the first conductive element is disposed on the first segment; and each of the at least one first contact finger and the at least two second contact fingers comprises a straight portion, a curved portion and a contact portion, the straight portion extends from the intermediate portion away from the first segment in a lateral direction perpendicular to the longitudinal direction, the curved portion is connected between the straight portion and the contact portion, the contact portion extends from the curved portion towards the first segment in the lateral direction, the mating contact portion is on the contact portion.

Optionally, for each first conductive element, the mating contact portions of the at least one first contact finger and the at least two second contact fingers are aligned with and spaced apart from each other in the longitudinal direction, and contact surfaces of the mating contact portions of the at least one first contact finger and the at least two second contact fingers are coplanar with each other.

Optionally, for each first conductive element, the straight portions of the at least one first contact finger and the at least two second contact fingers are aligned with and spaced apart from each other in the longitudinal direction.

Optionally, for each first conductive element, the widths of the straight, curved and contact portions of each first contact finger in the longitudinal direction are the same as each other.

Optionally, for each first conductive element, the widths of the straight, curved and contact portions of each second contact finger in the longitudinal direction are the same as each other.

Optionally, for each first conductive element, the at least one first contact finger and the at least two second contact fingers are aligned with each other in the longitudinal direction, each first contact finger has a first cross-section profile perpendicular to the longitudinal direction, and each second contact finger has a second cross-section profile perpendicular to the longitudinal direction, the first cross-section profile is the same as the second cross-section profile.

Optionally, for each first conductive element, the first conductive element is formed from a single piece of conductive material.

Optionally, for each first conductive element, the first width is at least 1.5 times the second width.

Optionally, for each first conductive element, the at least one first contact finger is a single first contact finger and the at least two second contact fingers are two second contact fingers.

Optionally, the first segment of the assembly housing comprises a supporting portion, and the intermediate portion of each of the plurality of first conductive elements is disposed on the supporting portion; and for each first conductive element: the mounting end of the first conductive element comprises at least two mounting legs each extending from the intermediate portion opposite to the mating end, the at least two mounting legs are aligned with and spaced apart from each other in the longitudinal direction, the intermediate portion comprises an edge portion extending between two adjacent ones of the at least two mounting legs; and the supporting portion comprises at least one first protrusion each extending into a space between corresponding adjacent two of the at least two mounting legs of the first conductive element and engaging with the edge portion of the intermediate portion between the corresponding adjacent two mounting legs.

Optionally, for each first conductive element, the corresponding adjacent two mounting legs comprise two side edges opposing to each other in the longitudinal direction, and the first protrusion engages the two side edges of the corresponding adjacent two mounting legs.

Optionally, for each first conductive element: the at least two mounting legs are arranged in a row in the longitudinal direction, the row has two ends opposite to each other in the longitudinal direction; and the supporting portion comprises two second protrusions each engaging, at a respective end of the two ends, with a side edge of a corresponding mounting leg located at the respective end to sandwich the row between the two second protrusions.

Optionally, for each first conductive element, each of the at least two mounting legs is disposed between corresponding adjacent two protrusions of the at least one first protrusion and the two second protrusions and is clamped by the corresponding adjacent two protrusions.

Optionally, for each first conductive element, each of the at least two mounting legs comprises a first straight portion, a second straight portion and a curved portion, the first straight portion extends from the intermediate portion in a lateral direction perpendicular to the longitudinal direction, the curved portion connects the first straight portion and the second straight portion and is curved such that the second straight portion is oriented in a vertical direction perpendicular to the longitudinal direction and the lateral direction, the intermediate portion and the first straight portions of the at least two mounting legs are disposed on a supporting surface of the supporting portion, and the at least one first protrusion protrudes from the supporting surface; and the assembly housing further comprises a retaining portion extending from the supporting portion in the lateral direction, the retaining portion surrounds and retains a portion of the second straight portion of each of the at least two mounting legs of each of the plurality of first conductive elements.

Optionally, the supporting portion comprises a first supporting surface and a second supporting surface opposite to each other in the vertical direction; and the plurality of first conductive elements comprises an upper first conductive element and a lower first conductive element, the intermediate portion of the upper first conductive element is disposed on the first supporting surface and the intermediate portion of the lower first conductive element is disposed on the second supporting surface.

Optionally, the curved portions of the at least two mounting legs of the lower first conductive element and the upper first conductive element are curved in the same direction, and the second straight portions of the at least two mounting legs of the lower first conductive element are closer to the supporting portion in the lateral direction than the second straight portions of the at least two mounting legs of the upper first conductive element; and the retaining portion comprises: a proximal portion adjacent to the supporting portion, wherein the proximal portion is formed with at least two receiving slots, and the curved portion and a portion of the second straight portion adjacent to the curved portion of each of the at least two mounting legs of the lower first conductive element are disposed in a corresponding one of the at least two receiving slots so as to be surrounded and retained by the proximal portion; and/or a distal portion away from the supporting portion, wherein the distal portion is formed with at least two receiving holes extending in the vertical direction, and the second straight portion of each of the at least two mounting legs of the upper first conductive element extends through a corresponding one of the at least two receiving hole so as to be surrounded and retained by the distal portion.

Some embodiments relate to an electrical connector. The electrical connector may include an insulative housing comprising a first face and a second face opposite to each other in a lateral direction, a first slot recessed into the insulative housing from the first face in the lateral direction, and a plurality of arms extending from the second face away from the insulative housing in the lateral direction; and at least one first conductive element each comprising a mating end having a mating contact portion, a mounting end opposite to the mating end, and an intermediate portion connecting the mating end to the mounting end.

Optionally, for each first conductive element, the intermediate portion is disposed between corresponding adjacent two arms of the plurality of arms and is held in position relative to the insulative housing by the corresponding adjacent two arms such that the mating contact portion of the mating end is exposed in the first slot.

Optionally, for each first conductive element, the intermediate portion comprises a first segment having a first edge and a second edge, the first edge and the second edge are opposite to each other in a longitudinal direction perpendicular to the lateral direction and extending respectively in the lateral direction; the corresponding adjacent two arms comprise a first arm and a second arm, the first arm comprises a first arm surface and a first receiving slot recessed into the first arm from the first arm surface and extending in the lateral direction, and the second arm comprises a second arm surface and a second receiving slot recessed into the second arm from the second arm surface and extending in the lateral direction, the first arm surface and the second arm surface face each other in the longitudinal direction, and the first receiving slot and the second receiving slot are aligned with each other in the longitudinal direction; and the first edge and the second edge are received and held in the first receiving slot and the second receiving slot, respectively.

Optionally, each first conductive element is configured to be inserted into the insulative housing in the lateral direction from a space between the corresponding adjacent two arms such that the intermediate portion is inserted between the corresponding adjacent two arms; the first edge and the second edge are formed with a first barb feature and a second barb feature, respectively; and when the intermediate portion is inserted between the corresponding adjacent two arms, the first barb feature engages the first receiving slot in the lateral direction and the second barb feature engages the second receiving slot in the lateral direction to limit the withdrawal of the intermediate portion in the lateral direction.

Optionally, the intermediate portion of each first conductive element further comprises a second segment extending from the first segment in the lateral direction, the second segment is configured to enter a space between the corresponding adjacent two arms prior to the first segment when the intermediate portion is inserted between the corresponding adjacent two arms; the second segment has a third edge and a fourth edge opposite to each other in the longitudinal direction and extending in the lateral direction, respectively; and the third edge and the fourth edge are indented in the longitudinal direction relative to the first edge and the second edge, respectively, such that when the intermediate portion is inserted between the corresponding adjacent two arms, an indented portion between the third edge and the first edge engages the first receiving slot in the lateral direction and an indented portion between the fourth edge and the second edge engages the second receiving slot in the lateral direction to limit further insertion of the intermediate portion in the lateral direction.

Optionally, when the first edge and the second edge are inserted into the first receiving slot and the second receiving slot, respectively, the first edge engages the first receiving slot in the longitudinal direction and the second edge engages the second receiving slot in the longitudinal direction to limit the movement of the intermediate portion relative to the insulative housing in the longitudinal direction.

Optionally, when the first edge and the second edge are inserted into the first receiving slot and the second receiving slot, respectively, the first edge engages the first receiving slot in a vertical direction perpendicular to the lateral direction and the longitudinal direction, and the second edge engages the second receiving slot in the vertical direction, so as to limit movement of the intermediate portion relative to the insulative housing in the vertical direction.

Optionally, each first conductive element comprises: a first terminal member comprising a first base portion; and a second terminal member comprising a second base portion; the first base portion and the second base portion are stacked on top of each other in a vertical direction perpendicular to the lateral direction, jointly forming the intermediate portion of the first conductive element.

Optionally, for each first conductive element, outer contours of the first base portion and the second base portion in the vertical direction entirely overlap with each other.

Optionally, for each first conductive element, the first base portion and the second base portion are held together by the corresponding adjacent two arms and are held in position relative to the insulative housing by the corresponding adjacent two arms.

Optionally, for each first conductive element: the first terminal member further comprises at least one first contact finger extending into the first slot from the first base portion in the lateral direction, each first contact finger comprises a first end connected to the first base portion and a second end opposite to the first end; the second terminal member further comprises at least two second contact fingers extending into the first slot from the second base portion in the lateral direction, each second contact finger comprises a first end connected to the second base portion and a second end opposite to the first end; the at least one first contact finger and the at least two second contact fingers jointly form the mating end of the first conductive element, and each of the second ends of the at least one first contact finger and the at least two second contact fingers has a mating contact portion; and the second ends of several first contact fingers of the at least one first contact finger are positioned between the second ends of corresponding adjacent two of the at least two second contact fingers.

Optionally, for each first conductive element, the mating contact portion of the second end of the at least one first contact finger and the mating contact portions of the second ends of the at least two second contact fingers are aligned with each other in a longitudinal direction perpendicular to the lateral direction and the vertical direction, and contact surfaces of the mating contact portions of the second ends of the at least one first contact finger and the at least two second contact fingers are coplanar with each other.

Optionally, for each first conductive element, the first end of the at least one first contact finger is positioned closer to the first slot in the vertical direction than the first ends of the at least two second contact fingers.

Optionally, the at least one first conductive element comprises pairs of first conductive elements spaced apart from each other in the vertical direction, and each pair of the first conductive elements of the pairs of first conductive elements is disposed between corresponding adjacent two arms of the plurality of arms and held in position relative to the insulative housing by the corresponding adjacent two arms; and the contact surfaces of the mating contact portions of the at least one first contact finger and the at least two second contact fingers of one first conductive element of each pair of first conductive elements are opposing to the contact surfaces of the mating contact portions of the at least one first contact finger and the at least two second contact fingers of the other first conductive element of each pair of first conductive elements in the vertical direction.

Optionally, the first terminal member further comprises at least two first mount pins each extending from the first base portion; the second terminal member further comprises at least two second mount pins each extending from the second base portion; the amount of the at least two first mount pins is the same as the amount of the at least two second mount pins; and each of the at least two first mount pins is stacked on a corresponding one of the at least two second mount pins, jointly forming the mounting end of the first conductive element.

Optionally, the electrical connector further comprises at least one insulative member each disposed between corresponding adjacent two arms of the plurality of arms to separate the mounting ends of the first conductive element from each other.

Optionally, the at least one first conductive element comprises first conductive elements spaced apart from each other in the vertical direction, and the first conductive elements are disposed between corresponding adjacent two arms of the plurality of arms and are held in position relative to the insulative housing by the corresponding adjacent two arms; for each first conductive element, each mounting end comprises a first segment, a second segment, and a curved portion connecting the first segment and the second segment, the first segment extends from the intermediate portion in the lateral direction, and the curved portion is curved such that the second segment is oriented in the vertical direction; the second segments of the mounting ends of the first conductive elements are arranged in two rows in the lateral direction; and the insulative member is disposed between the two rows and separates the second segments from each other.

Optionally, the corresponding adjacent two arms comprise a first arm and a second arm, the first arm comprises a first arm surface and a third receiving slot recessed into the first arm from the first arm surface and extending in the vertical direction, and the second arm comprises a second arm surface and a fourth receiving slot recessed into the second arm from the second arm surface and extending in the vertical direction, the first arm surface and the second arm surface face each other in a longitudinal direction perpendicular to the lateral direction and the vertical direction, and the third receiving slot and the fourth receiving slot are aligned with each other in the longitudinal direction; the insulative member comprises a first surface and a second surface opposite to each other in the longitudinal direction, a first rib protruding from the first surface and extending in the vertical direction, and a second rib protruding from the second surface and extending in the vertical direction; the first surface and the second surface face the first arm surface and the second arm surface, respectively; and the first rib and the second rib are received in the third receiving slot and the fourth receiving slot, respectively, to limit movement of the insulative member relative to the insulative housing in the lateral direction and the longitudinal direction.

Optionally, the two rows comprise a first row and a second row, the first row is closer to the insulative housing than the second row, the insulative member supports the first row in the longitudinal direction.

Optionally, the insulative housing further comprises a second slot recessed into the insulative housing from the first face in the lateral direction, and a divider separating the first slot from the second slot in a longitudinal direction perpendicular to the lateral direction; and for each first conductive element: the mating end of the first conductive element comprises at least one first contact finger and at least two second contact fingers, each of the at least one first contact finger and the at least two second contact fingers has a mating contact portion; the mating contact portion of each first contact finger has a first width in the longitudinal direction, and the mating contact portion of each second contact finger has a second width in the longitudinal direction, the first width is greater than the second width; and the at least one first contact finger is closer to the divider in the longitudinal direction than the at least two second contact fingers.

Optionally, for each first conductive element: the at least one first contact finger and the at least two second contact fingers are aligned with and spaced apart from each other in the longitudinal direction; and the mating contact portions of adjacent first and second contact fingers of the at least one first contact finger and the at least two second contact fingers are separated center-to-center from each other by a first pitch in the longitudinal direction, and the mating contact portions of two adjacent ones of the at least two second contact fingers are separated center-to-center from each other by a second pitch in the longitudinal direction, the first pitch is greater than the second pitch.

Optionally, for each first conductive element: each of the at least one first contact finger and the at least two second contact fingers comprises a straight portion, a curved portion and a contact portion, the straight portion extends from the intermediate portion towards the first face in the lateral direction, the curved portion is connected between the straight portion and the contact portion, the contact portion extends from the curved portion away from the first face in the lateral direction and extends into the first slot, the mating contact portion is on the contact portion.

Optionally, for each first conductive element, the mating contact portions of the at least one first contact finger and the at least two second contact fingers are aligned with and spaced apart from each other in the longitudinal direction, and contact surfaces of the mating contact portions of the at least one first contact finger and the at least two second contact fingers are coplanar with each other.

Optionally, for each of the first conductive elements, the straight portions of the at least one first contact finger and the at least two second contact fingers are aligned with and spaced apart from each other in the longitudinal direction.

Optionally, for each first conductive element, the widths of the straight, curved and contact portions of each first contact finger in the longitudinal direction are the same as each other.

Optionally, for each first conductive element, the widths of the straight, curved and contact portions of each second contact finger in the longitudinal direction are the same as each other.

Optionally, for each first conductive element, the at least one first contact finger and the at least two second contact fingers are aligned with each other in the longitudinal direction, each first contact finger has a first cross-section profile perpendicular to the longitudinal direction, and each second contact finger has a second cross-section profile perpendicular to the longitudinal direction, the first cross-section profile is the same as the second cross-section profile.

Optionally, for each first conductive element, the first conductive element is formed from a single piece of conductive material.

Optionally, for each first conductive element, the first width is at least 1.5 times the second width.

Optionally, for each first conductive element, the at least one first contact finger is a single first contact finger and the at least two second contact fingers are two second contact fingers.

Optionally, the electrical connector further comprises a plurality of second conductive elements each comprising a mating end having a mating contact portion, a mounting end opposite to the mating end, and an intermediate portion connecting the mating end to the mounting end, the plurality of second conductive elements are held in the insulative housing such that the mating contact portions of the mating ends are exposed in the first slot; the at least one first conductive element comprises a plurality of first conductive elements, and the mating contact portions of the plurality of first conductive elements are arranged in at least one first row in a longitudinal direction perpendicular to the lateral direction; the mating contact portions of the plurality of second conductive elements are arranged in at least one second row in the longitudinal direction, each of the at least one first row and a corresponding one of the at least one second row are aligned with and spaced apart from each other in the longitudinal direction; a pitch by which two adjacent mating contact portions in each first row are separated center-to-center from each other in the longitudinal direction is greater than a pitch by which two adjacent mating contact portions in each second row are separated center-to-center from each other in the longitudinal direction; a width of the mating contact portion of each first conductive element in the longitudinal direction is greater than a width of the mating contact portion of each second conductive element in the longitudinal direction; and each of the plurality of first conductive elements is configured for transmitting power, and at least a portion of the plurality of second conductive elements is configured for transmitting signal.

Optionally, a first portion of the plurality of second conductive elements is configured for transmitting signal, and a second portion of the plurality of second conductive elements is configured for transmitting power; and the second portion is positioned between the first portion and the plurality of first conductive elements in the longitudinal direction.

Optionally, the insulative housing further comprises a second slot recessed into the insulative housing from the first face in the lateral direction and a divider separating the first slot from the second slot in the longitudinal direction, the plurality of arms are located adjacent to the divider.

Some embodiments relate to an electronic system. The electronic system may include the aforementioned electrical connector further comprising a plurality of second conductive elements each comprising a mating end having a mating contact portion, a mounting end opposite to the mating end, and an intermediate portion connecting the mating end to the mounting end, the plurality of second conductive elements held in the insulative housing such that the mating contact portions of the mating ends are exposed in the first slot; and an electrical component comprising a first insert portion, the first insert portion comprising a first conductive portion and a second conductive portion, wherein the first insert portion is inserted into the first slot of the electrical connector such that the plurality of first conductive elements are in electrical contact with the first conductive portion and the plurality of second conductive elements are in electrical contact with the second conductive portion.

Optionally, the first conductive portion comprises a plurality of conductive pads, and each mating contact portion of each first conductive element is in electrical contact with at least two conductive pads.

Optionally, the first conductive portion comprises a first continuous conductive region on a first side thereof and a second continuous conductive region on a second side opposite to the first side thereof; and the mating contact portion of the first conductive elements are in electrical contact with the first conductive region and the second conductive region.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an electronic system including a circuit board and an electrical connector, according to a first embodiment of the present application;

FIG. 2A is a perspective view of a version of the circuit board of FIG. 1;

FIG. 2B is another perspective view of the circuit board of FIG. 2A;

FIG. 3A is a perspective view of another version of the circuit board of FIG. 1;

FIG. 3B is another perspective view of the circuit board of FIG. 3A;

FIG. 4A is a top, front perspective view of the electrical connector of FIG. 1;

FIG. 4B is a top, rear perspective view of the electrical connector of FIG. 4A;

FIG. 4C is a bottom, rear perspective view of the electrical connector of FIG. 4A;

FIG. 5 is a partially exploded view of the electrical connector of FIG. 4A, showing first conductive elements, an insulative member for separating the first conductive elements, and a lead assembly for second conductive elements;

FIG. 6A is a front view of the electrical connector of FIG. 4A;

FIG. 6B is a top view of the electrical connector of FIG. 4A;

FIG. 6C is a rear view of the electrical connector of FIG. 4A;

FIG. 6D is a bottom view of the electrical connector of FIG. 4A;

FIG. 6E is a cross-sectional view taken along the line I-I in FIG. 6B;

FIG. 6F is a cross-sectional view taken along the line II-II in FIG. 6B;

FIG. 6G is a cross-sectional view taken along the line III-III in FIG. 6B;

FIG. 6H is a cross-sectional view taken along the line IV-IV in FIG. 4A;

FIG. 7A is a front perspective view of an insulative housing of the electrical connector of FIG. 4A;

FIG. 7B is an enlarged view of the area 7B circled by the dashed frame in FIG. 7A;

FIG. 7C is a rear perspective view of the insulative housing of FIG. 7A;

FIG. 7D is an enlarged view of the area 7D circled by the dashed frame in FIG. 7C;

FIG. 7E is another rear perspective view of the insulative housing of FIG. 7A;

FIG. 7F is an enlarged view of the area 7F circled by the dashed frame in FIG. 7E;

FIG. 8A is a perspective view of the lead assembly of FIG. 5, showing the second conductive elements and an assembly housing, illustrating the assembled state of the second conductive elements and the assembly housing in the electrical connector;

FIG. 8B is a side view of the second conductive elements and the assembly housings of FIG. 8A;

FIG. 8C is a bottom view of the second conductive elements and the assembly housing of FIG. 8A;

FIG. 8D is a perspective view of the second conductive elements and a lossy member of FIG. 8A, illustrating an assembled state of the second conductive elements and the lossy member in the electrical connector;

FIG. 8E is a side view of the second conductive elements and the lossy member of FIG. 8D;

FIG. 8F is a bottom view of the second conductive elements and the lossy member of FIG. 8D;

FIG. 9A is a top view of a group of three signal terminals in a first portion of the second conductive elements of FIG. 8A;

FIG. 9B is a perspective view of the group of three signal terminals of FIG. 9A;

FIG. 9C is another perspective view of the group of three signal terminals of FIG. 9A;

FIG. 10A is a perspective view of the first conductive elements and the insulative member of FIG. 5, illustrating an assembled state of the first conductive elements and the insulative member in the electrical connector;

FIG. 10B is another perspective view of the first conductive elements and the insulative member of FIG. 10A;

FIG. 10C is a side view of the first conductive elements and the insulative member of FIG. 10A;

FIG. 10D is an exploded view of the first conductive elements and the insulative member of FIG. 10A;

FIG. 11A is a top view of one of the first conductive elements of FIG. 10A;

FIG. 11B is a top view of a first terminal member of the first conductive element of FIG. 11A;

FIG. 11C is a top view of a second terminal member of the first conductive element of FIG. 11A;

FIG. 12A is a perspective view of the insulative member of FIG. 10A;

FIG. 12B is another perspective view of the insulative member of FIG. 10A;

FIG. 13A is a top, front perspective view of an electrical connector, according to a second embodiment of the present application;

FIG. 13B is a top, rear perspective view of the electrical connector of FIG. 13A;

FIG. 13C is a bottom, rear perspective view of the electrical connector of FIG. 13A;

FIG. 14 is a partially exploded view of the electrical connector of FIG. 13A, showing a lead assembly for both first conductive elements and second conductive elements;

FIG. 15A is a front view of the electrical connector of FIG. 13A;

FIG. 15B is a top view of the electrical connector of FIG. 13A;

FIG. 15C is a rear view of the electrical connector of FIG. 13A;

FIG. 15D is a bottom view of the electrical connector of FIG. 13A;

FIG. 15E is a cross-sectional view taken along the line V-V in FIG. 15B;

FIG. 15F is a cross-sectional view taken along the line VI-VI in FIG. 15B;

FIG. 16A is a front perspective view of the insulative housing of the electrical connector of FIG. 13A;

FIG. 16B is an enlarged view of the area 16B circled by the dashed frame in FIG. 16A;

FIG. 16C is a rear perspective view of the insulative housing of FIG. 16A;

FIG. 16D is an enlarged view of the area 16D circled by the dashed frame in FIG. 16C;

FIG. 17A is a front, side perspective view of the lead assembly of FIG. 14 including two first conductive elements, a plurality of second conductive elements, and an assembly housing;

FIG. 17B is a partially exploded view of the lead assembly of FIG. 17A;

FIG. 17C is a top, side perspective view of the lead assembly of FIG. 17A with the plurality of second conductive elements hidden;

FIG. 17D is a bottom, side perspective view of the lead assembly of FIG. 17C;

FIG. 17E is a top, rear perspective view of the lead assembly of FIG. 17C;

FIG. 17F is a side view of the lead assembly of FIG. 17C;

FIG. 18A is a top, rear perspective view of the assembly housing of FIGS. 17A to 17F;

FIG. 18B is a bottom, rear perspective view of the assembly housing of FIG. 18A;

FIG. 18C is another bottom, rear perspective view of the assembly housing of FIG. 18A;

FIG. 18D is a top view of one of the first conductive elements of FIGS. 14 and 17A to 17F;

FIG. 18E is a bottom view of the first conductive element of FIG. 18D;

FIG. 18F is a top view of the other of the first conductive elements of FIGS. 14 and 17A to 17F;

FIG. 18G is a bottom view of the first conductive element of FIG. 18F;

FIG. 19A is a top, front perspective view of an electrical connector according to a third embodiment of the present application;

FIG. 19B is a bottom, rear perspective view of the electrical connector of FIG. 19A;

FIG. 19C is a partially exploded view of the electrical connector of FIG. 19A;

FIG. 19D is a perspective view of one of the first conductive elements of FIG. 19C;

FIG. 19E is another perspective view of the first conductive element of FIG. 19D;

FIG. 20A is a top, front perspective view of an electrical connector according to a fourth embodiment of the present application;

FIG. 20B is a top, rear perspective view of the electrical connector of FIG. 20A;

FIG. 20C is a partially exploded view of the electrical connector of FIG. 20A;

FIG. 20D is a perspective view of one of the first conductive elements of FIG. 20C;

FIG. 20E is another perspective view of the first conductive element of FIG. 20D;

FIG. 21A is a top, front perspective view of an electrical connector according to a fifth embodiment of the present application;

FIG. 21B is a top, rear perspective view of the electrical connector of FIG. 21A;

FIG. 21C is a perspective view similar to FIG. 21B, with the cables hidden to show the mounting end support member of the electrical connector;

FIG. 21D is a perspective view similar to FIG. 21C, with the mounting end support member hidden;

FIG. 21E is a partially exploded view of the electrical connector of FIG. 21A, with the cables and the corresponding mounting end support members hidden;

FIG. 21F is a perspective view of one of the first conductive elements of FIG. 21E; and

FIG. 21G is another perspective view of the first conductive element of FIG. 21E.

### DETAILED DESCRIPTION

The inventors have recognized and appreciated techniques for making a high density connector for providing both high-quality, high-speed signal transmission and high power transmission, while being backward compatible with physical requirements set by already defined industry standards (e.g., current version of SFF-TA-1002-Rev 1.3). According to aspects of the present application, a connector can have a type of conductive elements configured for high speed signal transmission (e.g., up to 112 GT/s), and another type of conductive elements configured for high power transmission (e.g., up to 200 W) while still satisfying the requirements on the quality of signals transmitted by the signal conductive elements at high speed. The power conductive element may be connected to a supply voltage or return, for example.

In some embodiments, a connector may have signal conductive elements and power conductive elements held by a same housing. The housing may have an upper wall, a lower wall, and multiple ports/slots separated by dividers extending between the upper and lower walls at a mating interface. The upper wall may include a first wider channel connected to a first slot. The lower wall may include a second wider channel connected to the first slot. The first and second channels may have power conductive elements disposed therein, while signal conductive elements may be disposed outside the first and second wider channels including, for example, on opposite sides of the first and second wider channels.

Alternatively or additionally, one or more of the power conductive elements may be configured to mate with pads on an add-in card that are the same width as an integer multiple of pads on an add-in card designated for power connections according to the standard. In some examples, one or more of the power conductive elements and/or spring fingers of the power conductive elements, may have a width corresponding to the width of an integer multiple of signal conductive elements in the connector and/or conductive elements designated as power conductive elements according to the standard. With this configuration, the connector may mate with both an add-in card according to the standard and an add-in card adapted to carry higher current. The higher current add-in card, for example, may have one or more power pads wider than pads according to the standard and occupying space along the edge of the card in which an integer multiple of pads would be disposed in a card according to the standard.

In a connector in which one or more wide power conductive elements is configured to take the place of multiple conductive elements designated to carry power according to the standard, the wide power conductive elements may be in the same port as one or more signal conductive elements, according to the standard. The wide power conductive elements may be integrated into the same connector housing as the signal conductive elements, which may reduce the overall distance along a card edge required to make signal connections according to the standard with higher current carrying capacity than according to the standard. The wide power conductive elements, for example, may be in the same slot configured to receive a card edge with signal conductive elements.

With power conductive elements configured as described herein, conductive elements with larger sizes and/or larger pitches can be disposed in the electrical connector without having to add additional slots or adding additional electrical connectors. Such a configuration also can enable signal and power conductive elements disposed closely together and therefore satisfy high density requirements. Such a configuration also can enable the high density electrical connector to provide both high quality, highspeed signal transmission and high power transmission.

In some embodiments, the housing may include a plurality of arms extending away from the housing from a face opposite to the mating face in a lateral direction. An intermediate portion of each power conductive element may be disposed between two corresponding adjacent arms of the plurality of arms and held in position relative to the housing by the two corresponding adjacent arms such that a mating contact portion of a mating end is exposed in the first slot.

In some embodiments, for each power conductive element, a mating end may include a first contact finger and a second contact fingers, each of which may include a mating contact portion. The mating contact portion of the first contact finger may have a first width in the longitudinal direction, and the mating contact portion of the second contact finger may have a second width in the longitudinal direction that is less than the first width. The first contact finger may be disposed closer to a divider separating the first slot from a second slot than the second contact finger.

In some embodiments, a lead assembly for a connector may include a unitary housing, which may include a first segment and a second segment extending from the first segment in a longitudinal direction. The lead assembly may include power conductive elements held by the first segment and signal conductive elements held by the second segment. Each power conductive element may include a mating end having a plurality of mating contact portions. Each signal conductive element may include a mating end having a mating contact portion. In the first port, the mating contact portions of the signal conductive elements may be separated from each other by a center-to-center distance in the longitudinal direction; and the mating contact portions of each of the plurality of first conductive elements may be separated from each other by a center-to-center distance in the longitudinal direction, which is greater than the center-to-center distance of the mating contact portions of the signal conductive elements. Each mating contact portion of the power conductive element may be wider than the mating contact portion of each signal conductive element in the longitudinal direction.

Such a configuration may enable the first conductive elements with larger sizes to be disposed in the same slot as signal conductive elements, without changing the overall width of the housing of the electrical connector in the lateral direction and the overall length of the housing in the longitudinal direction.

Some embodiments of the present application are described in detail below in conjunction with the accompanying drawings. It should be appreciated that these embodiments are not intended to form any limitations to the present application. Moreover, features in the embodiments of the present application can be combined with each other without conflict.

### First Exemplary Embodiment

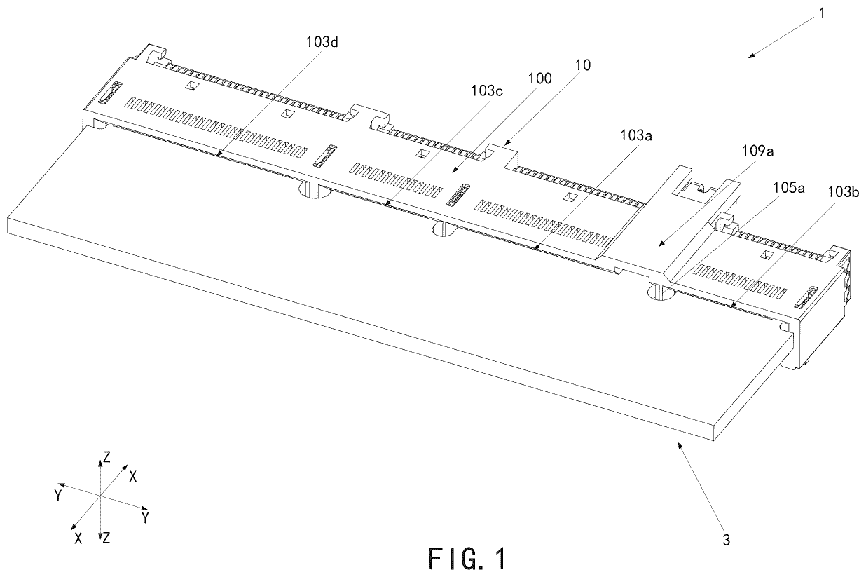

FIG. 1 illustrates an electronic system 1 according to a first embodiment of the present application including an electrical component 3 and an electrical connector 10. The electrical connector 10 may be configured to establish an electrical connection between the electrical component 3 and a circuit board (not shown). In particular, the electrical connector 10 may be mounted to the circuit board and may establish a separable electrical connection with the electrical component 3. For example, the circuit board may be a first circuit board (which may also be referred to as “a first printed circuit board” or “a first PCB”), and as exemplarily illustrated in FIGS. 1 to 3B, the electrical component 3 may be a second circuit board (which may also be referred to as “a second printed circuit board” or “a second PCB”). In this case, the first circuit board may be a motherboard, and the second circuit board may be a daughter card such as a solid state disk (SSD) card, a wireless communication card, an RF module, or the like.

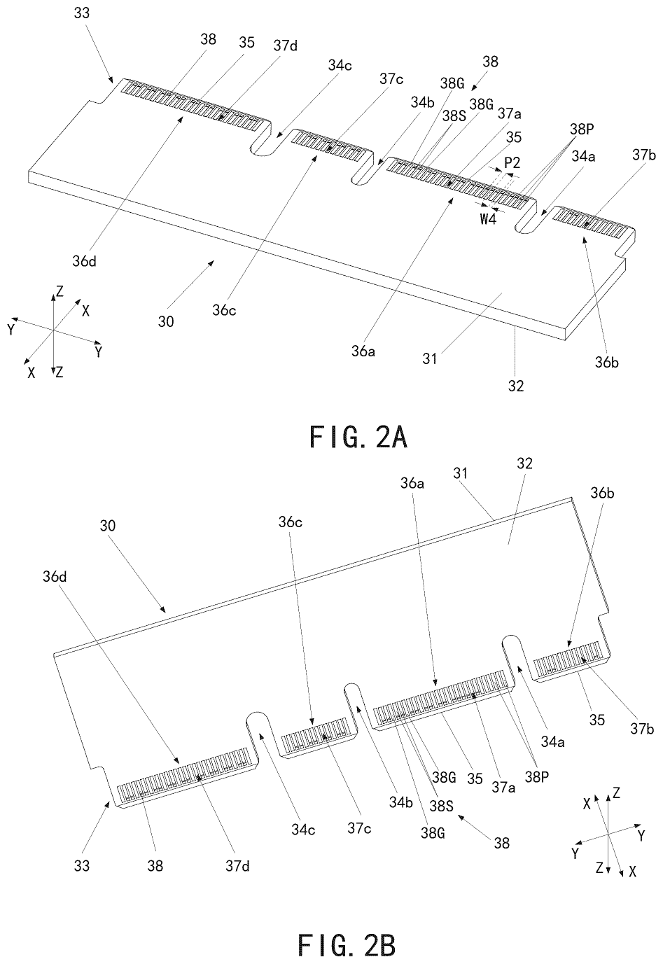

FIGS. 2A and 2B illustrate a first exemplary type of the electrical component 3, e.g., a second circuit board 30. The second circuit board 30 may be configured for a low power (such as 75 W) application. As shown in FIGS. 2A and 2B, the second circuit board 30 includes a first surface 31, a second surface 32, and a first end 33. The first surface 31 and the second surface 32 may be opposite to each other and substantially parallel to each other. As will be described in detail below, the first end 33 of the second circuit board 30 is configured to be inserted into a slot of the electrical connector 10. Notches 34a, 34b, and 34c are recessed into the second circuit board 30 from an edge 35 at the first end 33 to separate the first end 33 into a plurality of insert portions 36a, 36b, 36c, and 36d. The plurality of insert portions 36a, 36b, 36c, and 36d are configured to be inserted into a corresponding slot of the electrical connector 10. The second circuit board 30 includes conductive portions 37a, 37b, 37c, and 37d disposed at or near an edge 35 at each of the insert portions 36a, 36b, 36c, and 36d. The conductive portions 37a, 37b, 37c, and 37d may include conductive pads 38 (which may also be referred to as “gold fingers”) disposed at a certain pitch. At each of the insert portions 36a, 36b, 36c, and 36d, the conductive portions 37a, 37b, 37c, and 37d may be provided on both the first surface 31 and the second surface 32 of the second circuit board 30. For example, the conductive portions 37a, 37b, 37c, and 37d may be provided on opposite sides of each of the insert portions 36a, 36b, 36c, and 36d. Alternatively, the conductive portions 37a, 37b, 37c and 37d may be provided on one side of the insert portions 36a, 36b, 36c and 36d.

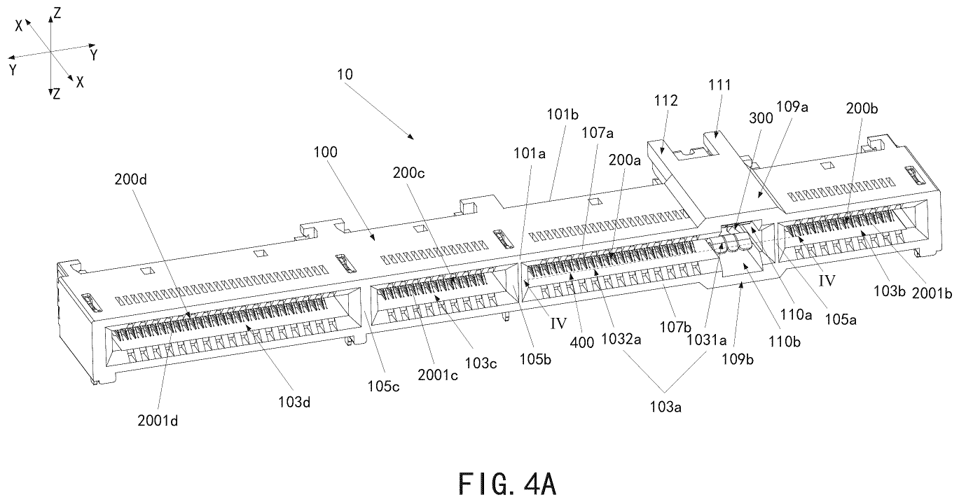

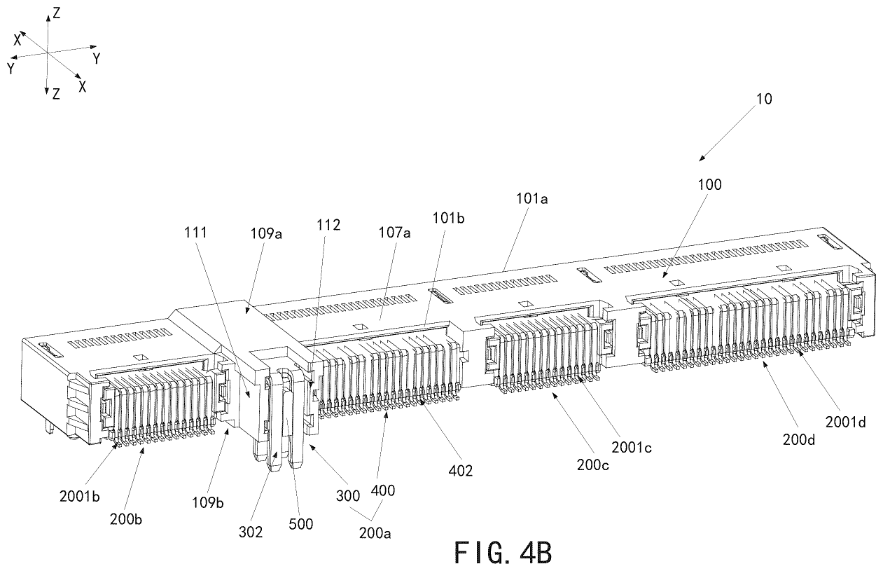

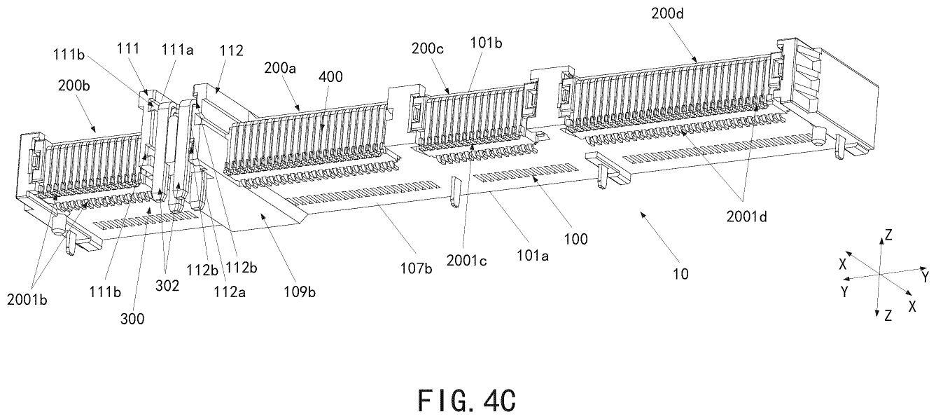

FIGS. 4A to 12B illustrate in detail the electrical connector 10 of FIG. 1. For the sake of clarity and conciseness of description, a lateral direction X-X, a longitudinal direction Y-Y, and a vertical direction Z-Z may be shown in the figures. The lateral direction X-X, the longitudinal direction Y-Y, and the vertical direction Z-Z may be perpendicular to each other. The lateral direction X-X may refer to a width direction of the electrical connector 10. The longitudinal direction Y-Y may refer to a length direction of the electrical connector 10. The vertical direction Z-Z may refer to a height direction of the electrical connector 10.

As shown in FIGS. 4A to 6H, the electrical connector 10 may be a card edge connector, specifically a right angle (RA) connector. The electrical connector 10 may be mounted onto the aforementioned first circuit board, and the insert portions 36a, 36b, 36c, and 36d of the second circuit board 30 may be inserted into corresponding slots of the electrical connector 10 to establish an electrical connection between corresponding conductive portions (e.g., conductive through holes or conductive pads) of the first circuit board and the conductive portions 37a, 37b, 37c, and 37d of the second circuit board 30 through the conductive elements of the electrical connector 10. The electrical connector 10 may mechanically and electrically connect the second circuit board 30 to the first circuit board. The electrical connector 10 may enable the first circuit board and the second circuit board 30 to be arranged to be parallel to each other.

The electrical connector 10 includes an insulative housing 100 and a plurality of conductive elements disposed in the insulative housing 100. The insulative housing 100 may be formed from an insulative material. Examples of insulative materials that are suitable for forming the insulative housing 100 include, but are not limited to, plastic, nylon, liquid crystal polymer (LCP), polyphenylene sulfide (PPS), high temperature nylon or polyphenylene oxide (PPO) or polypropylene (PP). Each of the plurality of conductive elements may be formed from a conductive material. The conductive material suitable for forming the conductive elements may be a metal or a metal alloy, such as a copper or copper alloy.

The insulative housing 100 includes a first face 101a and a second face 101b opposite to each other in the lateral direction X-X, and at least one slot recessed into the insulative housing 100 from the first face 101a in the lateral direction X-X. As shown in FIGS. 4A, 5, 6A, 7A, and 7B, the insulative housing 100 may include a first slot 103a, a second slot 103b, a third slot 103c, and a fourth slot 103d recessed into the insulative housing 100 from the first face 101a, respectively. The first face 101a may also be referred to as “a mating face”. The insert portions 36a, 36b, 36c, and 36d of the second circuit board 30 may be inserted into the first slot 103a, the second slot 103b, the third slot 103c, and the fourth slot 103d, respectively. Every adjacent two of the first slot 103a, the second slot 103b, the third slot 103c, and the fourth slot 103d are separated by a divider of the insulative housing 100 in the longitudinal direction Y-Y. For example, two adjacent slots are not connected with each other. As shown, the second slot 103b and the first slot 103a are separated by a divider 105a in the longitudinal direction Y-Y, the first slot 103a and the third slot 103c are separated by a divider 105b in the longitudinal direction Y-Y, and the third slot 103c and the fourth slot 103d are separated by a divider 105c in the longitudinal direction Y-Y. The divider 105a, the divider 105b, and the divider 105c may be integral parts of the insulative housing 100. The divider 105a, the divider 105b, and the divider 105c may be used to guide the insertion of the insert portions 36a, 36b, 36c, and 36d of the second circuit board 30 into the corresponding slots. In particular, the divider 105a, the divider 105b, and the divider 105c may be received in the notches 34a, 34b, and 34c, respectively, of the second circuit board 30 to guide the insertion of the insert portions 36a, 36b, 36c, and 36d of the second circuit board 30 into the corresponding slots.

As shown in FIGS. 4A to 6D, the plurality of conductive elements of the electrical connector 10 includes a first group of conductive elements 200a disposed in the first slot 103a, a second group of conductive elements 200b disposed in the second slot 103b, a third group of conductive elements 200c disposed in the third slot 103c, and a fourth group of conductive elements 200d disposed in the fourth slot 103d. As will be described in detail below, each conductive element includes a mating end having a mating contact portion, a mounting end opposite to the mating end, and an intermediate portion connecting the mating end to the mounting end. The mating end may be configured to mate with a corresponding conductive portion of the electrical component 3 such as the aforementioned second circuit board 30, and the mounting end may be configured to be mounted to a corresponding conductive portion of a circuit board such as the aforementioned first circuit board. Each conductive element is held in the insulative housing 100 with the mating contact portion of the mating end exposed in a corresponding slot for electrical contact with the corresponding conductive portion of the second circuit board 30. Aspects of the electrical connector 10 will be described below in connection with the first group of conductive elements 200a disposed in the first slot 103a and the second group of conductive elements 200b disposed in the second slot 103b.

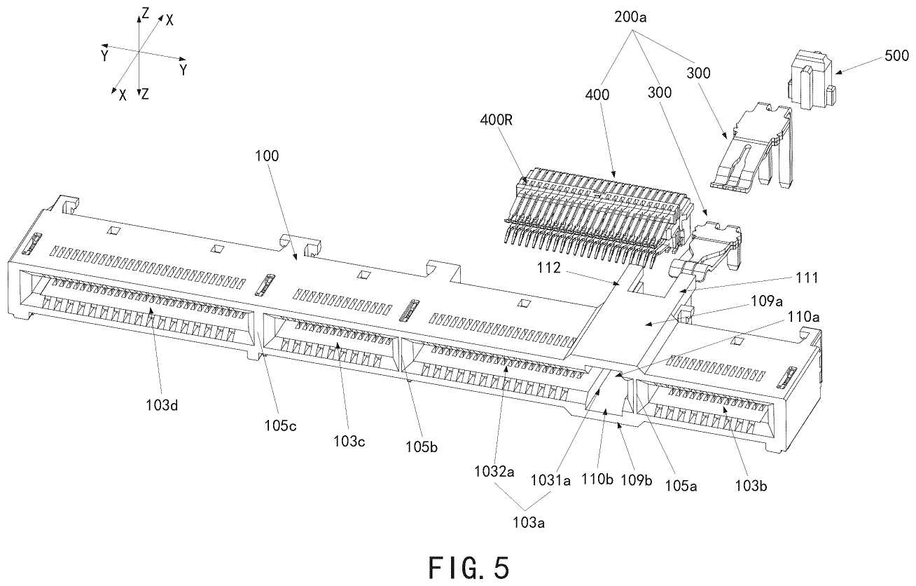

As shown in FIG. 5, the first group of conductive elements 200a includes first conductive elements 300 and second conductive elements 400. Although two first conductive elements 300 are shown in the figures, it should be appreciated that one first conductive element 300 may be included, or more than first conductive elements 300 may be included. For example, pairs (one or more pairs) of first conductive elements 300 may be included.

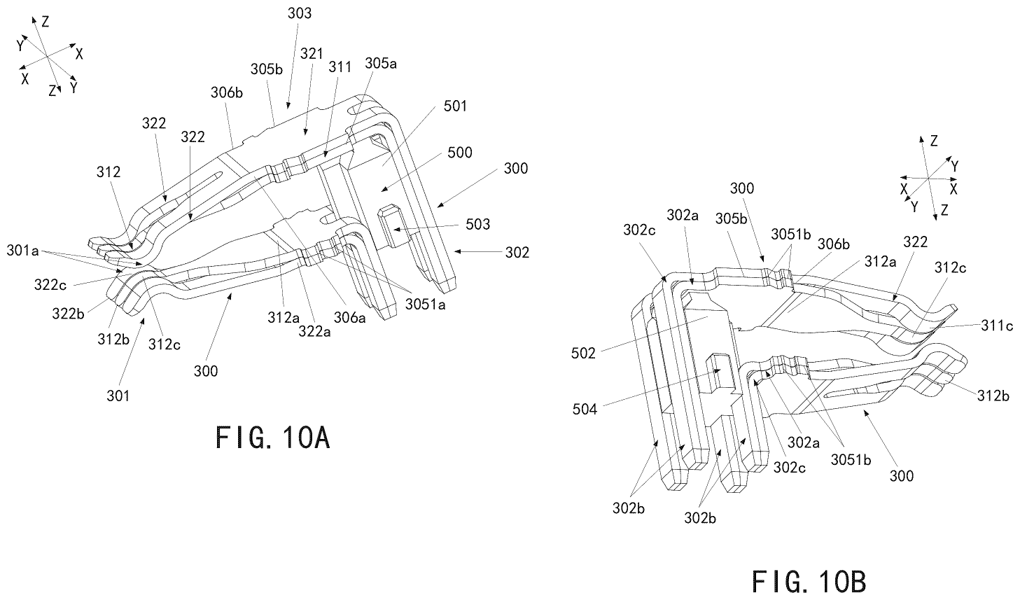

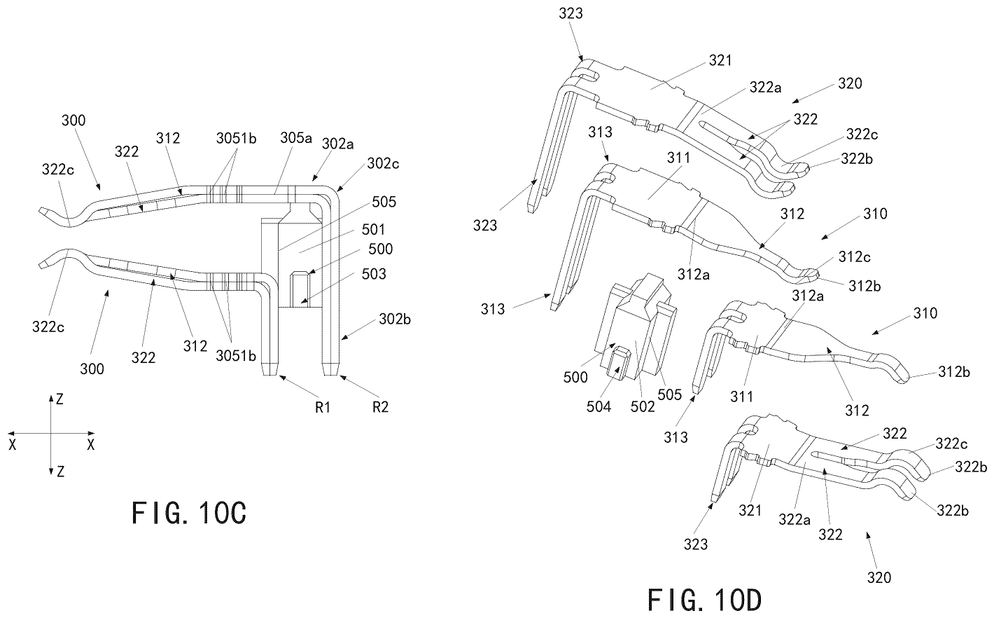

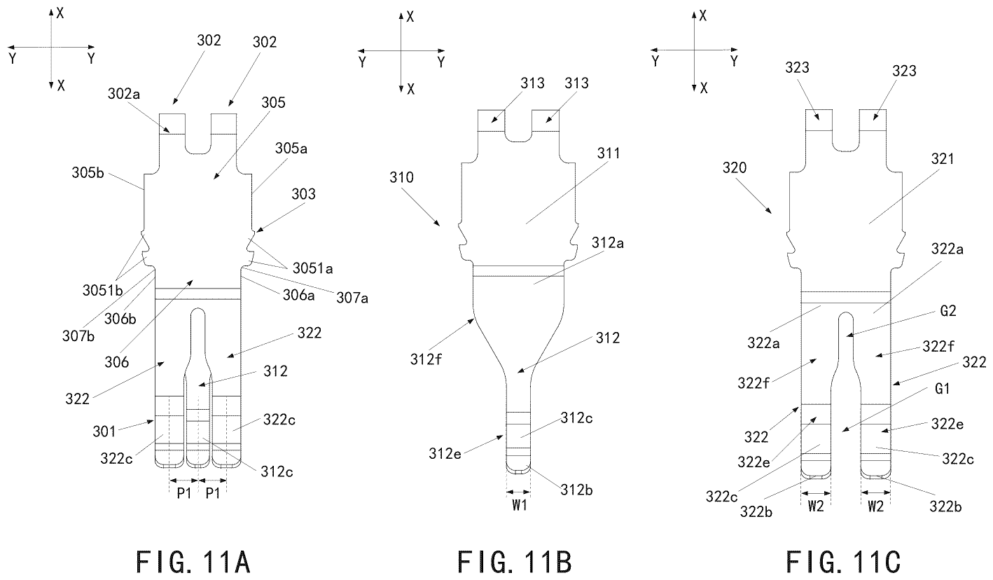

Each first conductive element 300 may be configured for transmitting power. An exemplary form of the first conductive element 300 is shown in FIGS. 10A to 11C. As shown in FIGS. 10A to 11C, each first conductive element 300 includes a mating end 301 having a mating contact portion 301a, a mounting end 302 opposite to the mating end 301, and an intermediate portion 303 connecting the mating end 301 to the mounting end 302. As will be described in detail below, the mating end 301 may be configured to mate with the conductive portion 37a of the second circuit board 30 such that the mating contact portion 301a electrically contacts a corresponding conductive pad 38 of the conductive portion 37a.

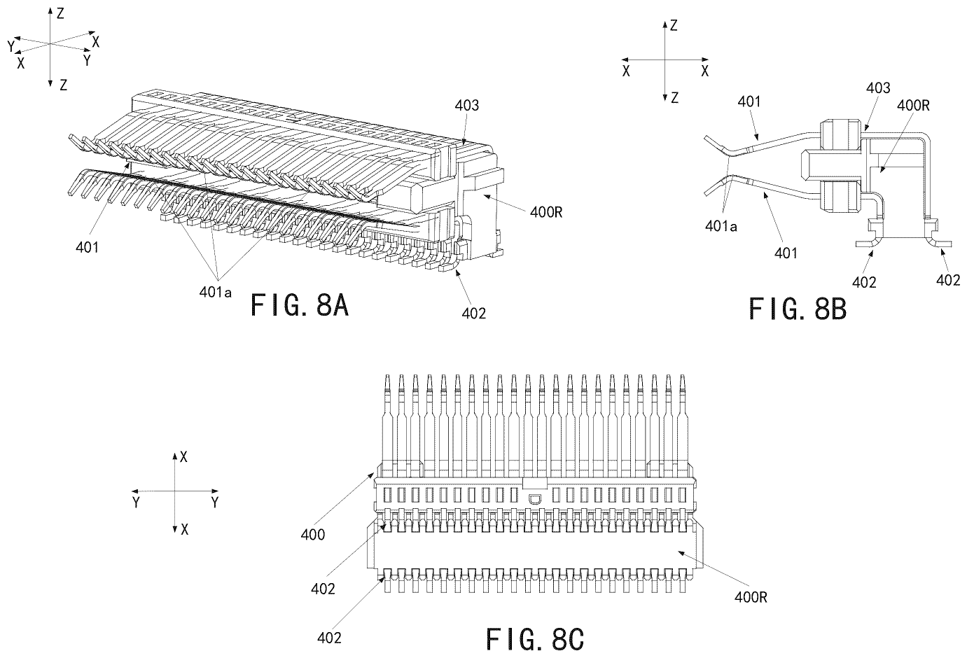

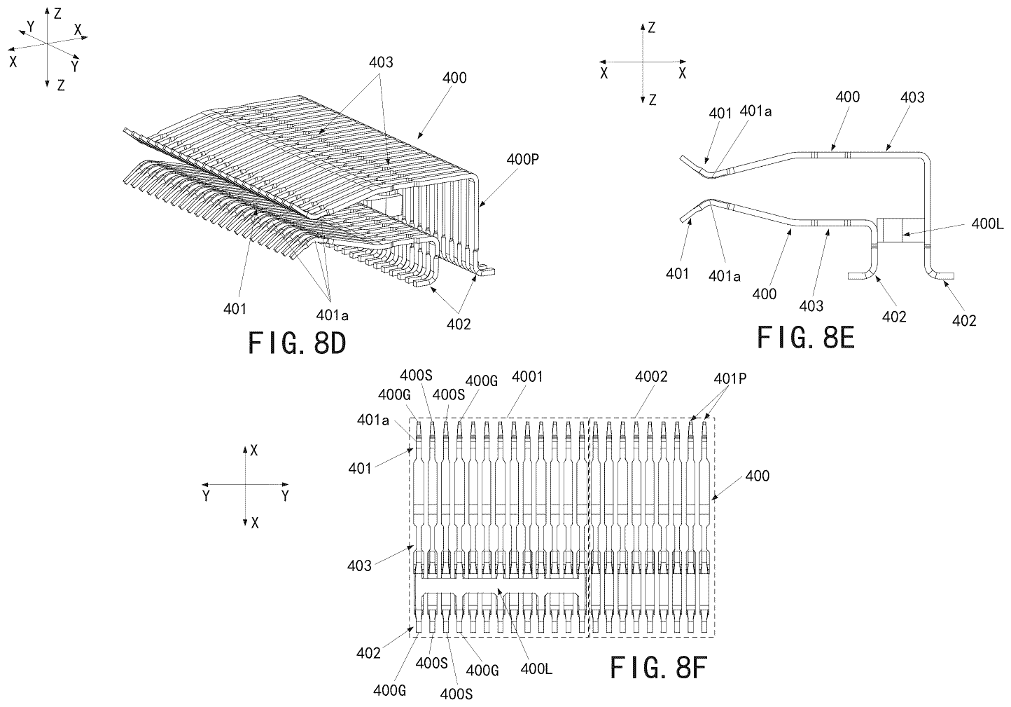

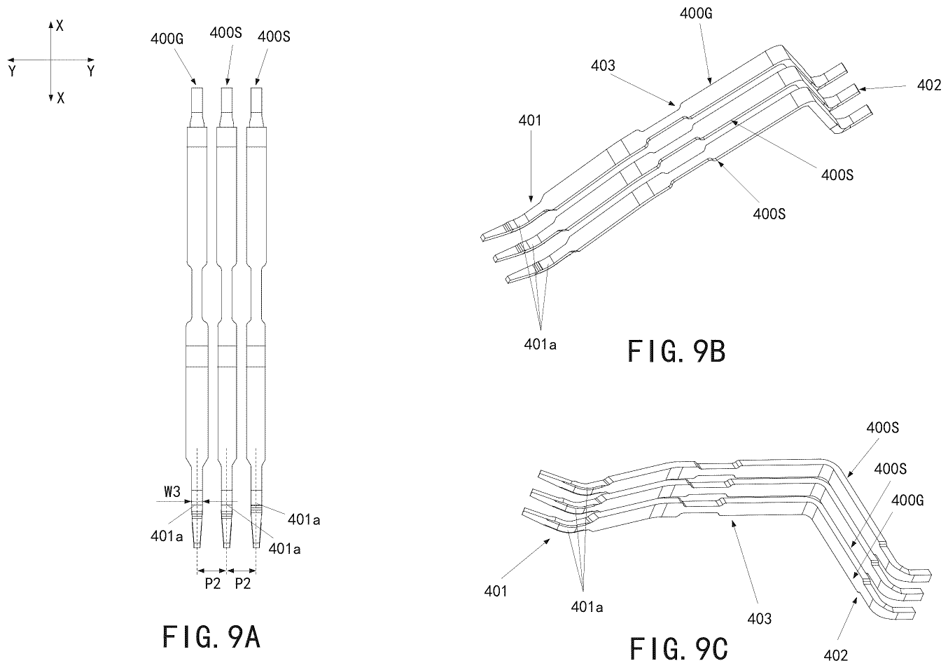

An exemplary form of the second conductive element 400 is shown in FIGS. 8A to 9C. As shown in FIGS. 8A to 9C, each of the second conductive elements 400 includes a mating end 401 having a mating contact portion 401a, a mounting end 402 opposite to the mating end 401, and an intermediate portion 403 connecting the mating end 401 to the mounting end 402. The mating end 401 may also be configured to mate with the conductive portion 37a of the second circuit board 30 such that the mating contact portion 301a electrically contacts a corresponding conductive pad 38 of the conductive portion 37a.

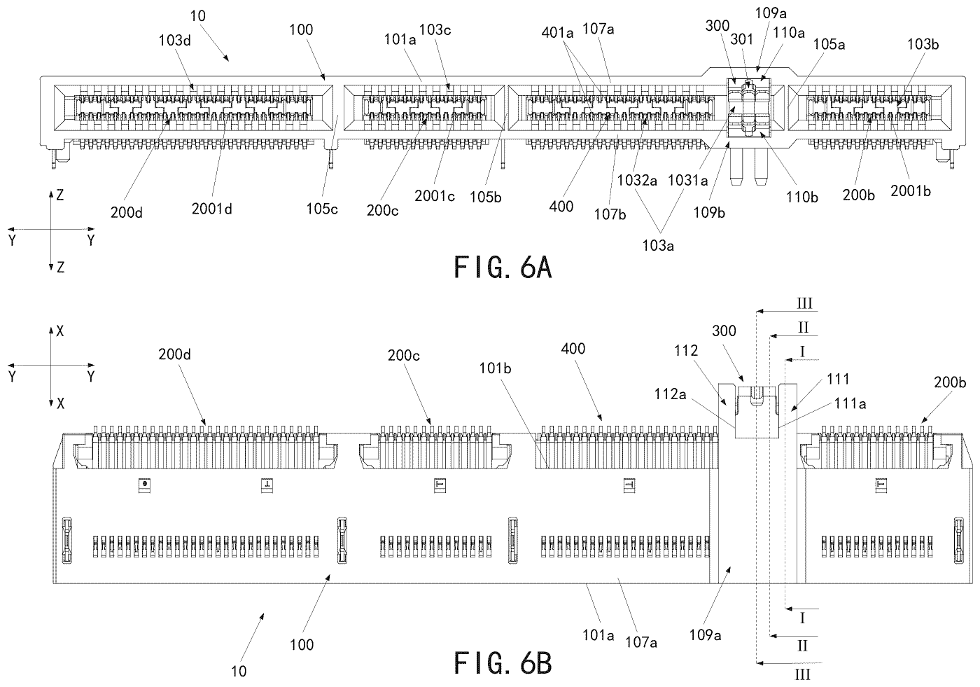

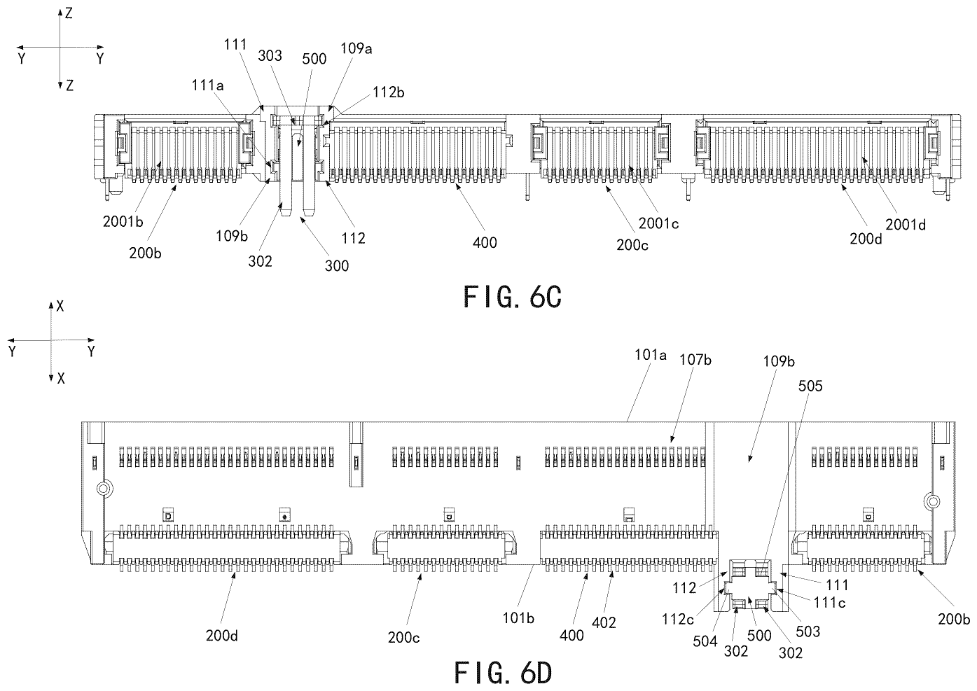

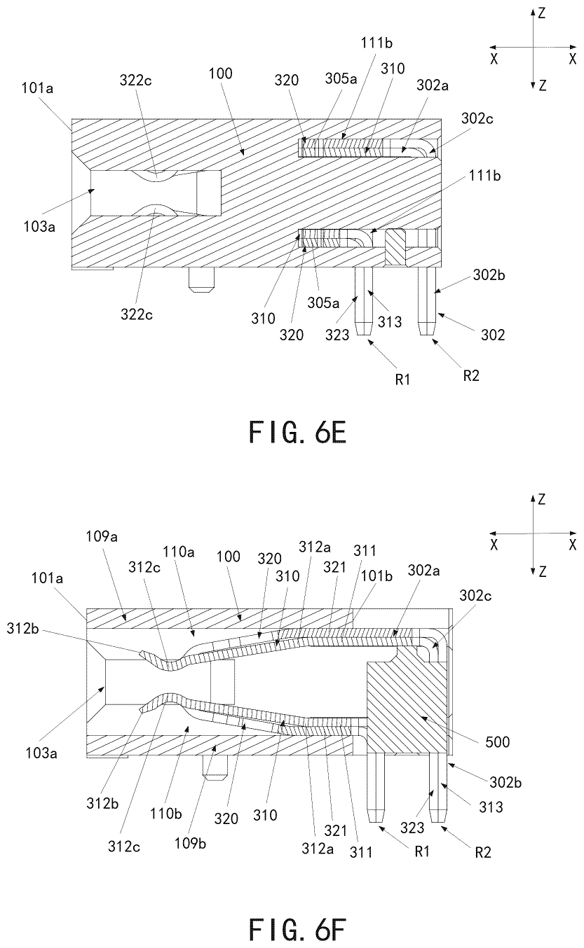

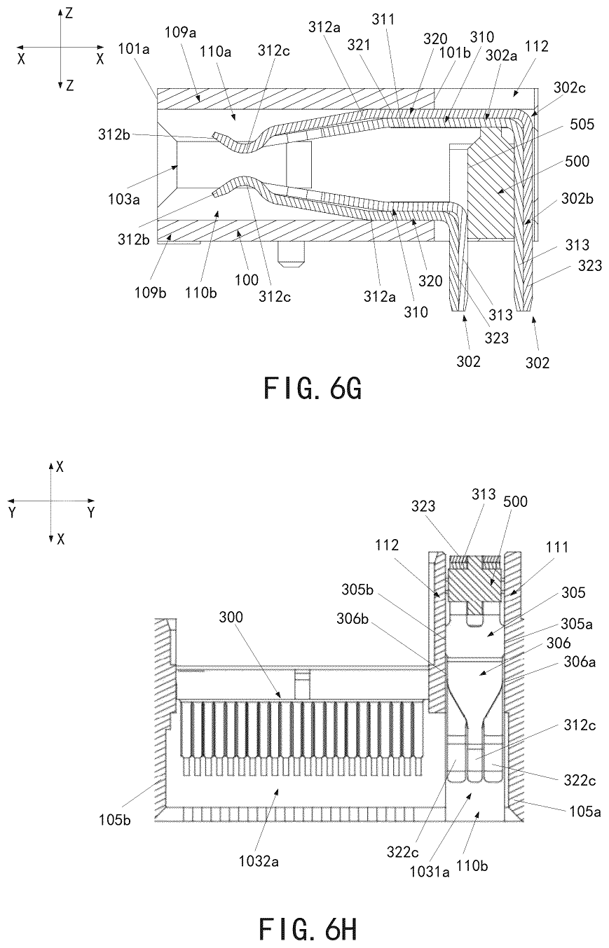

As shown in FIGS. 5 and 6A, the first conductive element 300 may have a larger size in the lateral direction X-X, the longitudinal direction Y-Y, and the vertical direction Z-Z compared to the second conductive element 400. Furthermore, the first conductive elements 300 may be separated apart from each other by a greater distance in the vertical direction Z-Z compared to the second conductive elements 400. In addition, as will be described in detail below, the mating contact portions 301a of the first conductive elements 300 may be separated center-to-center from each other by a greater distance in the longitudinal direction Y-Y compared to the mating contact portions 403a of the second conductive elements 400.

It should be appreciated that the present application is not limited thereto. For example, compared to the second conductive elements 400, the first conductive elements 300 may have a larger size in one and two of the lateral direction X-X, the longitudinal direction Y-Y, and the vertical direction Z-Z. As another example, there may be a plurality of first conductive elements 300, and two adjacent first conductive elements 300 in the longitudinal direction Y-Y may be separated apart from each other by a greater distance.

Turning to FIGS. 4A to 7B, the insulative housing 100 includes a first wall 107a and a second wall 107b separated by the first slot 103a in the vertical direction Z-Z. For example, the first wall 107a and the second wall 107b of the insulative housing 100 define a bounding of the first slot 103a in the vertical direction Z-Z. In addition, the divider 105a and the divider 105b of the insulative housing 100 define a bounding of the first slot 103a in the longitudinal direction Y-Y. A portion of the first wall 107a adjacent to the divider 105a protrudes outwardly away from the first slot 103a to form a first bulge 109a, and a portion of the second wall 107b adjacent to the divider 105a protrudes outwardly away from the first slot 103a to form a second bulge 109b. The first conductive elements 300 are held in the first bulge 109a and the second bulge 109b of the insulative housing 100, respectively.

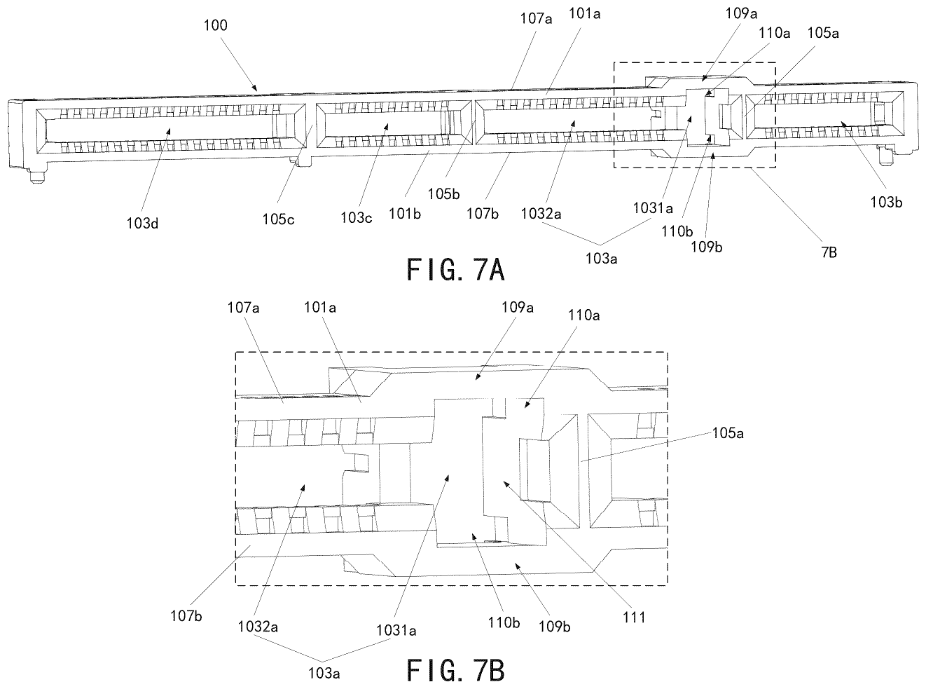

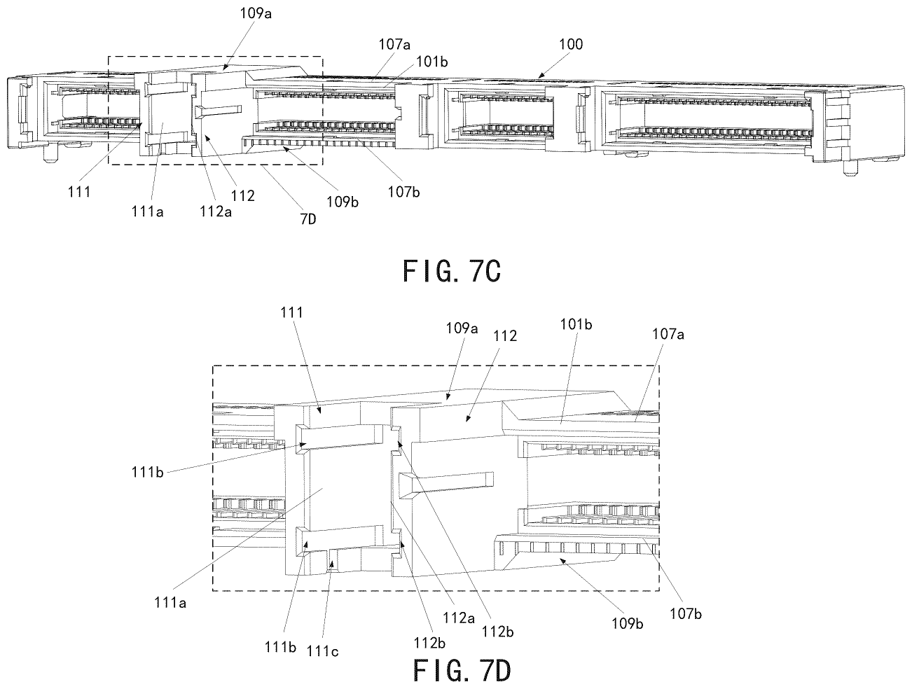

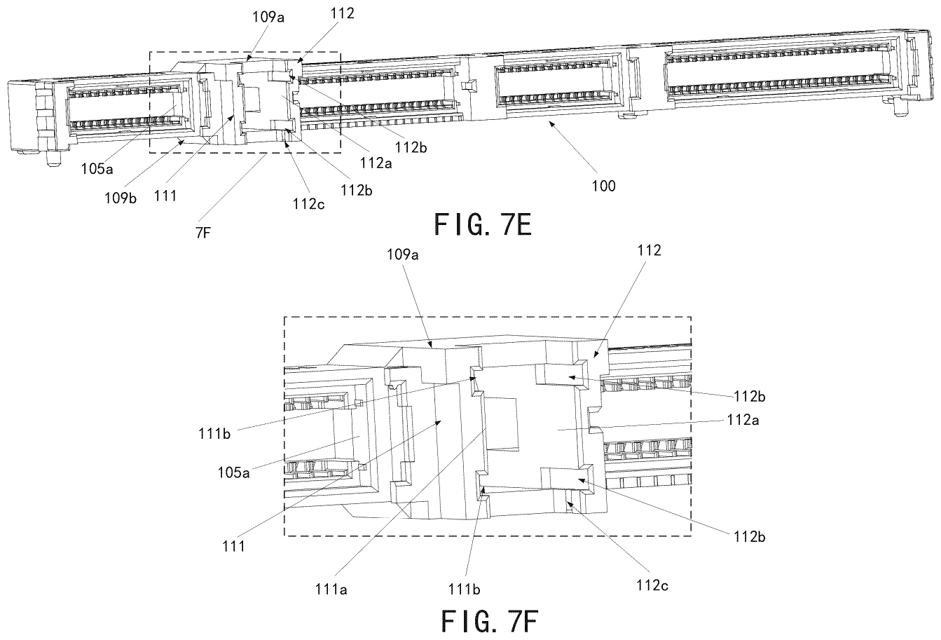

In particular, the first bulge 109a and the second bulge 109b of the insulative housing 100 include a first channel 110a and a second channel 110b, respectively. As shown in FIGS. 6F to 6G and 7A to 7B, the first channel 110a and the second channel 110b extend from the first slot 103a into the first bulge 109a and the second bulge 109b in the vertical direction Z-Z, respectively, to accommodate first conductive elements 300. One of the first conductive elements 300 is disposed in the first channel 110a, and the other is disposed in the second channel 110b.

With such a configuration, the first conductive element 300 can be disposed adjacent to the divider 105a of the insulative housing 100 separating the first slot 103a and the second slot 103b from each other, and can be disposed in the same slot as the plurality of second conductive elements 400. This enables the first conductive elements 300 with larger dimensions and/or larger pitches to be disposed in the electrical connector 10 without having to add additional slots, or without having to add additional electrical connectors to the electronic system 1. This configuration does not significantly increase the space occupied by the electrical connector 10 on the first circuit board such as a motherboard. Furthermore, in some embodiments, as will be described below, this configuration enables the high-density electrical connector to provide both high-quality, high-speed signal transmission and high power transmission. Moreover, in some embodiments, as will be described below, the electrical connector 10 configured according to the present application can be backwardly compatible with the second circuit board 30 designed and manufactured according to a particular specification, such as the second circuit board 30 designed and manufactured according to the current version of SFF-TA-1002.

In some embodiments, the intermediate portion 303 of the first conductive element 300 may engage a wall of a corresponding channel so as to retain the first conductive element 300 in the corresponding channel. In some other embodiments, the first conductive elements 300 may be retained in the corresponding channel by any suitable terminal retention structure (not shown). In some other embodiments, as will be described below, the intermediate portions 303 of the first conductive elements 300 may be retained by arms of the insulative housing 100 so as to retain the first conductive element 300 in the corresponding channel.

In some embodiments, the first channel 110a and the second channel 110b extend from the first face 101a through the insulative housing 100 to the second face 101b in the lateral direction X-X, respectively. In some embodiments, the first channel 110a and the second channel 110b may be aligned with each other in the vertical direction Z-Z, or offset from each other.

As shown in FIGS. 7A and 7B, the first slot 103a includes a first portion 1031a corresponding to the first channel 110a and the second channel 110b and a second portion 1032a extending from the first portion 1031a away from the divider 105a in the longitudinal direction Y-Y. The first portion 1031a is connected with the second portion 1032a. The first portion 1031a is connected with the first channel 110a and the second channel 110b. As shown in FIGS. 4A, 6A, and 6E through 6H, the mating contact portions 301a of the mating ends 301 of the first conductive elements 300 are exposed in the first portion 1031a for electrical contact with corresponding conductive pads 38 of the conductive portion 37a of the second circuit board 30. The plurality of second conductive elements 400 are disposed in the insulative housing 100 in correspondence with the second portion 1032a with the mating contact portions 401a of the mating ends 401 of the plurality of second conductive elements 400 exposed in the second portion 1032a for electrical contact with corresponding conductive pads 38 of the conductive portion 37a of the second circuit board 30.

It should be appreciated that, in some embodiments, pairs of first conductive elements 300 are held in pairs of first bulges 109a and second bulges 109b. For example, the pairs of first conductive elements 300 may be disposed on opposite sides of the first portion 1031a of the first slot 103a.

As shown in FIGS. 10A to 11C, each first conductive element 300 includes a first terminal member 310 and a second terminal member 320. For example, each first conductive element 300 may be formed from two pieces of conductive material. The first terminal member 310 and the second terminal member 320 are stacked on top of each other to jointly form one first conductive element 300. The first terminal member 310 and the second terminal member 320 may be formed, for example, by stamping and bending. The first terminal member 310 includes a first base portion 311, and the second terminal member 320 includes a second base portion 321. The first base portion 311 and the second base portion 321 may each extend in the lateral direction X-X. The first base portion 311 and the second base portion 321 are stacked on top of each other in the vertical direction Z-Z, jointly forming the intermediate portion 303 of the first conductive element 300. For example, the intermediate portion 303 of the first conductive element 300 includes two layers. In some embodiments, outer contours of the first base portion 311 and the second base portion 321 in the vertical direction Z-Z may entirely overlap with each other. In one of these embodiments, as will be described below, the first base portion 311 and the second base portion 321 may be held together by the insulative housing 100 when disposed in the insulative housing 100. In another of these embodiments, the first base portion 311 and the second base portion 321 may be secured together, e.g., by any suitable process such as soldering, gluing, or the like, or by any suitable securing feature such as a snap feature, and subsequently disposed in the insulative housing 100.

As shown in FIG. 11A, for each first conductive element 300, the intermediate portion 303 includes a first segment 305 having a first edge 305a and a second edge 305b. The first edge 305a and the second edge 305b are opposite to each other in the longitudinal direction Y-Y and extend in the lateral direction X-X, respectively. For example, in the case where the outer contours of the first base portion 311 and the second base portion 321 in the vertical direction Z-Z entirely overlap with each other, the first edge 305a and the second edge 305b may be defined jointly by edges of the first base portion 311 and the second base portion 321. It should be appreciated that the first edge 305a may be defined by one of the first base portion 311 and the second base portion 321, and/or the second edge 305b may be defined by one of the first base portion 311 and the second base portion 321.

In some embodiments, as shown in FIGS. 10A, 10B, and 11A, the first edge 305a and the second edge 305b may be formed with a first barb feature 3051a and a second barb feature 3051b, respectively.

In some embodiments, as shown in FIG. 11A, the intermediate portion 303 may further include a second segment 306 extending from the first segment 305 in the lateral direction X-X. The second segment 306 has a third edge 306a and a fourth edge 306b. The third edge 306a and the fourth edge 306b are opposite to each other in the longitudinal direction Y-Y and extend in the lateral direction X-X, respectively. The third edge 306a and the fourth edge 306b are indented in the longitudinal direction Y-Y relative to the first edge 305a and the second edge 305b, respectively, forming a first indented portion 307a between the third edge 306a and the first edge 305a, and forming a second indented portion 307b between the fourth edge 306b and the second edge 305b.

With continued reference to FIGS. 10A to 11C, for each first conductive element 300, the first terminal member 310 further includes a first contact finger 312 (which may also be referred to as “a first beam”) extending from the first base portion 311. The first contact finger 312 is configured to extend from the first base portion 311 into the first slot 103a in the lateral direction X-X when the first conductive element 300 is disposed in a corresponding channel. The second terminal member 320 further includes two second contact fingers 322 (which may also be referred to as “second beams”) extending from the second base portion 321. Each second contact finger 322 is configured to extend from the second base portion 321 into the first slot 103a in the lateral direction X-X when the first conductive element 300 is disposed in the corresponding channel. The first contact finger 312 includes a first end 312a connected to the first base portion 311 and a second end 312b opposite to the first end 312a, and each of the two second contact fingers 322 includes a first end 322a connected to the second base portion 321 and a second end 322b opposite to the first end 322a. The first contact finger 312 and the two second contact fingers 322 jointly form the mating end 301 of the first conductive element 300. The second end 312b of the first contact finger 312 has a mating contact portion 312c for electrical contact with a corresponding conductive pad 38 of the conductive portion 37a of the second circuit board 30, and the second end 322b of each of the second contact fingers 322 has a mating contact portion 322c for electrical contact with the corresponding conductive pad 38 of the conductive portion 37a of the second circuit board 30. In this case, the mating end 301 of the first conductive element 300 may have three mating contact portions, e.g., one mating contact portion 312c and two mating contact portions 322c. The second end 312b of the first contact finger 312 may be positioned between the second ends 322b of the two second contact fingers 322.

In some embodiments, as shown in FIGS. 6E, 6F, and 10C, the mating contact portion 312c of the second end 312b of the first contact finger 312 and the mating contact portions 322c of the second ends 322b of the two second contact fingers 322 may be aligned with each other in the longitudinal direction Y-Y, and the contact surfaces of the mating contact portion 312c and the mating contact portions 322c may be coplanar with each other.

In some embodiments, as shown in FIGS. 10A to 10C, the first end 312a of the first contact finger 312 may be aligned with the first ends 322a of the two second contact fingers 322 in the vertical direction Z-Z. For example, the first ends 322a of the two second contact fingers 322 may be stacked on the first end 312a of the first contact finger 312 in the vertical direction Z-Z.

In some embodiments, as shown in FIGS. 10A to 10C, for each first conductive element 300, the first end 312a of the first contact finger 312 may be positioned closer to the first slot 103a in the vertical direction Z-Z than the first ends 322a of the two second contact fingers 322.

In some embodiments, as shown in FIG. 11A, the mating contact portion 312c of the second end 312b of the first contact finger 312 may be separated center-to-center from the mating contact portion 322c of the second end 322b of one of the two second contact fingers 322 by a first distance in the longitudinal direction Y-Y, and may be separated center-to-center from the mating contact portion 322c of the second end 322 of the other second contact finger 322 by a second distance in the longitudinal direction Y-Y. The first distance may be equal to the second distance, and may be equal to a pitch P1 (FIG. 11A). For example, two adjacent mating contact portions 301a of the mating end 301 of the first conductive element 300 may be separated center-to-center from each other by the pitch P1 in the longitudinal direction Y-Y. For example, the mating contact portions 301a of the mating end 301 of the first conductive element 300 may have the pitch P1.

As shown in FIG. 11B, the first contact finger 312 may include a first segment 312e and a second segment 312f. The first segment 312e includes the second end 312b of the first contact finger 312, and has a first average width in the longitudinal direction Y-Y. The second segment 312f extends from the first segment 312e in the lateral direction X-X towards the first end 312a, and has a second average width in the longitudinal direction Y-Y that is greater than the first average width. This configuration enables the second end 312b of the first contact finger 312 to be positioned in a gap between the two second contact fingers 322 while providing a lower resistance to the first contact finger 312 compared to a contact finger having a uniform width. This shape can also provide a greater wiping length. The width of the second segment 312f in the longitudinal direction Y-Y gradually increases from an end connected to the first segment 312e to the opposite end. This width may be monotonically increased.

As shown in FIGS. 11B and 11C, the mating contact portion 312c of the second end 312b of the first contact finger 312 has a width W1 in the longitudinal direction Y-Y, and the mating contact portion 322c of the second end 322b of each of the second contact fingers 322 has a width W2 in the longitudinal direction Y-Y. In some embodiments, the width W1 may be equal to the width W2. In some other embodiments, the width W1 may be in the range of 90% to 110% of the width W2, in the range of 70% to 150% of the width W2, or in the range of 50% to 200% of the width W2. For example, the width W1 may be twice the width W2. The width W1 and the width W2 may be designed to fill as much of the permissible space as possible to increase the current flow capacity. The values of width W1 and width W2 may be determined on the specific terminal shape.

As shown in FIG. 11C, each second contact finger 322 may include a first segment 322e and a second segment 322f. The first segment 322e includes the second end 322b of the second contact finger 322. The second segment 322f extends from the first segment 322e in the lateral direction X-X towards the first end 322a of the second contact finger 322. There is a first gap G1 between the first segments 322e of the two second contact fingers 322 in the longitudinal direction Y-Y, and there is a second gap G2 between the second segments 322f of the two second contact fingers 322 in the longitudinal direction Y-Y. The first gap G1 is larger than the second gap G2. For example, a larger first gap G1 is left in the distal region of the two second contact fingers 322 away from the second base portion 321, and a smaller second gap G2 is left in the proximal region closer to the second base portion 321. The larger first gap G1 may accommodate the first segment 312e of the first contact finger 312. The smaller second gap G2 enables the two second contact fingers 322 to flex independently of each other.

It should be appreciated that the first terminal member 310 of each first conductive element 300 may include more than one first contact finger 312, and the second terminal member 320 may include more than two second contact fingers 322. Thus, according to the present application, the first terminal member 310 may include at least one first contact finger 312 extending from the first base portion 311 into the first slot 103a in the lateral direction X-X, and the second terminal member 320 may include at least two second contact fingers 322 extending from the second base portion 321 into the first slot 103a in the lateral direction X-X. Each first contact finger 312 includes a first end 312a connected to the first base portion 311 and a second end 312b opposite to the first end 312a, and each second contact finger 322 includes a first end 322a connected to the second base portion 321 and a second end 322b opposite to the first end. The at least one first contact finger 312 and the at least two second contact fingers 322 jointly form the mating end 301 of the first conductive element 300. In this case, the second end of several (e.g., one, two, three, or more) first contact fingers of the at least one first contact finger 312 may be positioned between the second ends 322b of two corresponding adjacent second contact fingers 322 of the at least two second contact fingers 322. The mating contact portion 312c of the second end 312b of the at least one first contact finger 312 and the mating contact portions 322c of the second ends 322b of the at least two second contact fingers 322 may be aligned with each other in the longitudinal direction Y-Y, and the contact surfaces of the mating contact portion 312c of the second end 312b of the at least one first contact finger 312 and the contact surfaces of the mating contact portion 322c of the second ends 322b of the at least two second contact fingers 322 may be coplanar with each other. The first end 312a of the at least one first contact finger 312 may be positioned closer to the first slot 103a in the vertical direction Z-Z than the first ends 322a of the at least two second contact fingers 322. The mating end 301 of each first conductive element 300 may have at least three mating contact portions 301a. In some embodiments, adjacent mating contact portions 301a of the mating end 301 of the first conductive element 300 may be separated center-to-center from each other by the pitch P1 in the longitudinal direction Y-Y.

As shown in FIGS. 6A, 6E to 6G, and 10A to 10C, the first channel 110a and the second channel 110b are aligned with each other in the vertical direction Z-Z, and the first channel 110a and the second channel 110b are each provided with one first conductive element 300. The first conductive elements 300 are spaced apart from each other in the vertical direction Z-Z. The contact surfaces of the mating contact portion 312c of the first contact finger 312 and the mating contact portions 322c of the two second contact fingers 322 of one of the first conductive elements 300 are opposing to the contact surfaces of the mating contact portion 312C of the first contact finger 312 and the mating contact portions 322 of the two second contact fingers 322 of the other first conductive element 300 in the vertical direction Z-Z, so as to make electrical contact with the conductive pads 38 on opposite sides of the insert portion 36a of the circuit board 30.

As shown in FIGS. 10A to 11C, for each first conductive element 300, the first terminal member 310 includes two first mount pins 313 extending from the first base portion 311 opposite to the first contact finger 312, and the second terminal member 320 includes two second mount pins 323 extending from the second base portion 321 opposite to the second contact fingers 322. The two first mount pins 313 each extend from the first base portion 311 in the lateral direction X-X, and the two second mount pins 323 each extend from the second base portion 321 in the lateral direction X-X. Each of the two first mount pins 313 is stacked on a corresponding one of the two second mount pins 323, jointly forming the mounting end 302 of the first conductive element 300. For example, the first conductive element 300 has two mounting ends 302.

In some embodiments, as shown in FIGS. 10A to 11C, the first mount pins 313 and the second mount pins 323 may each be curved such that the mounting end 302 includes a first segment 302a, a second segment 302b, and a curved portion 302c connecting the first segment 302a to the second segment 302b. The first segment 302a of the mounting end 302 extends from the intermediate portion 303 in the lateral direction X-X, and the curved portion 302c is curved such that the second segment 302b is oriented in the vertical direction Z-Z so as to be mounted to the aforementioned first circuit board (not shown). In some other embodiments, the first mount pins 313 and the second mount pins 323 may each be straight in the lateral direction X-X.

As shown in FIGS. 4B, 6D, 6E to 6G, and 10A to 10C, the second segments 302b of the mounting ends 302 of the first conductive elements 300 are arranged in two rows, e.g., a first row R1 and a second row R2, in the lateral direction X-X. The first row R1 is closer to the insulative housing 100 than the second row R2.

It should be appreciated that for each first conductive element 300, the first terminal member 310 may include more than two first mount pins 313, and the second terminal member 320 may include more than two second mount pins 323. For example, for each first conductive element 300, the first terminal member 310 may include at least two first mount pins 313, and the second terminal member 320 may include at least two second mount pins 323. The amount of the at least two first mount pins 313 is the same as the amount of the at least two second mount pins 323, and each of the at least two first mount pins 313 is stacked on a corresponding one of the at least two second mount pins 323, jointly forming the mounting end 302 of the first conductive element 300.

It should also be appreciated that for each first conductive element 300, the first terminal member 310 may include one first mount pin 313, and the second terminal member 320 may include one second mount pin 323. The first mount pin 313 is stacked on the second mount pin 323, jointly forming the mounting end 302 of the first conductive element 300.

Alternatively or additionally, as shown in FIGS. 4A to 5, 6B to 6D, and 6H to 7F, the insulative housing 100 may include a first arm 111 and a second arm 112 extending from the second face 101b away from the insulative housing 100 in the lateral direction X-X. The intermediate portion 303 of each of the first conductive elements 300 is disposed between the first arm 111 and second arm 112 and is held in position relative to the insulative housing 100 by the first arm 111 and the second arm 112, such that the mating end 301 is disposed in a corresponding one of the first channel 110a and the second channel 110b. The mating contact portion 301a of the mating end 301 may be curved into the first portion 1031a of the first slot 103a. The first channel 110a and the second channel 110b may be aligned with a space between the first arm 111 and the second arm 112 in the lateral direction X-X, respectively. This configuration can enable the first conductive element 300 with a larger size to be disposed in the same slot as the plurality of second conductive elements 400 without significantly increasing the overall width of the insulative housing 100 of the electrical connector 10 in the lateral direction X-X. Thus, this configuration does not significantly increase the space occupied by the electrical connector 10 on the first circuit board such as a motherboard. Furthermore, in some embodiments, as will be described below, this configuration enables the high-density electrical connector to provide both high-quality, and high-speed signal transmission and high power transmission. Moreover, in some embodiments, as will be described below, the electrical connector 10 configured according to the present application can be backwardly compatible with the second circuit board 30 designed and manufactured according to a particular specification, such as the second circuit board 30 designed and manufactured according to the current version of SFF-TA-1002.

In some embodiments, in the case where the first conductive element 300 includes the first terminal member 310 and the second terminal member 320, the first base portion 311 and the second base portion 321 may be held together by the first arm 111 and the second arm 112, and may be held in position relative to the insulative housing 100 by the first arm 111 and the second arm 112.

As shown in FIGS. 4C, 6C, 7D, and 7F, the first arm 111 includes a first arm surface 111a, and the second arm 112 includes a second arm surface 112a. The first arm surface 111a and the second arm surface 112a face each other in the longitudinal direction Y-Y. The first arm 111 further includes a first receiving slot 111b recessed into the first arm 111 from the first arm surface 111a and extending in the lateral direction X-X, and the second arm 112 further includes a second receiving slot 112b recessed into the second arm 112 from the second arm surface 112a and extending in the lateral direction X-X. The first edge 305a and the second edge 305b of the first segment 305 of the intermediate portion 303 of the first conductive element 300 are received and held in the first receiving slot 111b and the second receiving slot 112b, respectively, such that the intermediate portion 303 is retained between the first arm 111 and the second arm 112.

In some embodiments, each first conductive element 300 may be configured to be inserted into the insulative housing 100 in the lateral direction X-X from a space between the first arm 111 and the second arm 112 such that the intermediate portion 303 is inserted between the first arm 111 and the second arm 112. As described above, the first edge 305a and the second edge 305b of the first segment 305 are formed with a first barb feature 3051a and a second barb feature 3051b, respectively. When the intermediate portion 303 is inserted between the first arm 111 and the second arm 112, the first barb feature 3051a of the first edge 305a engages the first receiving slot 111b in the lateral direction X-X and the second barb feature 3051b of the second edge 305b engages the second receiving slot 112b in the lateral direction X-X to limit the withdrawal of the intermediate portion 303 in the lateral direction X-X. The second segment 306 of the intermediate portion 303 of each first conductive element 300 may be configured to enter into the space between the first arm 111 and the second arm 112 prior to the first segment 305 when the intermediate portion 303 is inserted into the space between the first arm 111 and the second arm 112. When the intermediate portion 303 is inserted between the first arm 111 and the second arm 112, the first indented portion 307a between the third edge 306a and the first edge 305a engages the first receiving slot 111b in the lateral direction X-X, and the second indented portion 307b between the fourth edge 306b and the second edge 305b engages the second receiving slot 112b in the lateral direction X-X, thereby limiting further insertion of the intermediate portion 303 in the lateral direction X-X. In this way, it is possible to limit the movement of the intermediate portion 303 relative to the insulative housing 100 in the lateral direction X-X.

In some embodiments, as shown in FIGS. 4B, 4C, 6A, and 6H, the first edge 305a and the second edge 305b of the first segment 305, the first receiving slot 111b of the first arm 111, and the second receiving slot 112b of the second arm 112 may be configured such that when the first edge 305a and the second edge 305b are inserted into the first receiving slot 111b and the second receiving slot 112b, respectively, the first edge 305a engages the first receiving slot 111b in the longitudinal direction Y-Y and the second edge 305b engages the second receiving slot 112b in the longitudinal direction Y-Y to limit the movement of the intermediate portion 303 relative to the insulative housing 100 in the longitudinal direction Y-Y. It should be appreciated that, in some examples, the first edge 305a, the second edge 305b, the first receiving slot 111b, and the second receiving slot 112b may be used as guiding features to guide the insertion of the intermediate portion 303 between the first arm 111 and the second arm 112.

In some embodiments, as shown in FIGS. 4B, 4C, and 6A, the first edge 305a and the second edge 305b of the first segment 305, the first receiving slot 111b of the first arm 111, and the second receiving slot 112b of the second arm 112 may be configured such that when the first edge 305a and the second edge 305b are inserted into the first receiving slot 111b and the second receiving slot 112b, respectively, the first edge 305a engages the first receiving slot 111b in the vertical direction Z-Z, and the second edge 305b engages the second receiving slot 112b in the vertical direction Z-Z to limit the movement of the intermediate portion 303 relative to the insulative housing 100 in the vertical direction Z-Z. It should be appreciated that, in some examples, the first edge 305a, the second edge 305b, the first receiving slot 111b, and the second receiving slot 112b may be used as guiding features to guide the insertion of the intermediate portion 303 into the space between the first arm 111 and the second arm 112.

Alternatively or additionally, as shown in FIG. 5, the electrical connector 10 further includes an insulative member 500. The insulative member 500 may be formed from an insulative material. Examples of insulative materials that are suitable for forming the insulative member 500 include, but are not limited to, plastic, nylon, liquid crystal polymer (LCP), polyphenylene sulfide (PPS), high temperature nylon or polyphenylene oxide (PPO) or polypropylene (PP). The insulative member 500 is disposed between the first arm 111 and the second arm 112 to separate the mounting ends 302 of the first conductive elements 300 from each other. In particular, the insulative member 500 is disposed between the first row R1 and the second row R2 of second segments 302b of the mounting ends 302 of the first conductive elements 300, and separates the second segments 302b from each other.

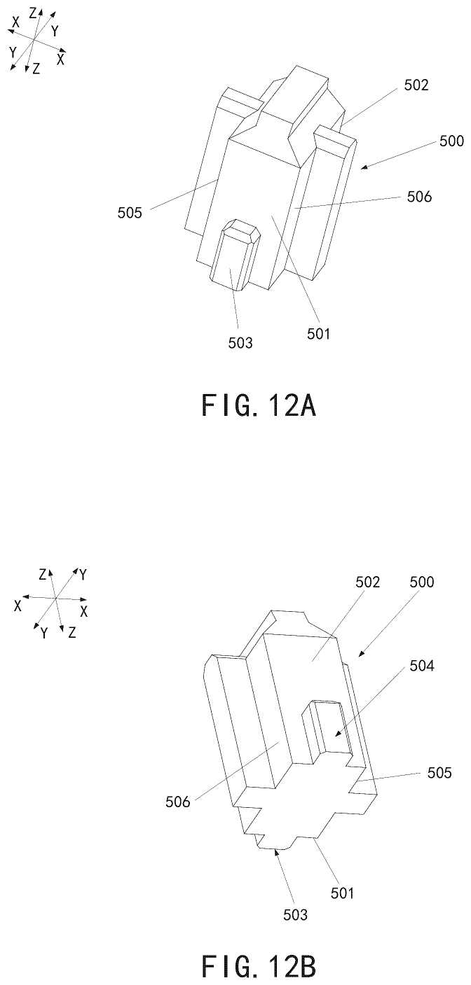

As shown in FIGS. 12A and 12B, the insulative member 500 includes a first surface 501 and a second surface 502 opposite to each other in the longitudinal direction Y-Y and a third surface 505 and a fourth surface 506 opposite to each other in the lateral direction X-X. When the insulative member 500 is disposed between the first arm 111 and the second arm 112, the first surface 501 and the second surface 502 face the first arm surface 111a and the second arm surface 112a, respectively.

In some embodiments, as shown in FIGS. 6D, 7D, and 7F, the first arm 111 may include a third receiving slot 111c recessed into the first arm 111 from the first arm surface 111a and extending in the vertical direction Z-Z, and the second arm 112 may include a fourth receiving slot 112c recessed into the second arm 112 from the second arm surface 112a and extending in the vertical direction Z-Z. The third receiving slot 111c and the fourth receiving slot 112c may be aligned with each other in the longitudinal direction Y-Y. The insulative member 500 may include a first rib 503 protruding from the first surface 501 and extending in the vertical direction Z-Z, and a second rib 504 protruding from the second surface 502 and extending in the vertical direction Z-Z. When the insulative member 500 is disposed between the first arm 111 and the second arm 112, the first rib 503 and the second rib 504 are received in the third receiving slot 111c and the fourth receiving slot 112c, respectively, to limit the movement of the insulative member 500 relative to the insulative housing 100 in the lateral direction X-X and the longitudinal direction Y-Y. In particular, the first rib 503 may engage the third receiving slot 111c in the lateral direction X-X and the second rib 504 may engage the fourth receiving slot 112c in the lateral direction X-X to limit the movement of the insulative member 500 relative to the insulative housing 100 in the lateral direction X-X. The first rib 503 may engage the third receiving slot 111c in the longitudinal direction Y-Y, and the second rib 504 may engage the fourth receiving slot 112c in the longitudinal direction Y-Y to limit the movement of the insulative member 500 relative to the insulative housing 100 in the longitudinal direction Y-Y. It should be appreciated that, in some examples, the first rib 503, the second rib 504, the third receiving slot 111c, and the fourth receiving slot 112c may be used as guiding features to guide the insertion of the insulative member 500 between the first arm 111 and the second arm 112.

In some embodiments, as shown in FIG. 6G, the insulative member 500 may support the first row R1 of the second segment 302b in the longitudinal direction Y-Y. This can help to reliably retain the corresponding first conductive element 100 between the first arm 111 and the second arm 112.

In some embodiments, the second segments 302b may exert a clamping force on the insulative member 500 to retain the insulative member 500 in the insulative housing 100. For example, as shown in FIGS. 10A to 10C, four second segments 302b may clamp the insulative member 500 and may be spaced apart from each other by the insulative member 500.

It should be appreciated that the insulative member 500 may be retained in the insulative housing 100 by any other suitable mechanism.

The plurality of second conductive elements 400 may be arranged in two rows. In some embodiments, as shown in FIGS. 5 and 8A to 9C, the electrical connector 10 may include an insulative assembly housing 400R, and the plurality of second conductive elements 400 are retained by the assembly housing 400R in two rows mutually opposed and spaced apart from each other. The mating contact portions 401a of the plurality of second conductive elements 400 may be arranged in two rows in the longitudinal direction Y-Y. As shown in FIGS. 8B and 8E, the mating contact portions 401a in each row are aligned with each other in the longitudinal direction Y-Y, and the contact surfaces of the mating contact portions 401a are coplanar with each other. The assembly housing 400R may surround the intermediate portions 403 of the plurality of second conductive elements 400 to hold the plurality of second conductive elements 400 in position relative to each other. The assembly formed by the assembly housing 400R and the plurality of second conductive elements 400 may be inserted into the insulative housing 100, such as through channels recessed into the insulative housing 100 from the second face 101b of the insulative housing 100. The assembly housing 400R may be held by the insulative housing 100, thereby retaining the plurality of second conductive elements 400 in the insulative housing 100. It should be appreciated that the present application is not limited thereto, and that the plurality of second conductive elements 400 may be disposed in the insulative housing 100 by any other suitable mechanism or process.

At least a portion of the plurality of second conductive elements 400 may be configured for transmitting signal. For example, a first portion 400 (schematically circled by a dashed frame in FIG. 8F) of the plurality of second conductive elements 400 may be configured to transmit differential signals. FIGS. 9A to 9C illustrate a group of three conductive elements of the first portion 400 of the plurality of second conductive elements 400. The group of three conductive elements includes a ground terminal 400G and a pair of signal terminals 400S forming a differential signal pair for carrying differential signals. In particular, one of the pair of signal terminals 400S may be energized by a first voltage and the other may be energized by a second voltage. The voltage difference between the pair of signal terminals 400S represents a signal. The ground terminal 400G and the signal terminals 400S may have the same configuration. It should be appreciated that the present application is not limited thereto.

As shown in FIG. 8F, the plurality of ground terminals 400G may be arranged adjacent to each pair of signal terminals 400S to separate the plurality of pairs of signal terminals 400S from each other, thereby reducing crosstalk between signals and improving signal integrity. The plurality of ground terminals 400G and the plurality of pairs of signal terminals 400S are arranged in a “G-S-S-S-G-S-S . . . G-S-S-G” pattern (wherein “G” represents the ground terminals 400G and “S” represents the signal terminals 400S), wherein a ground terminal 400G is disposed between two adjacent pairs of signal terminals 400S. Separating multiple pairs of signal terminals 400S from each other with the ground terminals 400G can reduce crosstalk, thereby improving signal integrity.

In some embodiments, the electrical connector 10 may also include a lossy member 400L. As shown in FIGS. 8D to 8F, the lossy member 400L may be configured to electrically couple the plurality of ground terminals 400G together. The lossy member 400L is formed from a lossy material. A material may be regarded as lossy, that dissipate a sufficient portion of the electromagnetic energy interacting with that material to appreciably impact the performance of an electrical connector. A meaningful impact results from attenuation over a frequency range of interest for an electrical connector. In some configurations, lossy material may suppress resonances within ground structures of the electrical connector and the frequency range of interest may include the natural frequency of the resonant structure, with the lossy material being not in place. In other configurations, the frequency range of interest may be all or part of the operating frequency range of the electrical connector.

Electrically coupling the plurality of ground terminals 400G together by the lossy member 400L can reduce the effect of the electrical resonance, thereby improving the integrity of the signal. In particular, when the electrical resonance occurs at a frequency within the operating frequency range of the electrical connector 10, the integrity of the high-speed signal passing through the electrical connector 10 deteriorates. The deterioration in the integrity of the signal passing through the electrical connector 10 is partially caused by the loss of signal energy coupled into the resonant signal, which may cause that less signal energy passes through the electrical connector 10. The deterioration in the integrity of the signal passing through the electrical connector 10 is also partially caused by the coupling of the resonant signal from the ground terminals 400G to the signal terminals 400S. The resonant signal accumulates and possesses a high amplitude, so that when the resonant signal is coupled from the ground terminals 400G to the signal terminals 400S, it will generate a large amount of noise that interferes with the signal. Sometimes, the resonant signal coupled to the signal terminals 400S is also referred to as crosstalk. The frequency at which electrical resonance occurs may be related to the length of the ground terminals supporting the electrical resonance, the reason is that the wavelength of the resonant signal is related to the length of the ground terminals supporting the resonance, and the frequency is inversely related to the wavelength. Electrically coupling the lossy member 400L to the ground terminals 400G can enable energy coupled into the ground terminals 400G and accumulated into a resonant signal to be dissipated in the lossy member 400L, which reduces the possibility of the occurrence of electrical resonance, thereby increasing signal integrity and improving the operating frequency range of the electrical connector 10.

The lossy member 400L may be retained by the assembly housing 400R and electrically couple the plurality of ground terminals 400G together at the mounting ends 402 of the plurality of ground terminals 400G. The lossy member 400L may be positioned to abut against the ground terminal 400G or to be sufficiently close to the ground terminal 400G, so as to sufficiently couple with the ground terminal 400G. Close contact does not require an electrical coupling between the lossy material and the ground terminals 400G, as sufficient electrical coupling, such as capacitive coupling, between the lossy member 400L and the ground terminals 400G can achieve the desired result.

A second portion 4002 (schematically circled by a dashed frame in FIG. 8F) of the plurality of second conductive elements 400 may be configured to transmit power and/or signal. For example, the second portion 4002 of the plurality of second conductive elements 400 may be configured to transmit a signal such as a sideband signal. As another example, the second portion 4002 of the plurality of second conductive elements 400 may include a power terminal 400P configured to transmit power. The second conductive elements 400 of the first portion 4001 and the second portion 4002 of the plurality of second conductive elements 400 may have the same configurations. As shown in FIG. 9A, the mating contact portion 401a of the ground terminal 400G has a width W3 in the longitudinal direction Y-Y, and the mating contact portions 401a of two adjacent terminals of the pair of signal terminals 400S and the ground terminals 400G are separated center-to-center from each other by a pitch in the longitudinal direction Y-Y. It should be appreciated that the mating contact portion 401a of each of the second conductive elements 400 has the width W3 in the longitudinal direction Y-Y, and two adjacent mating contact portions 401a in each row of the second conductive elements 400 are separated center-to-center from each other by the pitch P2 in the longitudinal direction Y-Y. In a specification such as SFF-TA-1002, the pitch is 0.6 mm. In some other embodiments, the pitch may be less than 0.6 mm or greater than 0.6 mm.

As shown in FIGS. 4A and 6A and as described above, the mating contact portions 301a of the first conductive elements 300 are arranged in two first rows in the longitudinal direction Y-Y and are exposed in the first portion 1031a of the first slot 103a. The mating contact portions 401a of the plurality of second conductive elements 400 are arranged in two second rows in the longitudinal direction Y-Y and are exposed in the second portion 1032a of the first slot 103a. Each of the two first rows and a corresponding one of the two second rows are aligned with and spaced apart from each other in the longitudinal direction Y-Y. As described above, two adjacent mating contact portions in each first row (e.g., two adjacent contact portions of the mating contact portion 312c of the first contact finger 312 of the first terminal member 310 and the mating contact portions 322c of the second contact fingers 322 of the second terminal member 320) are separated center-to-center from each other by the pitch P1 (FIG. 11A) in the longitudinal direction Y-Y, and the two adjacent mating contact portions (e.g., the mating contact portion 401a) in each second row are separated center-to-center from each other by the pitch P2 (FIG. 9C) in the longitudinal direction Y-Y. The pitch P1 may be greater than the pitch P2. Furthermore, as described above, the mating contact portion 312c of the first contact finger 312 of the first terminal member 310 of the first conductive element 300 has the width W1 in the longitudinal direction Y-Y, and the mating contact portion 322c of the second contact finger 322 of the second terminal member 320 of the first conductive element 300 has the width W2 in the longitudinal direction Y-Y. The mating contact portion 301a of each of the plurality of second conductive elements 400 has the width W3 in the longitudinal direction Y-Y. W1 may be equal to W2. W1 may be greater than W3, and W2 may be greater than W3.

One or more of the above configurations of the first conductive elements 300 enables the first conductive elements 300 to generate less heat for a given current than power terminals such as the power terminals 400P. For example, one or more of the above configurations of the first conductive elements 300 enables the first conductive elements 300 to transmit more power at a maximum temperature rise that can be tolerated. For example, first conductive elements are capable of transmitting a power of up to 200 W with a maximum temperature rise of 30° C. above ambient temperature.

The inventors have recognized and appreciated that by disposing the first conductive elements 300 and the plurality of second conductive elements 400 in the first slot 103a and configuring each of the plurality of first conductive elements 300 for transmitting power and at least a portion of the plurality of second conductive elements 400 for transmitting signals, it is possible for the electrical connector 10 to provide high-quality signal transmission and high power transmission without significantly increasing the space occupied by the electrical connector 10 on the circuit board. In addition, this also enables the electrical connector 10 to be backward compatible with existing specifications, such as SFF-TA-1002, while providing high-quality, high-speed signal transmission and high power transmission.

In some embodiments, as shown in FIG. 8F, the second portion 4002 of the plurality of second conductive elements 400 may be disposed between the first portion 4001 of the plurality of second conductive elements 400 and the first conductive elements 300 in the longitudinal direction Y-Y. With such a configuration, interference to the differential signals transmitted by the first portion 4001 of the plurality of second conductive elements 400 can be reduced. In one of these embodiments, the second portion 4002 of the plurality of second conductive elements 400 is disposed in a region of each of the two second rows immediately adjacent to the corresponding one first row. In addition, the power terminals 400P of the second portion 4002 of the plurality of second conductive elements 400 may be disposed between the signal terminals of the second portion 4002 and the first conductive elements 300 in the longitudinal direction Y-Y.

In some embodiments, each of the two first rows and a corresponding one of the two second rows are separated from each other by at least twice the pitch P2 in the longitudinal direction Y-Y. With such a configuration, it is possible to reduce interference to differential signals transmitted by the first portion 4001 of the plurality of second conductive elements 400.

In some embodiments, the pitch P1 may be greater than or equal to 0.8 mm. For example, the pitch P1 may be 0.8 mm, 0.9 mm, 1.0 mm, etc.

In some embodiments, the pitch P1 is greater than 1.5 times the pitch P2. For example, the pitch P1 is N times the pitch P2, wherein N is an integer greater than 1. As will be described in detail below, at least one of the width W1 and the width W2 may be greater than N−1 times the pitch P2.

Referring back to FIGS. 2A and 2B, the plurality of conductive pads 38 disposed on each of the conductive portions 37a of the insert portion 36a of the second circuit board 30 may be separated from each other by a pitch P2 in the longitudinal direction Y-Y, and each of the conductive pads 38 has a width W4 in the longitudinal direction Y-Y. The width W3 of the mating contact portion 301a in the longitudinal direction Y-Y may be equal to the width W4. The plurality of conductive pads 38 may include signal pads 38S, ground pads 38G, and power pads 38P. The first conductive elements 300 and the second conductive elements 400 of the electrical connector 10 and the signal pads 38S, the ground pads 38G, and the power pads 38P of the conductive portion 37a of the second circuit board 30 may be disposed in correspondence with each other, such that when the insert portion 36a is inserted in the slot 103a, the mating contact portions of the first conductive elements 300 and the second conductive elements 400 are in electrical contact with corresponding pads of the signal pads 38S, the ground pads 38G, and the power pads 38P. The mating contact portion 401a of each second conductive element 400 may be in electrical contact with a corresponding one of the pads. For example, the signal terminal 400S may be in electrical contact with the signal pad 38S, and the ground terminal 400G may be in electrical contact with the ground pad 38G. Each mating contact portion 301a of the first conductive element 300 may be in contact with at least two power pads 38P. For example, the first conductive elements 300 electrically contact a first conductive portion of the insert portion 36a, and the plurality of the second conductive elements 400 electrically contact a second conductive portion of the insert portion 36a. The first conductive portion includes a plurality of conductive pads 38, and each mating contact portion 301a of the first conductive elements 300 electrically contacts at least two conductive pads 38. The second conductive portion includes a plurality of conductive pads 38, and each mating contact portion 401a of the second conductive element 400 electrically contacts a corresponding one of the conductive pads 38.

With such a configuration, the electrical connector 10 can be backwardly compatible with the second circuit board 30 designed and manufactured according to a particular specification, such as the second circuit board 30 designed and manufactured according to the current version of SFF-TA-1002, while providing high-quality, high-speed signal transmission and high power transmission.

In some embodiments, as described above, the pitch P1 is greater than 1.5 times the pitch P2. In this case, one mating contact portion 301a of the first conductive element 300 may be in electrical contact with at least two power pads 38P simultaneously. In one of these embodiments, the pitch P1 is N times the pitch P2, wherein N is an integer greater than 1, and the width (the width W1 and the width W2) of the mating contact portion 301a of the first conductive element 300 may be greater than N−1 times the pitch P2. In this case, one of the mating contact portions 301a of the first conductive element 300 may be in electrical contact with at least N power pads 38P simultaneously. In one of these embodiments, the width of the mating contact portion 301a of the first conductive element 300 may be equal to N−1 times the pitch P2 plus the width W4 of the conductive pad 38. For example, the width of the mating contact portion 301a of the first conductive element 300 may be equal to N−1 times the pitch P2 plus the width W3.

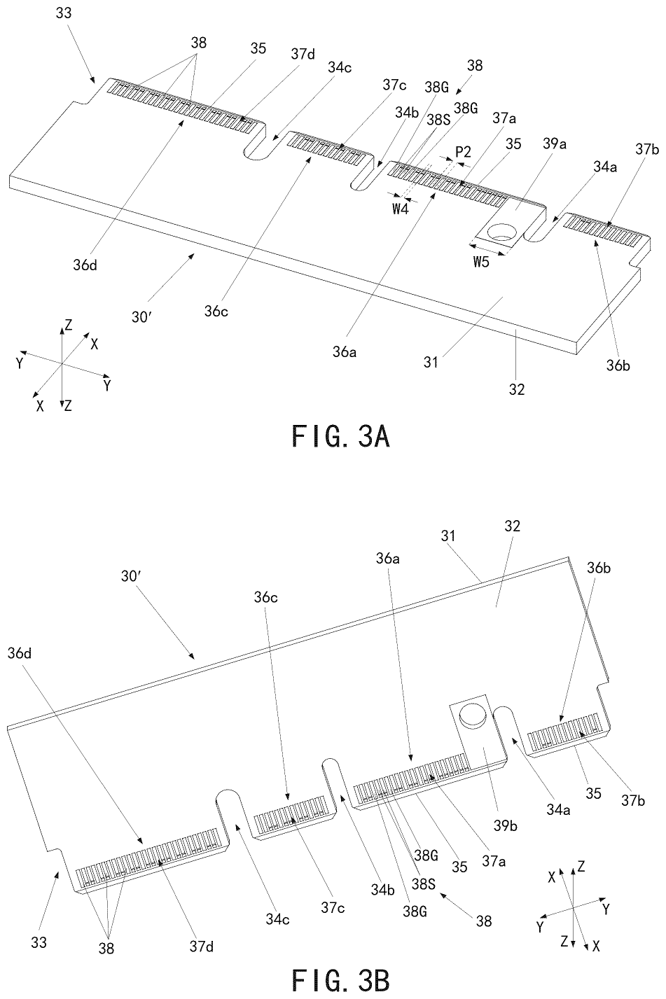

FIGS. 3A and 3B illustrate a second exemplary type of the electrical component 3. The second circuit board 30′ may be configured to be used in a high power (e.g., 200 W) application. The electrical component 3 is labeled in FIG. 3 by the second circuit board 30′. The second circuit board 30′ of FIGS. 3A and 3B is substantially the same as the second circuit board 30 shown in FIGS. 2A and 2B. Thus, the same reference signs are used in FIGS. 3A and 3B to denote portions of the second circuit board 30′ that are the same as the second circuit board 30 shown in FIGS. 2A and 2B, and those same portions may not be repeated herein.

The second circuit board 30′ shown in FIGS. 3A and 3B differs from the second circuit board 30 shown in FIGS. 2A and 2B in that the second circuit board 30′ is provided with a first conductive region 39a and a second conductive region 39b at the insert portion 36a. The first conductive region 39a and the second conductive region 39b are each continuous in the longitudinal direction Y-Y. The first conductive region 39a and the second conductive region 39b are each configured to be in electrical contact with a corresponding one of the first conductive elements 300. The first conductive element 300 disposed in the first channel 110a may electrically contact the first conductive region 39a, and the first conductive element 300 disposed in the second channel 110b may electrically contact the second conductive region 39b. With such a configuration, a high power transmission of, for example, 200 W may be provided.

As shown in FIG. 3A, the first conductive region 39a and the second conductive region 39b may be disposed symmetrically to each other on opposite sides of the insert portion 36a. The first conductive region 39a has a width W5 in the longitudinal direction Y-Y. The width W5 of the first conductive region 39a may be greater than the width W4 of the conductive pad 38. For example, the width W5 of the conductive region 39a may be greater than or equal to the width W4 of the conductive pad 38 plus the pitch P2. Similarly, the width of the second conductive region 39b in the longitudinal direction Y-Y may be equal to the width W5.

It should be appreciated that the second group of conductive elements 200b disposed in the second slot 103b, the third group of conductive elements 200c disposed in the third slot 103c, and the fourth group of conductive elements 200d disposed in the fourth slot 103d of the electrical connector 10 may have configurations similar to those of the plurality of second conductive elements 400. For example, at least a portion of the second group of conductive elements 200b may be configured for transmitting signal.

Although aspects of the electrical connector 10 is described above specifically in connection with the embodiment in which the electrical connector 10 has the first conductive elements 300 arranged in two rows and the plurality of second conductive elements 400 arranged in two rows, it should be appreciated that the electrical connector 10 may have one first conductive element 300 or may have more first conductive elements 300. Accordingly, the electrical connector 10 may have a plurality of insulative members 500 each disposed between two corresponding adjacent arms to separate the mounting ends 302 of the corresponding ones of the plurality of first conductive elements 300 from each other. Thus, the electrical connector 10 may include at least one row of first conductive elements 300. Aspects of the insulative housing 100 may be varied accordingly. For example, the insulative housing 100 may have one portion and one corresponding channel, or more than two channels. As another example, the insulative housing 100 may have more than two arms. For each first conductive element 300, the intermediate portion 303 is disposed between two corresponding adjacent arms of the plurality of arms and is held in position relative to the insulative housing 100 by the two corresponding adjacent arms.

It should be appreciated that the electrical component 3 may be any other suitable type of electrical component, such as a plug connector.

Although aspects of the electrical connector 10 is specifically described above in connection with the embodiments in which each first conductive element 300 includes the first terminal member 310 and the second terminal member 320, it should be appreciated that the first conductive element 300 may be in any other suitable form. For example, the first conductive element 300 may be made from one piece of metal, or may have one contact finger and/or one mount pin.

### Second Exemplary Embodiment

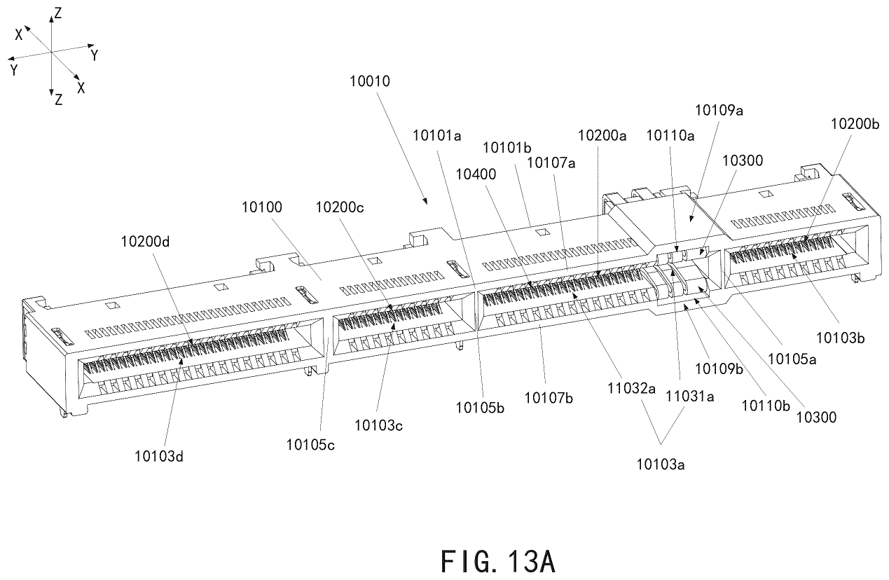

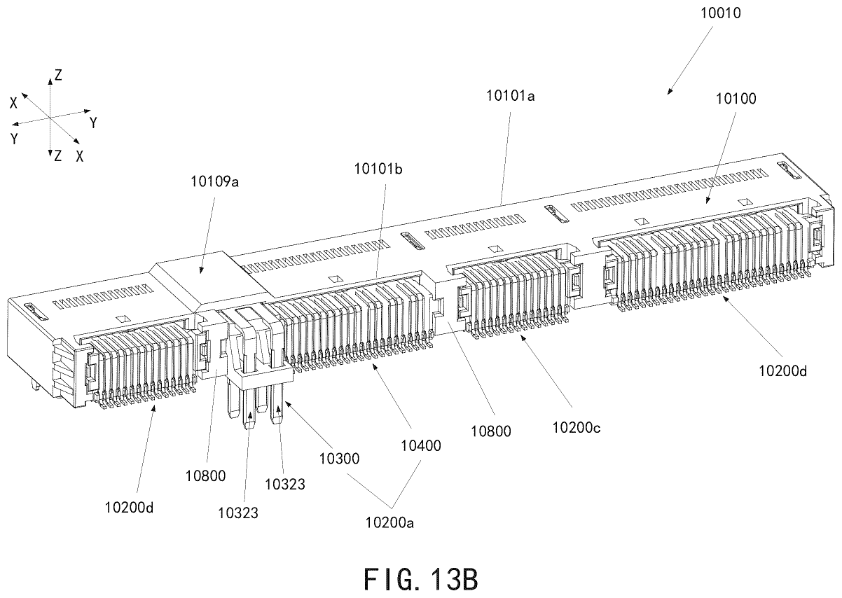

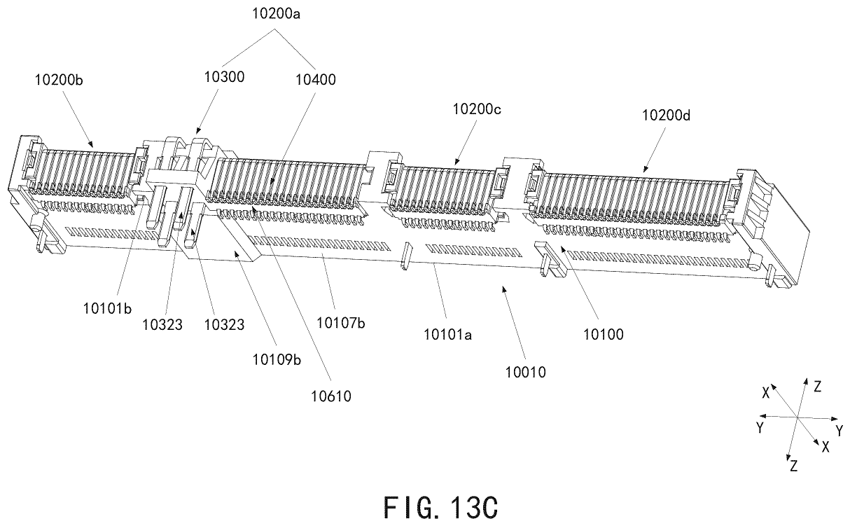

FIGS. 13A to 18G illustrate an electrical connector 10010 according to a second embodiment of the present application. Similar to FIGS. 4A to 12B, a lateral direction X-X, a longitudinal direction Y-Y, and a vertical direction Z-Z may be shown in the figures. The lateral direction X-X, the longitudinal direction Y-Y, and the vertical direction Z-Z may be perpendicular to each other. The lateral direction X-X may refer to a width direction of the electrical connector 10010. The longitudinal direction Y-Y may refer to a length direction of the electrical connector 10010. The vertical direction Z-Z may refer to a height direction of the electrical connector 10010.

Similar to the electrical connector 10 shown in FIGS. 4A to 12B, the electrical connector 10010 may be used in the electronic system 1 to establish an electrical connection between the electrical component 3 (e.g., the second circuit board 30 shown in FIGS. 2A and 2B and the second circuit board 30′ shown in FIGS. 3A and 3B) and the circuit board (not shown). The electrical connector 10010 is capable of establishing an electrical connection between the electrical component 3 and the circuit board (not shown) in a similar manner to the electrical connector 10. For the sake of brevity, those details included above may not be repeated.

As shown in FIGS. 4A to 12B and 13A to 18G, aspects of the electrical connector 10010 may be similar to aspects of the electrical connector 10. Accordingly, for parts or portions of the electrical connector 10010 that are identical or similar to those of the electrical connector 10, the identical or similar parts or portions of the electrical connector 10010 may be labeled in FIGS. 13A to 18G with the reference signs that label the parts or portions of the electrical connector 10 in FIGS. 4A to 12B plus “10,000 (ten thousand)” so as to label the identical or similar parts or portions of the electrical connector 10010. For the sake of brevity, the details of these identical or similar parts or portions may not be repeated.

As shown in FIGS. 13A to 18G, the electrical connector 10010 may be a card edge connector, specifically a right angle (RA) connector. The electrical connector 10010 is capable of arranging the aforementioned first circuit board and the second circuit board 30 or 30′ to be parallel to each other in a similar manner to the electrical connector 10.

Similar to the electrical connector 10, the electrical connector 10010 includes an insulative housing 10100 and a plurality of conductive elements disposed in the insulative housing 10100.

As shown in FIGS. 13A, 14, 15A, and 16A to 16D, similar to the insulative housing 100 of the electrical connector 10, the insulative housing 10100 of the electrical connector 10010 includes a first face 10101a and a second face 10101b opposite to each other in the lateral direction X-X, and a first slot 10103a, a second slot 10103b, a third slot 10103c, and a fourth slot 10103d recessed into the insulative housing from the first face 10101a in the lateral direction X-X, respectively. The insert portions 36a, 36b, 36c, and 36d of the second circuit board 30 or 30′ may be inserted into the first slot 10103a, the second slot 10103b, the third slot 10103c, and the fourth slot 10103d, respectively. The second slot 10103b and the first slot 10103a are separated by a divider 10105a in the longitudinal direction Y-Y, the first slot 10103a and the third slot 10103c are separated by a divider 10105b in the longitudinal direction Y-Y, and the third slot 10103c and the fourth slot 10103d are separated by a divider 10105c in the longitudinal direction Y-Y.

As shown in FIGS. 13A to 15D, similar to the plurality of conductive elements of the electrical connector 10, the plurality of conductive elements of the electrical connector 10010 includes a first group of conductive elements 10200a disposed in the first slot 10103a, a second group of conductive elements 10200b disposed in the second slot 10103b, a third group of conductive elements 10200c disposed in the third slot 10103c, and a fourth group of conductive elements 10200d disposed in the fourth slot 10103d. Each of the conductive elements includes a mating end having a mating contact portion, a mounting end opposite to the mating end, and an intermediate portion connecting the mating end to the mounting end. The mating end may be configured to mate with a corresponding conductive portion of the electrical component 3 such as the aforementioned second circuit board 30 and 30′, and the mounting end may be configured to be mounted to a corresponding conductive portion of a circuit board such as the aforementioned first circuit board. Each conductive element is held in an insulative housing 10100 with the mating contact portion of the mating end exposed in a corresponding slot for electrical contact with a corresponding conductive portion of the second circuit board 30 or 30′.

The second group of conductive elements 10200b, the third group of conductive elements 10200c, and the fourth group of conductive elements 10200d of the electrical connector 10010 are the same as the second group of conductive elements 200b, the third group of conductive elements 200c, and the fourth group of conductive elements 200d of the electrical connector 10, respectively. Thus, for the sake of brevity, those details included above may not be repeated. As will be described in detail below, the electrical connector 10010 differs from the electrical connector 10 in that aspects of the first group of conductive elements 10200a of the electrical connector 10010 is different from that of the first group of conductive elements 200a of the electrical connector 10.

Aspects of the electrical connector 10010 will be described below in connection with the first group of conductive elements 10200a disposed in the first slot 10103a.

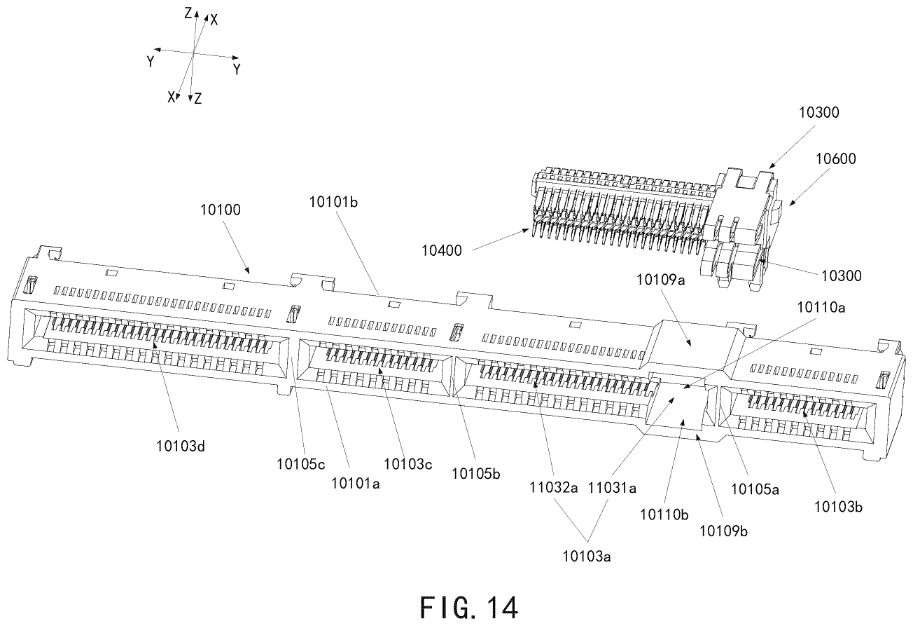

As shown in FIGS. 14 and 17A to 18C, the electrical connector 10010 includes a lead assembly 10600 including the first group of conductive elements 10200a. For example, the first group of conductive elements 10200a is part of the lead assembly 10600. The first group of conductive elements 10200a includes first conductive elements 10300 and a plurality of second conductive elements 10400.

Although first conductive elements 10300 are shown in the figures, it should be appreciated that one first conductive element 10300 may be included, or more than first conductive elements 10300 may be included. For example, pairs (one or more pairs) of first conductive elements 10300 may be included.

Aspects of the plurality of second conductive elements 10400 of the electrical connector 10010 are the same as those of the plurality of second conductive elements 400 of the electrical connector 10. Thus, for the sake of brevity, those details included above may not be repeated. Moreover, the description of aspects of the second conductive elements 10400 hereinafter may be referred to those of aspects of the second conductive elements 400 shown in FIGS. 8A to 8F and described above, and the reference signs representing aspects of the second conductive elements 400 will be used to represent the same configurations of the second conductive elements 10400.

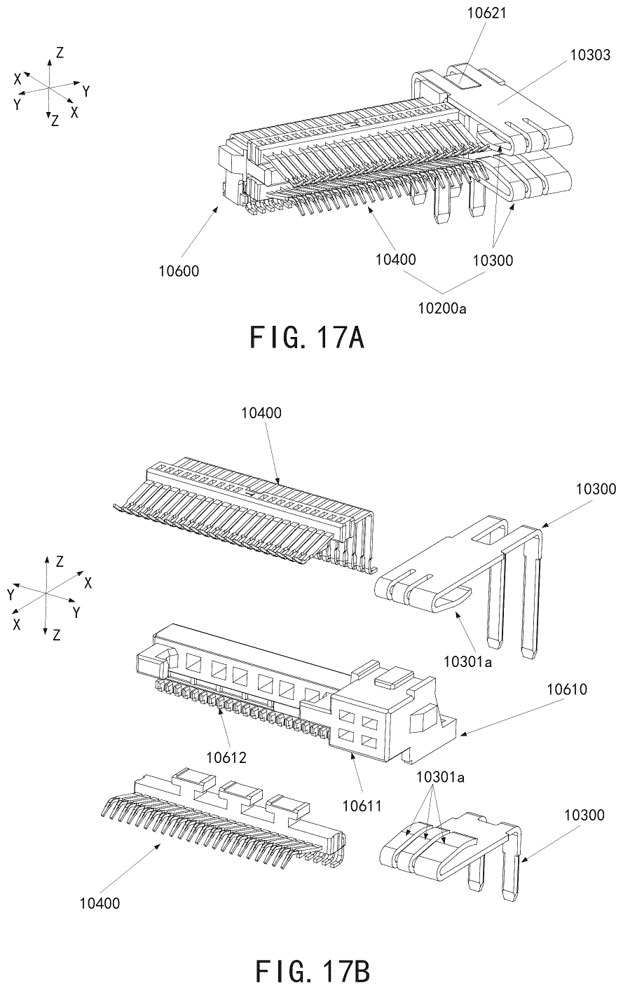

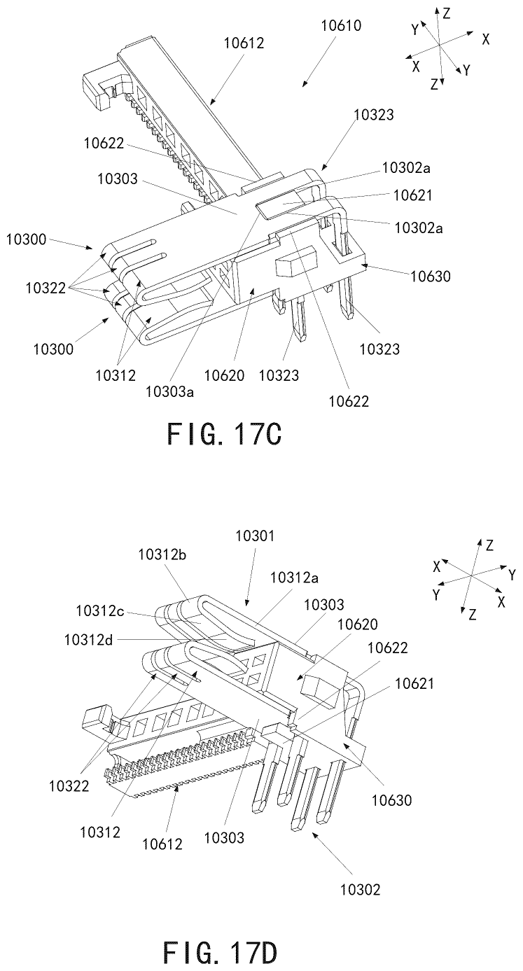

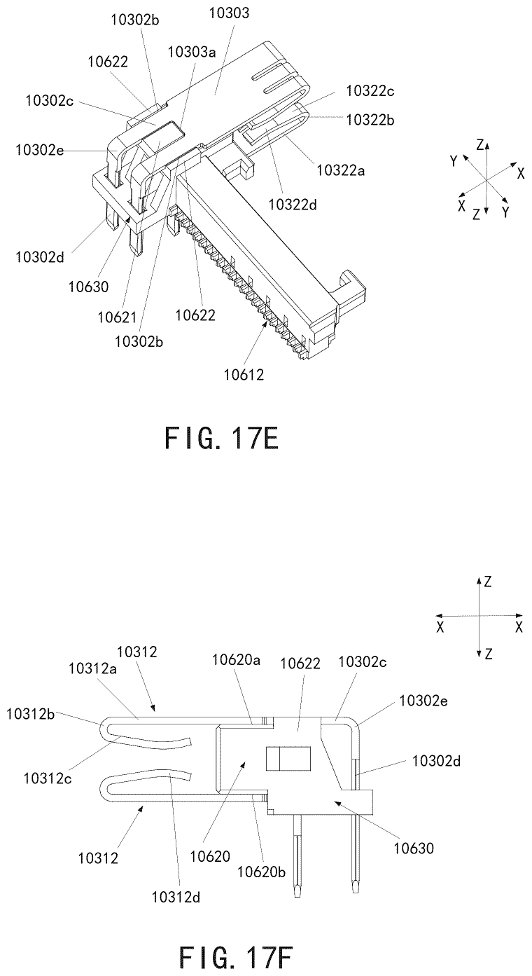

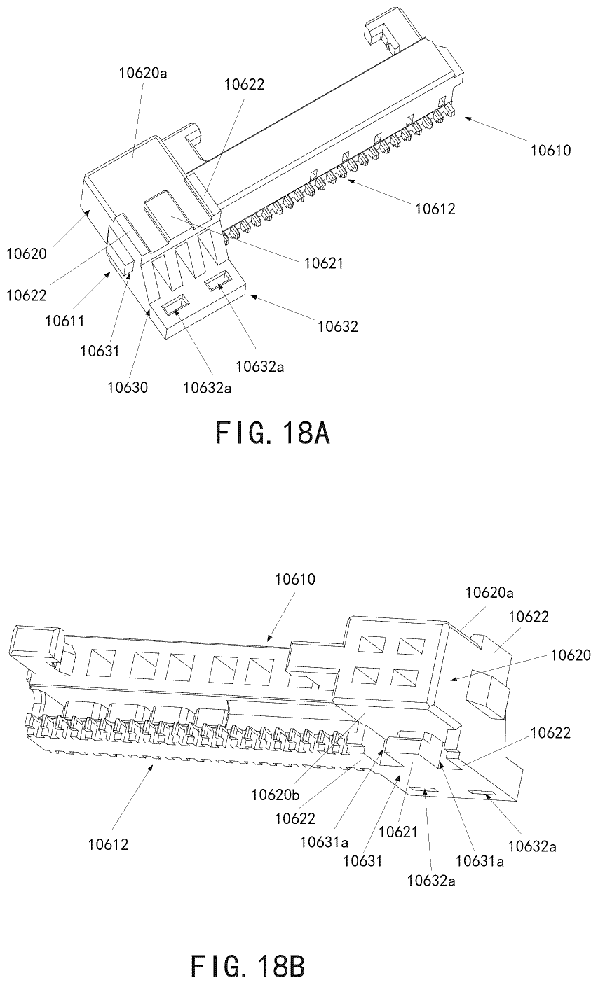

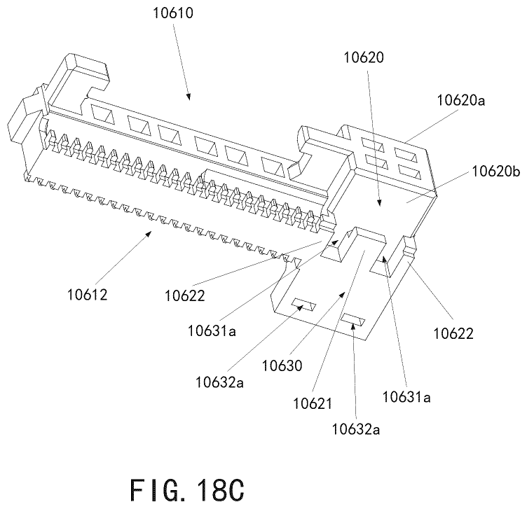

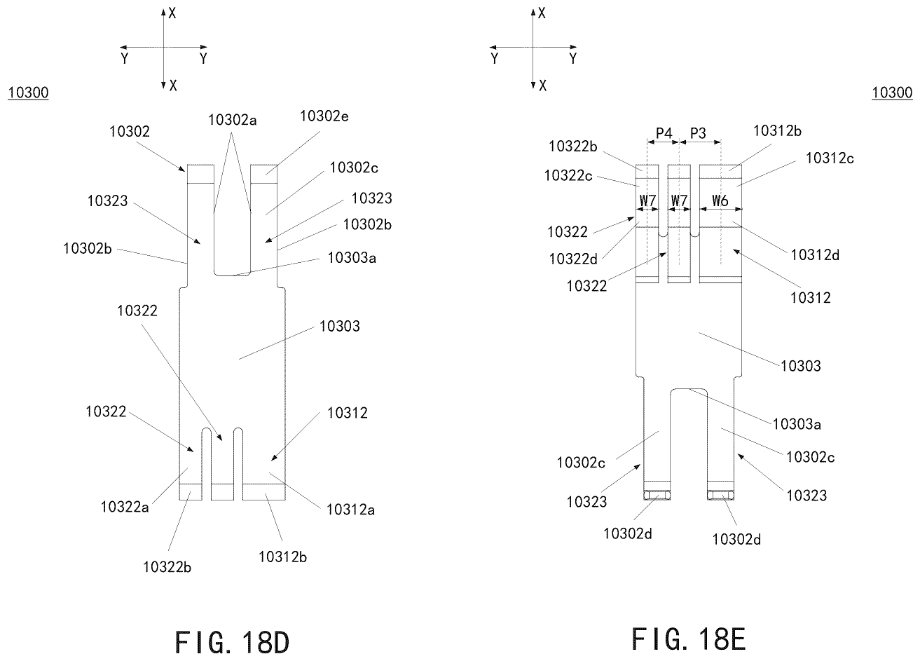

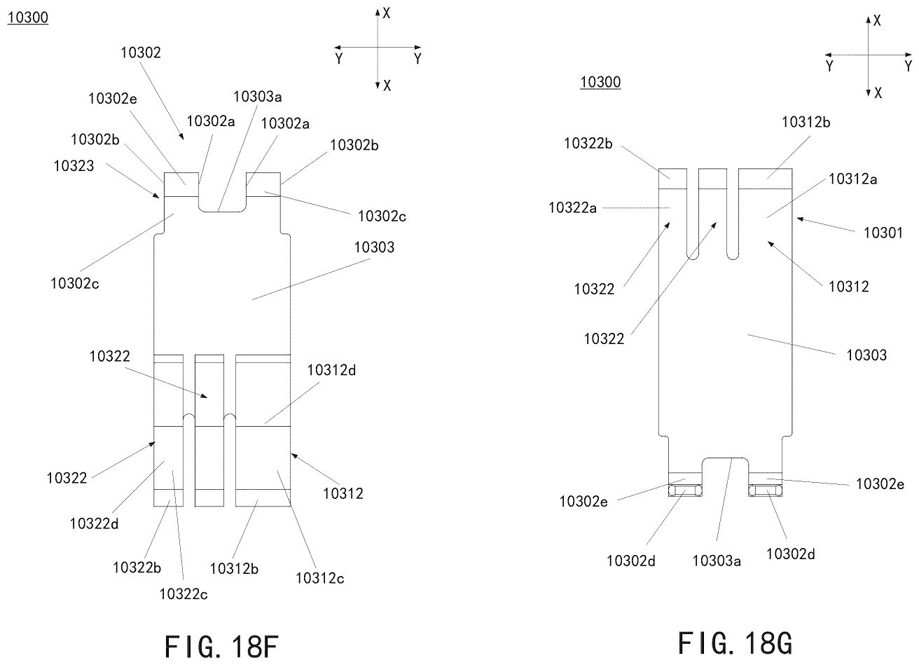

Each first conductive element 10300 may be configured for transmitting power. As shown in FIGS. 17C to 17F and 18D to 18G, each first conductive element 10300 includes a mating end 10301 having a mating contact portion 10301a, a mounting end 10302 opposite to the mating end 10301, and an intermediate portion 10303 connecting the mating end 10301 to the mounting end 10302. As will be described in detail below, the mating end 10301 may be configured to mate with the conductive portion 37a of the second circuit board 30 or 30′ such that the mating contact portion 10301a electrically contacts a corresponding conductive pad or conductive region.

As shown in FIGS. 14, 15A, 17A, and 17B, the first conductive element 10300 may have a larger size in the lateral direction X-X, the longitudinal direction Y-Y, and the vertical direction Z-Z compared to the second conductive element 10400 (see the second conductive element 400 shown in FIGS. 8A to 8F). Furthermore, the first conductive elements 10300 may be spaced apart from each other by a greater distance in the vertical direction Z-Z compared to the second conductive element 10400. In addition, as will be described in detail below, the mating contact portions 10301a of the first conductive elements 10300 may be separated center-to-center from each other by a greater distance in the longitudinal direction Y-Y compared to the mating contact portions (see “403a” in FIGS. 8A to 9C) of the second conductive elements 10400.

It should be appreciated that the present application is not limited thereto. For example, the first conductive element 10300 may have a larger size in one and two of the lateral direction X-X, the longitudinal direction Y-Y, and the vertical direction Z-Z compared to the second conductive element 10400. As another example, there may be a plurality of first conductive elements 10300, and two adjacent first conductive elements 10300 may be spaced apart from each other by a greater distance in the longitudinal direction Y-Y.

As shown in FIGS. 13A to 16D, similar to the insulative housing 100 of the electrical connector 10, the insulative housing 10100 of the electrical connector 10010 includes a first wall 10107a and a second wall 10107b separated by the first slot 10103a in the vertical direction Z-Z. A portion of the first wall 10107a adjacent to the divider 10105a protrudes outwardly away from the first slot 10103a to form a first bulge 10109a, and a portion of the second wall 10107b adjacent to the divider 10105a protrudes outwardly away from the first slot 10103a to form a second bulge 10109b. The first conductive elements 10300 are held in the first bulge 10109a and the second bulge 10109b of the insulative housing 10100, respectively.

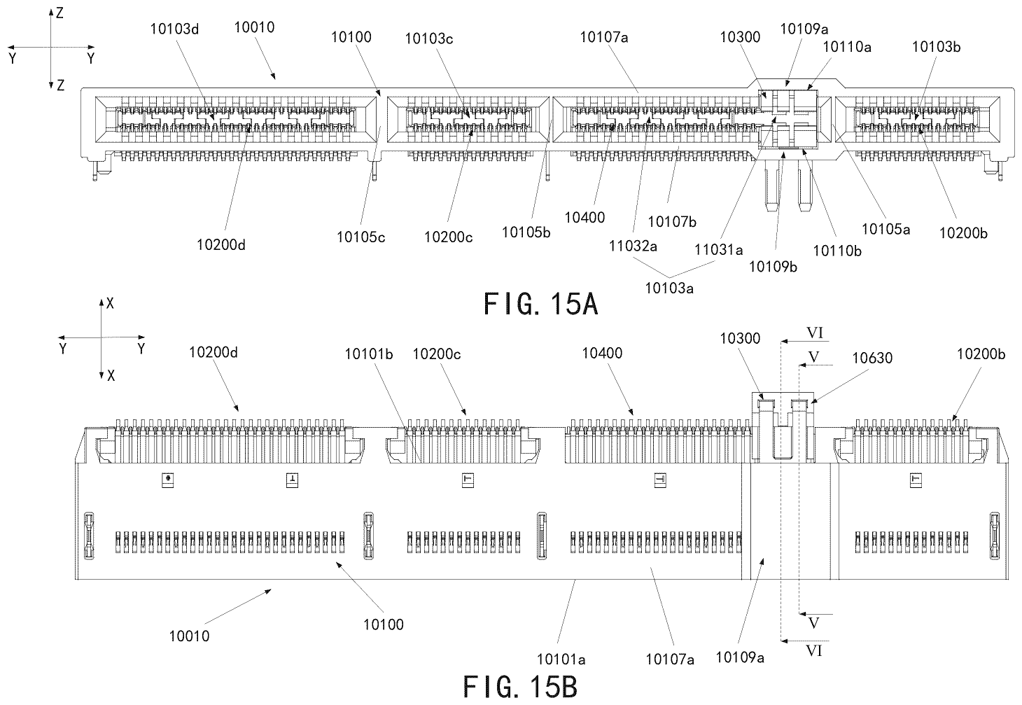

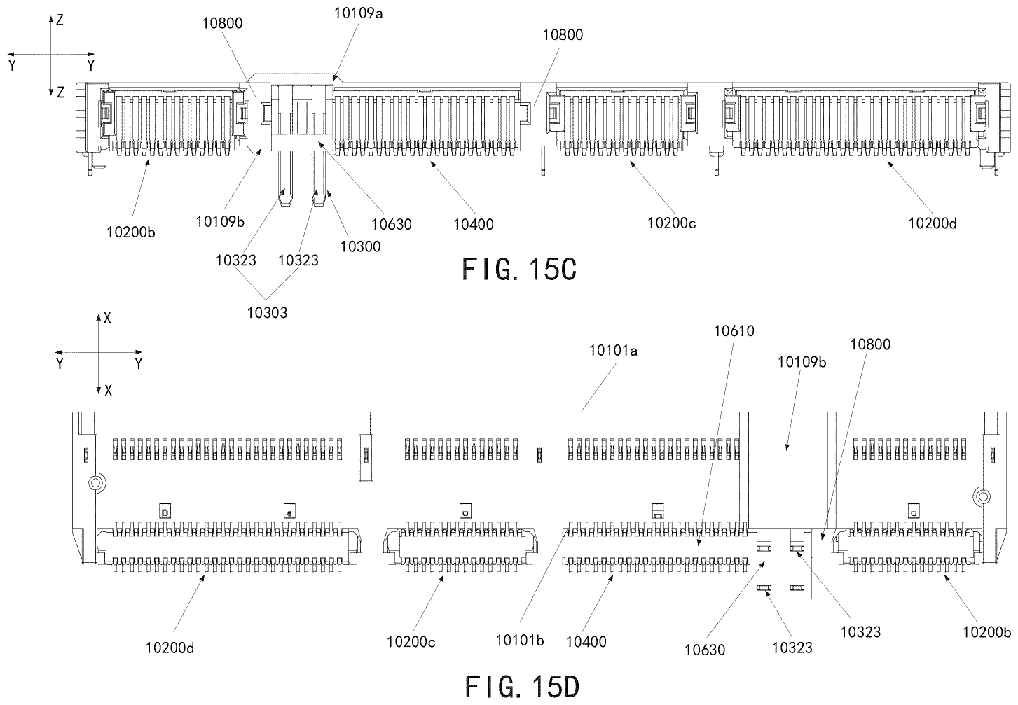

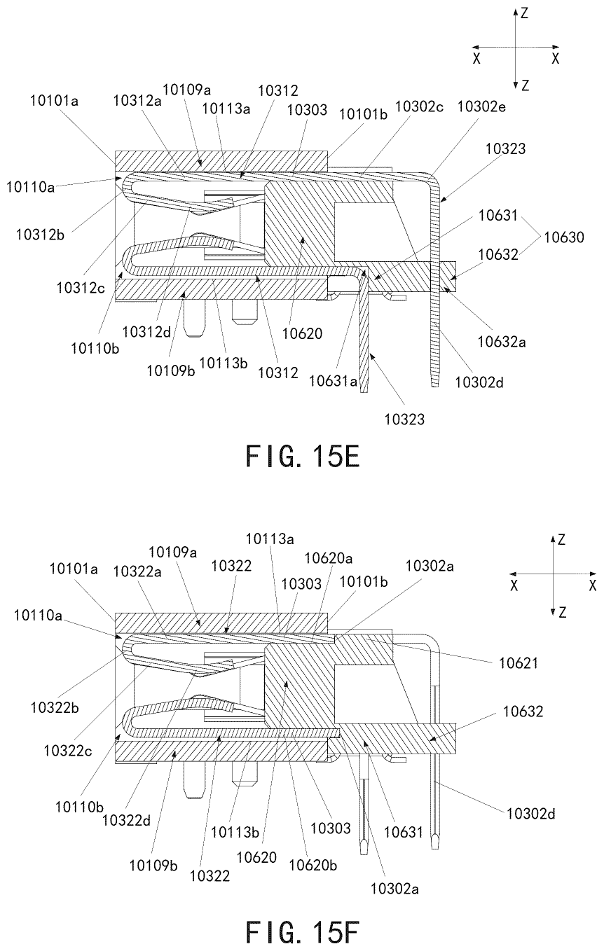

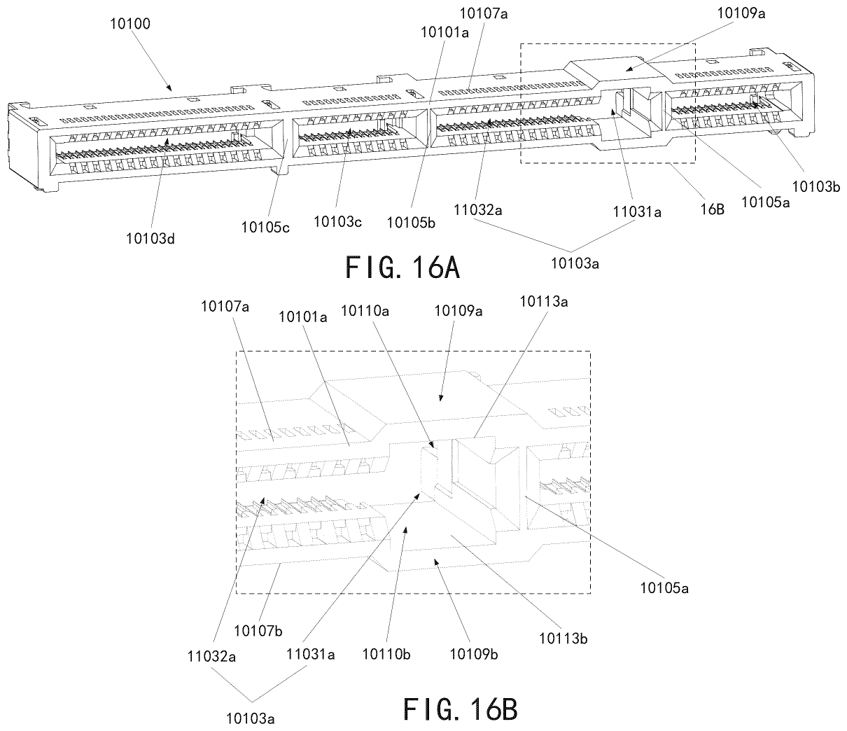

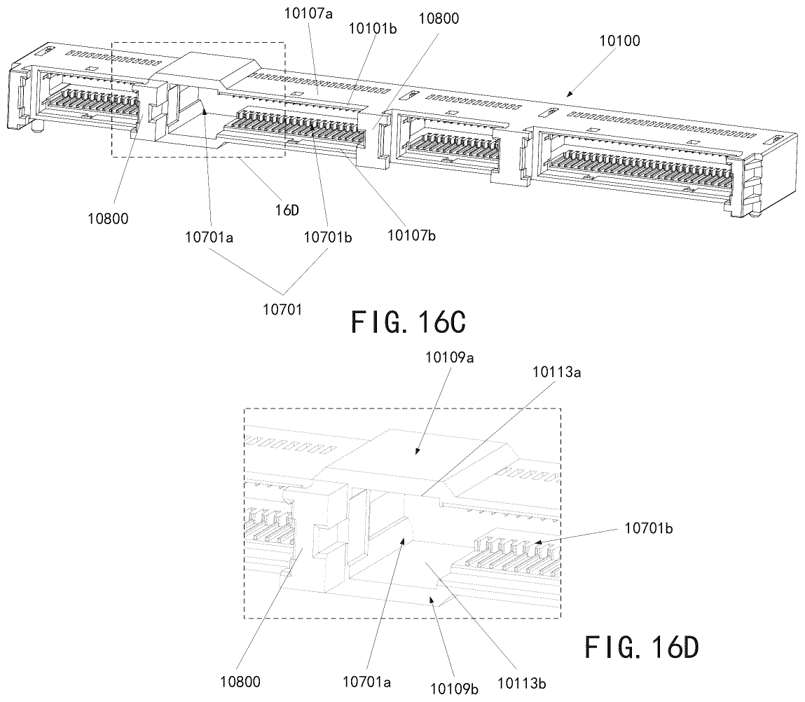

In particular, the first bulge 10109a and the second bulge 10109b of the insulative housing 10100 include a first channel 10110a and a second channel 10110b, respectively. As shown in FIGS. 15A, 15E to 15F, and 16A to 16D, the first channel 10110a and the second channel 10110b extend into the first bulge 10109a and the second bulge 10109b from the first slot 10103a in the vertical direction Z-Z, respectively, for accommodating the first conductive elements 10300. One of the first conductive elements 10300 is disposed in the first channel 10110a and the other is disposed in the second channel 10110b. The first conductive element 10300 disposed in the first channel 10110a may be referred to as “an upper first conductive element”, and the first conductive element 10300 disposed in the second channel 10110b may be referred to as “a lower first conductive element”. It should be appreciated that this indicates a relative positional relationship, and not an absolute positional relationship, between the first conductive elements 10300. FIGS. 18D and 18E are the top and bottom views, respectively, of the upper first conductive element, and FIGS. 18F and 18G are the top and bottom views, respectively, of the lower first conductive element.

Similar to the electrical connector 10, in the electrical connector 10010, with the configuration described above, the first conductive elements 10300 can be disposed adjacent to the divider 10105a of the insulative housing 10100 which separates the first slot 10103a and the second slot 10103b from each other, and can be disposed in the same slot as the plurality of second conductive elements 10400. This enables the first conductive elements 10300 with a larger size and/or a larger pitch to be disposed in the electrical connector 10010 without having to add additional slots or add additional electrical connectors to the electronic system 1. This configuration does not significantly increase the space occupied by the electrical connector 10010 on the first circuit board such as a motherboard. Furthermore, in some embodiments, as will be described below, this configuration enables the high-density electrical connector to provide both high-quality, high-speed signal transmission and high power transmission. Moreover, in some embodiments, as will be described below, the electrical connector 10010 configured according to the present application can be backwardly compatible with the second circuit board 30 designed and manufactured in accordance with a particular specification, such as the second circuit board 30 designed and manufactured in accordance with the current version of SFF-TA-1002.

In some embodiments, the first channel 10110a and the second channel 10110b extend from the first face 10101a through the insulative housing 10100 to the second face 10101b in the lateral direction X-X, respectively. In some embodiments, the first channel 10110a and the second channel 10110b may be aligned with each other, or offset from each other, in the vertical direction Z-Z.

As shown in FIGS. 16A and 16B, the first slot 10103a includes a first portion 11031a corresponding to the first channel 10110a and the second channel 10110b and a second portion 11032a extending from the first portion 11031a away from the divider 10105a in the longitudinal direction Y-Y. The first portion 11031a is connected with the second portion 11032a. The first portion 11031a is connected with the first channel 10110a and the second channel 10110b. As shown in FIGS. 13A, 15A, 15E, and 15F, the mating contact portions 10301a of the mating ends 10301 of the first conductive elements 10300 are exposed in the first portion 11031a for electrical contact with corresponding conductive pads or conductive regions of the conductive portion 37a of the second circuit board 30 or 30′. The plurality of second conductive elements 10400 are disposed in the insulative housing 100 in correspondence with the second portion 11032a such that the mating contact portions of the mating ends of the plurality of second conductive elements 10400 are exposed in the second portion 11032a for electrical contact with corresponding conductive pads 38 of the conductive portion 37a of the second circuit board 30 or 30′.

It should be appreciated that, in some embodiments, pairs of first conductive elements 10300 are held in pairs of first bulges 10109a and second bulges 10109b. For example, the pairs of first conductive elements 10300 may be disposed on opposite sides of the first portion 11031a of the first slot 10103a.

Aspects of the first conductive elements 10300 of the electrical connector 10010 may be different from those of the first conductive elements 300 of the electrical connector 10. In particular, as shown in FIGS. 17C to 17F and 18D to 18G, the mating end 10301 of each first conductive element 10300 includes one first contact finger 10312 (which may also be referred to as “a first beam”) and two second contact fingers 10322 (which may also be referred to as “second beams”). The one first contact finger 10312 and the two second contact fingers 10322 jointly form the mating end 10301 of the first conductive element 10300. The first contact finger 10312 has a mating contact portion 10312d for electrical contact with a corresponding conductive pad or conductive region of the conductive portion 37a of the second circuit board 30 or 30′, and each of the second contact fingers 10322 has a mating contact portion 10322d for electrical contact with a corresponding conductive pad or conductive region of the conductive portion 37a of the second circuit board 30 or 30′. In this case, the mating end 10301 of the first conductive element 10300 may have three mating contact portions, e.g., one mating contact portion 10312d and two mating contact portions 10322d. As will be described in detail below, the one first contact finger 10312 is closer to the divider 10105a of the insulative housing 10100 in the longitudinal direction Y-Y than the two second contact fingers 10322.

As shown in FIG. 18E, the mating contact portion 10312d of the first contact finger 10312 of the upper first conductive element has a width W6 in the longitudinal direction Y-Y, and the mating contact portion 10322d of each of the two second contact fingers 10322 has a width W7 in the longitudinal direction. The width W6 is greater than the width W7. The width W6 may be at least 1.5 times the width W7. For example, the width W6 may be 1.5 times, 1.6 times, 1.8 times, or twice the width W7. When the first conductive element 10300 is used to transmit power, due to such configurations of the first contact finger 10312 and the second contact fingers 10322, the current flowing through the first contact finger 10312 is greater than the current flowing through each of the second contact fingers 10322.

As shown in FIGS. 17C to 17F and 18D to 18E, the first contact finger 10312 and the two second contact fingers 10322 of the upper first conductive element are aligned with and spaced apart from each other in the longitudinal direction Y-Y. As shown in FIG. 18E, the mating contact portion 10312d of the first contact finger 10312 and the mating contact portion 10322d of the adjacent second contact finger 10322 of the upper first conductive element are separated center-to-center from each other by a pitch P3 in the longitudinal direction Y-Y, and the mating contact portions 10322d of the two second contact fingers 10322 are separated center-to-center from each other by a fourth pitch P4 in the longitudinal direction Y-Y. The pitch P3 is greater than the pitch P4.

As shown in FIGS. 17C to 17F and 18D to 18G, the mating ends 10301 of the first conductive elements 10300 (e.g., the upper first conductive element and the lower first conductive element) are symmetrical to each other about an imaginary plane parallel to the lateral direction X-X and the longitudinal direction Y-Y. For example, the mating ends 10301 of the lower first conductive element and the upper first conductive element are symmetrical to each other, and thus for the sake of brevity, those details included above may not be repeated.

As shown in FIGS. 15E and 15F, the intermediate portion 10303 of each of the first conductive elements 10300 is disposed in a corresponding one of the first channel 10110a and the second channel 10110b. As shown in FIGS. 17C to 17F and 18D to 18G, for each first conductive element 10300, the first contact finger 10312 includes a straight portion 10312a, a curved portion 10312b, and a contact portion 10312c. The straight portion 10312a extends from the intermediate portion 10303 towards the first face 10101a in the lateral direction X-X in the corresponding channel, and the curved portion 10312b is connected between the straight portion 10312a and the contact portion 10312c, the contact portion 10312c extends from the curved portion 10312b away from the first face 10101a in the lateral direction X-X and extends into the first slot 10103a, and the mating contact portion 10312d is on the contact portion 10312c. Each of the two second contact fingers 10322 includes a straight portion 10322a, a curved portion 10322b, and a contact portion 10322c. For each of the second contact fingers 10322, the straight portion 10322a extends from the intermediate portion 10303 towards the first face 10101a in the lateral direction X-X in the corresponding channel, the curved portion 10322b is connected between the straight portion 10322a and the contact portion 10322c, the contact portion 10322c extends from the curved portion 10322b away from the first face 10101a in the lateral direction X-X and extends into the first slot 10103a, and the mating contact portion 10322d is on the contact portion 10322c.

As shown in FIGS. 15E, 15F, and 17A to 17F, for each first conductive element 10300, the mating contact portion 10312c of the one first contact finger 10312 and the two mating contact portions 10322c of the two second contact fingers 10322 may be aligned with and spaced apart from each other in the longitudinal direction Y-Y, and the contact surface of the mating contact portion 10312c of the one first contact finger 10312 and the contact surfaces of the two mating contact portions 10322c of the two second contact fingers 10322 are coplanar with each other.

As shown in FIGS. 15E, 15F, and 17A to 17F, for each first conductive element 10300, the straight portion 10312a of the one first contact finger 10312 and the two straight portions 10322a of the two second contact fingers 10322 may be aligned with and spaced apart from each other in the longitudinal direction Y-Y.

In some embodiments, the first contact fingers 10312 of the first conductive elements 10300 may be aligned with each other in the vertical direction Z-Z (as shown in FIGS. 17A, 17C, and 17D), or offset from each other. In some embodiments, the second contact fingers 10322 of the first conductive elements 10300 may be aligned with each other in the vertical direction Z-Z (as shown in FIGS. 17A, 17C, and 17D), or offset from each other.

In some embodiments, as shown in FIGS. 17A to 17F and 18D to 18G, for each first conductive element 10300, the straight portion 10312a, the widths of the curved portion 10312b, and the contact portion 10312c of each first contact finger 10312 in the longitudinal direction Y-Y may be the same as each other. For example, each first contact finger 10312 may have a consistent width in an extending direction thereof.

In some embodiments, as shown in FIGS. 17A to 17F and 18D to 18G, for each first conductive element 10300, the widths of the straight portion 10322a, the curved portion 10322b, and the contact portion 10322c of each second contact finger 10322 in the longitudinal direction Y-Y may be the same as each other. For example, each second contact finger 10322 may have a consistent width in an extending direction thereof.

As shown in FIGS. 17A to 17F and 18D to 18G, each first conductive element 10300 is formed from a single piece of conductive material. For example, each first conductive element 10300 includes a single layer. It should be appreciated that the present application is not limited thereto.

In some other embodiments, the mating end 10301 of each first conductive element 10300 may include at least one first contact finger 10312 and at least two second contact fingers 10322. Each of the at least one first contact finger 10312 and the at least two second contact fingers 10322 has a mating contact portion. The mating contact portion 10312d of each first contact finger 10312 has a width W6 in the longitudinal direction Y-Y, and the mating contact portion 10322d of each second contact finger 10322 has a width W7 in the longitudinal direction Y-Y. The at least one first contact finger 10312 is closer to the divider 10105a of the insulative housing 10100 in the longitudinal direction Y-Y than the at least two second contact fingers 10322. The at least one first contact finger 10312 and the at least two second contact fingers 10322 are aligned with and spaced apart from each other in the longitudinal direction Y-Y. The mating contact portion 10312d of the first contact finger 10312 and the mating contact portion 10322d of the adjacent second contact fingers 10322 of the at least one first contact finger 10312 and the at least two second contact fingers 10322 are separated center-to-center from each other by the pitch P3 in the longitudinal direction Y-Y, and the mating contact portions 10312d of two adjacent second contact fingers 10322 of the at least two second contact fingers 10322 are separated center-to-center from each other by the pitch P4 in the longitudinal direction Y-Y. In addition, in the case where the at least one first contact finger 10312 is at least two first contact fingers 10312, the mating contact portions 10312d of two adjacent first contact fingers 10312 may be separated center-to-center from each other, in the longitudinal direction Y-Y, by a pitch (not shown) that may be greater than or equal to the pitch P3.

As shown in FIGS. 14, 15E to 15F, and 17A to 18C, the lead assembly 10600 of the electrical connector 10010 further includes an insulative assembly housing 10610 configured to retain the first conductive elements 10300 and the plurality of second conductive elements 10400 in the insulative housing 10100. In particular, the first conductive elements 10300 and the plurality of second conductive elements 10400 are held by the assembly housing 10610, and the assembly housing 10610 is mounted to the insulative housing 10100 to retain the first conductive elements 10300 and the plurality of second conductive elements 10400 in the insulative housing 10100. The assembly housing 10610 may be formed from an insulative material. Examples of insulative materials that are suitable for forming the assembly housing 10610 include, but are not limited to, plastic, nylon, liquid crystal polymer (LCP), polyphenylene sulfide (PPS), high temperature nylon or polyphenylene oxide (PPO) or polypropylene (PP).

As shown in FIGS. 16C and 16D, the insulative housing 10100 includes a pair of retention arms 10800 extending from the second face 10101b in the lateral direction X-X. For example, the pair of retention arms 10800 may extend from the second face 10101b in the lateral direction X-X in correspondence with the dividers 10105a and 10105b of the insulative housing 10100. The assembly housing 10610 is held therebetween by the pair of retention arms 10800 so as to be mounted to the insulative housing 10100. The assembly housing 10610 and the retention arms 10800 may have mating snap-fit structures.

As shown in FIGS. 17B to 18C, the assembly housing 10610 includes a first segment 10611 and a second segment 10612 extending from the first segment 10611 in the longitudinal direction Y-Y. The first conductive elements 10300 are held by the first segment 10611 of the assembly housing 10610, and the plurality of second conductive elements 10400 are held by the second segment 10612 of the assembly housing 10610.

As shown in FIGS. 16C and 16D, the insulative housing 10100 may include a mounting slot 10701 recessed into the insulative housing 10100 from the second face 10101b in the lateral direction X-X. The mounting slot 10701 may include a first portion 10701a and a second portion 10701b extending from the first portion 10701a in the longitudinal direction Y-Y. The first portion 10701a of the mounting slot 10701 is connected with the first channel 10110a and the second channel 10110b.

As shown in FIGS. 17C to 18C, the first segment 10611 of the assembly housing 10610 includes a supporting portion 10620. The intermediate portion 10303 of each of the first conductive elements 10300 is disposed on the supporting portion 10620. As shown in FIGS. 15E and 15F, the supporting portion 10620 is inserted in the first portion 10701a of the mounting slot 10701 of the insulative housing 10100 such that the intermediate portion 10303 of each first conductive element 10300 is sandwiched between the supporting portion 10620 and a bottom wall of a corresponding one of the first channel 10110a and the second channel 10110b. In particular, the intermediate portion 10303 of the upper first conductive element is sandwiched between the supporting portion 10620 and a bottom wall 10113a of the first channel 10110a, and the intermediate portion 10303 of the lower first conductive element is sandwiched between the supporting portion 10620 and the bottom wall 10113b of the second channel 10110b. In this way, it is possible to limit at least the movement of the intermediate portion 10303 of each first conductive element 10300 relative to the insulative housing 10100 in the vertical direction Z-Z. This can limit the movement of the first conductive elements 10300 relative to the insulative housing 10100 in the vertical direction Z-Z, thereby reliably retaining the first conductive elements 10300 in the insulative housing 10100. In some embodiments, this can limit movement of the intermediate portion 10303 of each first conductive element 10300 relative to the insulative housing 10100 in the vertical direction Z-Z, the horizontal direction X-X, and the longitudinal direction Y-Y, thereby reliably retaining the first conductive element 10300 in the insulative housing 10100.

In some embodiments, it is possible to limit at least the movement of the intermediate portion 10303 of each first conductive element 10300 relative to the insulative housing 10100 in the longitudinal direction Y-Y by engaging the intermediate portion 10303 of each first conductive element 10300 with sidewalls of the corresponding channel. In one of these embodiments, the movement of the intermediate portion 10303 relative to the insulative housing 10100 in both the longitudinal direction Y-Y and the lateral direction X-X may be limited by engaging the intermediate portion 10303 of each first conductive element 10300 with side walls of the corresponding channel. For example, side edges of the intermediate portion 10303 of each first conductive element 10300 may have a barb feature for engaging with side walls of the corresponding channel.

As shown in FIGS. 17B to 17F and 18D to 18G, the mounting end 10302 of each first conductive element 10300 includes two mounting legs 10323 each extending from the intermediate portion 10303 opposite to the mating end 10301. The two mounting legs 10323 are aligned with and spaced apart from each other in the longitudinal direction Y-Y. For example, the two mounting legs 10323 are arranged in a row in the longitudinal direction Y-Y. The intermediate portion 10303 includes an edge portion 10303a extending between the two mounting legs 10323.

In some embodiments, as shown in FIGS. 18A to 18C, the supporting portion 10620 may include two first protrusions 10621. As shown in FIGS. 15F and 17C to 17E, each first protrusion 10621 extends into a space between the two mounting legs 10323 of the mounting end 10302 of a corresponding one of the first conductive elements 10300 and engages the edge portion 10303a of the intermediate portion 10303 between the mounting legs 10323 to limit movement of the intermediate portion 10303 relative to the insulative housing 10100 towards the second face 10101b in the lateral direction X-X, thereby limiting the movement of the first conductive element 10300 relative to the insulative housing 10100 towards the second face 10101b in the lateral direction X-X. This can improve the reliability of retaining the first conductive elements 10300 in the insulative housing 10100.

In some embodiments, as shown in FIGS. 17C to 17E, for each first conductive element 10300, the two mounting legs 10323 include two side edges 10302a opposing to each other in the longitudinal direction Y-Y, and the first protrusion 10621 engages the two side edges 10302a of the two mounting legs 10323. For example, the first protrusion 10621 is sandwiched between and engages the two side edges 10302a of the two mounting legs 10323. In this way, it is possible to limit the movement of the two mounting legs 10323 relative to the insulative housing 10100 in the longitudinal direction Y-Y, thereby limiting the movement of the first conductive element 10300 relative to the insulative housing 10100 in the longitudinal direction Y-Y. This can improve the reliability of retaining the first conductive elements 10300 in the insulative housing 10100.

As described above, for each first conductive element 10300, two mounting legs 10323 are arranged in a row in the longitudinal direction Y-Y. The row has two ends opposite to each other in the longitudinal direction Y-Y. In some embodiments, as shown in FIGS. 18A to 18C, for each first conductive element 10300, the supporting portion 10620 may also include two second protrusions 10622. As shown in FIG. 17E, each second protrusion 10622 engages, at a corresponding end of the two ends of the row, with the side edge 10302b of a corresponding mounting leg 10323 at the corresponding end to sandwich the row between the two second protrusions 10622. In this way, it is possible to limit the movement of the row relative to the insulative housing 10100 in the longitudinal direction Y-Y, thereby limiting the movement of the first conductive elements 10300 relative to the insulative housing 10100 in the longitudinal direction Y-Y. This can improve the reliability of retaining the first conductive elements 10300 in the insulative housing 10100.

In some embodiments, for each first conductive element 10300, each mounting leg 10323 is disposed between the first protrusion 10621 and a corresponding second protrusion 10622 and is clamped by these two protrusions so as to at least limit the movement of the mounting leg 10323 relative to the insulative housing 10100 in the longitudinal direction Y-Y. In this way, it is possible to limit the movement of the two mounting legs 10323 relative to the insulative housing 10100 in the longitudinal direction Y-Y, thereby limiting the movement of the first conductive element 10300 relative to the insulative housing 10100 in the longitudinal direction Y-Y. This can increase the reliability of retaining the first conductive element 10300 in the insulative housing 10100. In one of these embodiments, each mounting leg 10323 can be clamped by the first protrusion 10621 and the corresponding second protrusion 10622 to limit the movement of the mounting leg 10323 relative to the insulative housing 10100 in the lateral direction X-X.

As shown in FIGS. 17C to 17E, for each first conductive element 10300, each of the two mounting legs 10323 includes a first straight portion 10302c, a second straight portion 10302d, and a curved portion 10302e. The first straight portion 10302c extends beyond the second face 10101b of the insulative housing 10100 from the intermediate portion 10303 in the lateral direction X-X. The curved portion 10302e connects the first straight portion 10302c to the second straight portion 10302d and is curved such that the second straight portion 10302d is oriented in the vertical direction Z-Z.

As shown in FIGS. 18A to 18C, the assembly housing 10610 may also include a retaining portion 10630 extending from the supporting portion 10620 in the lateral direction X-X. As shown in FIGS. 15E and 17C to 17E, the retaining portion 10630 surrounds and retains a portion of the second straight portion 10302d of each of the two mounting legs 10323 of each of the first conductive elements 10300 to limit the movement of the mounting leg 10323 towards the first face 10101a relative to the insulative housing 10100 in the lateral direction X-X. In this way, it is possible to limit the movement of the first conductive elements 10300 towards the first face 10101a relative to the insulative housing 10100 in the lateral direction X-X. This can improve the reliability of retaining the first conductive elements 10300 in the insulative housing 10100.

As shown in FIGS. 18A to 18C, the supporting portion 10620 includes a first supporting surface 10620a and a second supporting surface 10620b opposite to each other in the vertical direction Z-Z. As shown in FIGS. 15E and 15F, when the supporting portion 10620 is inserted in the first portion 10701a of the mounting slot 10701 of the insulative housing 10100, the first supporting surface 10620a and the second supporting surface 10620b face the first channel 10110a and the second channel 10110b, respectively. The intermediate portion 10303 of the upper first conductive element is sandwiched between the first supporting surface 10620a and the bottom wall 10113a of the first channel 10110a, and the intermediate portion 10303 of the lower first conductive element is sandwiched between the second supporting surface 10620b and the bottom wall 10113b of the second channel 10110b.

As shown in FIGS. 17B to 17F, the curved portions 10302e of the two mounting legs 10323 of the lower first conductive element and the curved portions 10302e of the two mounting legs 10323 of the upper first conductive element are curved in the same direction. As shown in FIGS. 15E and 15F, the second straight portions 10302d of the mounting legs 10323 of the lower first conductive element 10300 are closer to the second face 10101b of the insulative housing 10100 in the lateral direction X-X than the second straight portions 10302d of the mounting legs 10323 of the upper first conductive element 10300.

In some embodiments, as shown in FIGS. 18A and 18C, the retaining portion 10630 may include a proximal portion 10631 adjacent to the second face 10101b and a distal portion 10632 away from the second face 10101b. As shown in FIGS. 18A and 18C, the distal portion 10632 is formed with two receiving holes 10632a extending in the vertical direction Z-Z. As shown in FIGS. 18B and 18C, the proximal portion 10631 is formed with two receiving slots 10631a.

As shown in FIGS. 17C to 17E, the second straight portion 10302d of each of the two mounting legs 10323 of the upper first conductive element extends through a corresponding one of the two receiving holes 10632a of the distal portion 10632 so as to be surrounded and held by the distal portion 10632. This configuration can protect the mounting legs 10323 of the upper first conductive element from accidental bending or breaking.

As shown in FIGS. 17C to 17E, the curved portion 10302e and a portion of the second straight portion 10302d adjacent to the curved portion 10302e of the lower first conductive element are disposed in a corresponding one of the two receiving slots 10631a of the proximal portion 10631 so as to be surrounded and held by the proximal portion 10631. This configuration can protect the mounting legs 10323 of the lower first conductive element from accidental bending or breaking.

It should be appreciated that the mounting end 10302 of each first conductive element 10300 may include more than two mounting legs 10323. Therefore, according to the present application, for each first conductive element 10300, the mounting end 10302 may include at least two mounting legs 10323 each extending from the intermediate portion 10303 opposite to the mating end 10301. The at least two mounting legs 10323 are aligned with and spaced apart from each other in the longitudinal direction Y-Y, and the intermediate portion 10303 includes an edge portion extending between two adjacent ones of the at least two mounting legs 10323. Accordingly, for each first conductive element 10300, the supporting portion 10620 of the assembly housing 10610 may include at least one first protrusion 10621. Each first protrusion 10621 extends into a space between two corresponding adjacent mounting legs of the at least two mounting legs 10323 of the first conductive element 10300 and engages the edge portion of the intermediate portion 10303 between the two corresponding adjacent mounting legs 10323 so as to limit the movement of the intermediate portion 10303 towards the second face 10101b relative to the insulative housing 10100 in the lateral direction X-X. Accordingly, for each first conductive element 10300, each of the at least two mounting legs 10323 is disposed between two corresponding adjacent protrusions of the at least one first protrusion 10621 and the two second protrusions 10622 and is clamped by the two corresponding adjacent protrusions to limit the movement of the mounting legs 10323 relative to the insulative housing 10100 in the longitudinal direction Y-Y. Accordingly, the distal portion 10632 of the retaining portion 10630 may be formed with at least two receiving holes 10632a, and the proximal portion 10631 may be formed with at least two receiving slots 10631a.

It should also be appreciated that the intermediate portion 10303 of the first conductive element 10300 may be retained to the insulative housing 10100 in any other suitable manner. For example, the insulative housing 10100 may be formed with arms similar to the first arm 111 and the second arm 112 of the insulative housing 100 to retain the intermediate portions 10303 of the first conductive elements 10300 in position. In this case, the intermediate portion 10303 of the first conductive element 10300 may have a configuration similar to that of the intermediate portion 10303 of the first conductive element 300.

The plurality of second conductive elements 10400 are held by the second segment 10612 of the assembly housing 10610. A portion of the second segment 10612 of the assembly housing 10610 may be inserted into the second portion 10701b of the mounting slot 10701. The plurality of second conductive elements 10400 may be cooperated with the second segment 10612 of the assembly housing 10610 in a manner similar to the manner shown in FIGS. 5A, 8A to 9C in which the plurality of second conductive elements 400 are cooperated with the assembly housing 400R. Thus, for the sake of brevity, those details included above may not be repeated.

Similar to the plurality of second conductive elements 400, at least a portion of the plurality of second conductive elements 10400 may be configured for transmitting signal. For example, a first portion (see “4001” in FIG. 8F) of the plurality of second conductive elements 10400 may be configured to transmit differential signals, and a second portion (see “4002” in FIG. 8F) thereof may be configured to transmit power and/or signal.

Similar to the electrical connector 10, in the electrical connector 10010, as shown in FIGS. 13A and 15A and as described above, the mating contact portions 10301a of the first conductive elements 10300 are arranged in two first rows in the longitudinal direction Y-Y and are exposed in the first portion 11031a of the first slot 10103a, and the mating contact portions (see “401a” in FIGS. 8A to 8F) of the plurality of second conductive elements 10400 are arranged in two second rows in the longitudinal direction Y-Y and are exposed in the second portion 11032a of the first slot 10103a. Each of the two first rows and a corresponding one of the two second rows are aligned with and spaced apart from each other in the longitudinal direction Y-Y. A pitch (“P3” or “P4” in FIG. 18E) by which two adjacent mating contact portions (e.g., two adjacent ones of the mating contact portion 10312d of the first contact finger 10312 and the mating contact portions 10322d of the second contact fingers 10322) of each first row are separated center-to-center from each other in the longitudinal direction Y-Y is greater than a pitch (see “P2” in FIG. 9C) by which two adjacent mating contact portions of each second row are separated center-to-center from each other in the longitudinal direction Y-Y. For example, the pitch P3 is greater than the pitch P2, and the pitch P4 is greater than the pitch P2. In addition, as described above, the pitch P3 is greater than the pitch P4. As described above, the mating contact portion 10312d of the first contact finger 10312 of the first conductive element 10300 has the width W6 in the longitudinal direction Y-Y, and the mating contact portion 10322d of the second contact finger 10322 has the width W7 in the longitudinal direction Y-Y. The mating contact portion (see “401a” in FIGS. 8A to 8F) of each of the plurality of second conductive elements 10400 has the width W3 (see FIG. 9A) in the longitudinal direction Y-Y. The width W6 is greater than the width W3, and the width W7 is greater than the width W3. In addition, as described above, the width W6 is greater than the width W7.

One or more of the above configurations of the first conductive elements 10300 enables the first conductive elements 10300 to generate less heat for a given current compared to power terminals such as the power terminal 400P (FIG. 8D). For example, one or more of the above configurations of the first conductive elements 10300 enable the first conductive elements 10300 to transmit more power at a maximum temperature rise that can be tolerated. For example, the first conductive elements are capable of transmitting a power of up to 200 W with a maximum temperature rise of 30° C. above ambient temperature.

The inventors have recognized and appreciated that by disposing the first conductive elements 10300 and the plurality of second conductive elements 10400 in the first slot 10103a and configuring each of the plurality of first conductive elements 10300 for transmitting power and at least a portion of the plurality of second conductive elements 10400 for transmitting signals, it is possible to provide high-quality, high-speed signal transmission and high power transmission without significantly increasing the space occupied by the electrical connector 10010 on the circuit board. In addition, this also enables the electrical connector 10010 to be backward compatible with existing specifications, such as SFF-TA-1002, while providing high-quality, high-speed signal transmission and high power transmission.

Since for each first conductive element 10300, one first contact finger 10312 is closer to the divider 10105a of the insulative housing 10100 in the longitudinal direction Y-Y than the two second contact fingers 10322, the two second contact fingers 10322 are therefore closer to the plurality of second conductive elements 10400 in the longitudinal direction Y-Y than the one mating contact portion 10312d. With such a configuration, interference to differential signals transmitted by the first portion of the plurality of second conductive elements 10400 can be reduced.

In some embodiments, the second portion of the plurality of second conductive elements 10400 may be disposed between the first portion and the first conductive elements 10300 in the longitudinal direction Y-Y. With such a configuration, interference to differential signals transmitted by the first portion of the plurality of second conductive elements 10400 can be reduced. In one of these embodiments, the second portion of the plurality of second conductive elements 10400 is disposed in a region of each of the two second rows immediately adjacent to the corresponding first row. In addition, the power terminal(s) in the second portion of the plurality of second conductive elements 10400 may be disposed between the signal terminal(s) in the second portion and the first conductive elements 10300 in the longitudinal direction Y-Y.

In some embodiments, the pitch P4 is greater than 1.5 times the pitch P2. Accordingly, since the pitch P3 is greater than the pitch P4, the pitch P3 is also greater than 1.5 times the pitch P2. For example, the pitch P4 is N times the pitch P2, wherein N is an integer greater than one. In some embodiments, W7 may be greater than N−1 times the pitch P2.

Similar to the electrical connector 10, each mating contact portion of the first conductive element 10300 of the electrical connector 10010 (the mating contact portion 10312d of the first contact finger 10312 and the mating contact portions 10322d of the second contact fingers 10322) can be in contact with at least two power pads 38P of the second circuit board 30. With such a configuration, the electrical connector 10010 is capable of being backwardly compatible with the second circuit board 30 designed and manufactured according to a particular specification, such as the second circuit board 30 designed and manufactured in accordance with the current version of SFF-TA-1002, while providing high-quality, high-speed signal transmission and high power transmission.

Furthermore, similar to the electrical connector 10, the first conductive elements 10300 of the electrical connector 10010 may electrically contact with the first conductive region 39a and the second conductive region 39b of the second circuit board 30′, respectively. With such a configuration, a high power transmission of, for example, 200 W, can be provided.

### Third Exemplary Embodiment

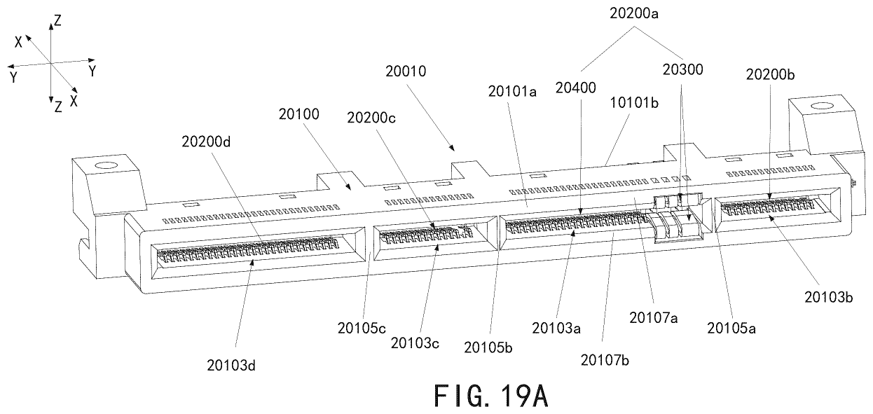

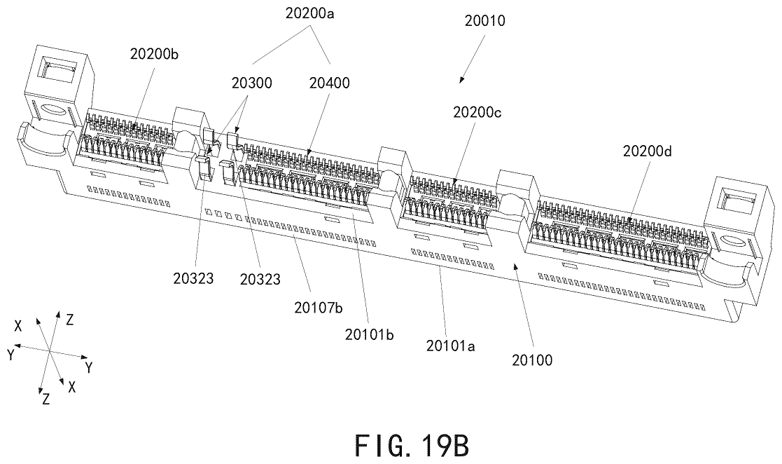

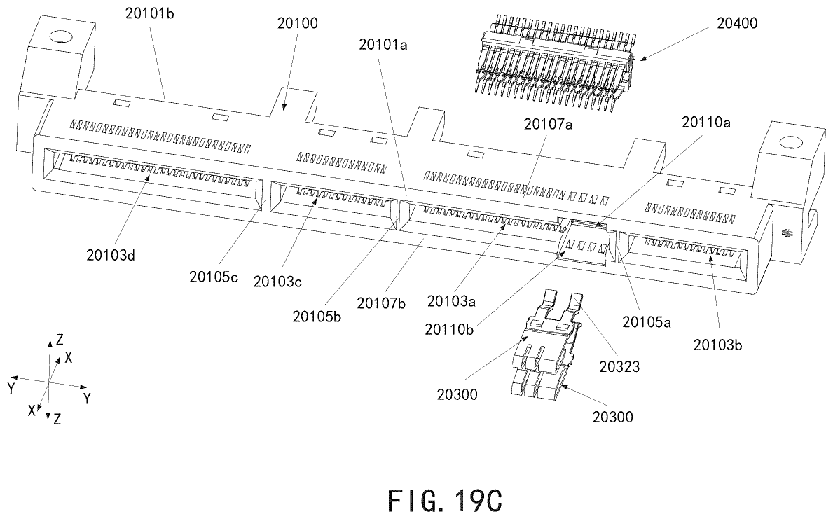

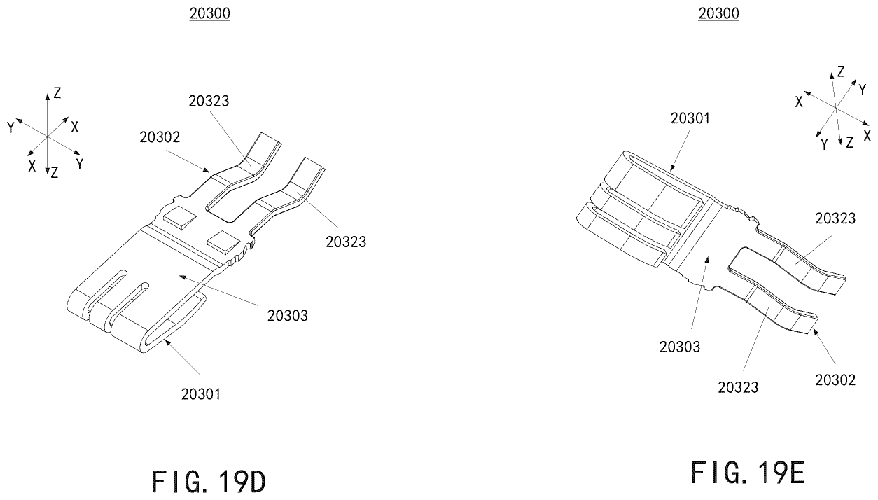

FIGS. 19A to 19E illustrate an electrical connector 20010 according to a third embodiment of the present application. Similar to FIGS. 4A to 18G, a lateral direction X-X, a longitudinal direction Y-Y, and a vertical direction Z-Z are defined in FIGS. 19A to 19E. The lateral direction X-X, the longitudinal direction Y-Y, and the vertical direction Z-Z are perpendicular to each other. The lateral direction X-X may refer to the width direction of the electrical connector 20010. The longitudinal direction Y-Y may refer to the length direction of the electrical connector 20010. The vertical direction Z-Z may refer to the height direction of the electrical connector 20010.

Similar to the electrical connector 10 shown in FIGS. 4A to 12B and the electrical connector 10010 shown in FIGS. 13A to 18G, the electrical connector 20010 may be used in the electronic system 1 to mate with the electrical component 3 (e.g., the second circuit board 30 shown in FIGS. 2A and 2B and the second circuit board 30′ shown in FIGS. 3A and 3B). Thus, for the sake of brevity, those details included above may not be repeated.

As shown in FIGS. 4A to 18G and 19A to 19E, aspects of the electrical connector 20010 may be similar to those of the electrical connector 10 and the electrical connector 10010. Thus, for parts or portions of the electrical connector 20010 that are identical or similar to those of the electrical connectors 10 and 10010, the identical or similar parts or portions of the electrical connector 20010 may be labeled in FIGS. 19A to 19E with the reference signs that label the parts or portions of the electrical connector 10 in FIGS. 4A to 12B plus “20000 (twenty thousand)” so as to label the identical or similar parts or portions of the electrical connector 20010. For the sake of brevity, the details of these identical or similar parts or portions may not be repeated.

As shown in FIGS. 19A to 19E, the electrical connector 20010 may be a card edge connector, specifically a straddle mount (SM) type connector. The electrical connector 20010 enables the aforementioned second circuit board 30 or 30′ and another circuit board to be arranged to be parallel to each other.

Similar to the electrical connectors 10 and 10010, the electrical connector 20010 includes an insulative housing 20100 and a plurality of conductive elements disposed in the insulative housing 20100.

As shown in FIGS. 19A to 19C, similar to the electrical connectors 10 and 10010, the insulative housing 20100 of the electrical connector 20010 includes a first face 20101a and a second face 20101b opposite to each other in the lateral direction X-X, and a first slot 20103a, a second slot 20103b, a third slot 20103c and a fourth slot 20103d recessed into the insulative housing 20100 from the first face 20101a in the lateral direction X-X, respectively. The insert portions 36a, 36b, 36c, and 36d of the second circuit board 30 or 30′ may be inserted into the first slot 20103a, the second slot 20103b, the third slot 20103c, and the fourth slot 20103d, respectively. The second slot 20103b and the first slot 20103a are separated by the divider 20105a in the longitudinal direction Y-Y, the first slot 20103a and the third slot 20103c are separated by the divider 20105b in the longitudinal direction Y-Y, and the third slot 20103c and the fourth slot 20103d are separated by the divider 20105c in the longitudinal direction Y-Y.

Similar to the plurality of conductive elements of the electrical connector 10010, the plurality of conductive elements of the electrical connector 20010 includes a first group of conductive elements 20200a disposed in the first slot 20103a, a second group of conductive elements 20200b disposed in the second slot 20103b, a third group of conductive elements 20200c disposed in the third slot 20103c, and a fourth group of conductive elements 20200d disposed in the fourth slot 20103d. The first group of conductive elements 20200a, the second group of conductive elements 20200b, the third group of conductive elements 20200c, and the fourth group of conductive elements 20200d of the electrical connector 20010 may be similar to the first group of conductive elements 10200a, the second group of conductive elements 10200b, the third group of conductive elements 10200c, and the fourth group of conductive elements 10200d of the electrical connector 10010, respectively. Thus, for the sake of brevity, those details included above may not be repeated.

Each of the plurality of conductive elements of the electrical connector 20010 includes a mating end having a mating contact portion, a mounting end opposite to the mating end, and an intermediate portion connecting the mating end to the mounting end. The mating end may be configured to mate with a corresponding conductive portion of the electrical component 3 such as the aforementioned second circuit board 30 and 30′. Each conductive element is held in the insulative housing 20100 with the mating contact portion of the mating end exposed in a corresponding slot for electrical contact with a corresponding conductive portion of the second circuit board 30 or 30′. Unlike the plurality of conductive elements of the electrical connector 10010, the mating end of each of the plurality of conductive elements of the electrical connector 20010 is configured for a straddle mount application so as to mate with a corresponding conductive portion of another circuit board.

Taking the first group of conductive elements 20200a as an example, as shown in FIGS. 19C to 19E, the first group of conductive elements 20200a of the electrical connector 20010 includes first conductive elements 20300 and a plurality of second conductive elements 20400. Aspects of the mating end 20301 and the intermediate portion 20303 of the first conductive element 20300 of the electrical connector 20010 may be similar to those of the mating end 10301 and the intermediate portion 10303 of the first conductive element 10300 of the electrical connector 10010, respectively. Thus, for the sake of brevity, those details included above may not be repeated.

The first conductive element 20300 differs from the first conductive element 10300 in that the mounting legs 20323 of the mounting end 20302 of the first conductive element 20300 are configured for a straddle mount application. In particular, the mounting legs 20323 of one of the first conductive elements 20300 extend from the insulative housing 20100 and are configured to align with an upper surface of another circuit board, and the mounting legs 20323 of the other of the first conductive elements 20300 extend from the insulative housing 20100 and are configured to align with a lower surface of the another circuit board.

Furthermore, the first conductive element 20300 further differs from the first conductive element 10300 in that the first conductive element 20300 is configured to be directly inserted into the insulative housing 20100, rather than to be held together with the plurality of second conductive elements 20400 in the insulative housing 20100 by a assembly housing. For example, the intermediate portion 20303 of the first conductive element 20300 may be configured to engage an inner wall of a corresponding channel of the insulative housing 20100 such that the first conductive element 20300 is held in the insulative housing 20100.

Aspects of the plurality of second conductive elements 20400 of the electrical connector 20010 may be similar to those of the plurality of second conductive elements 10400 of the electrical connector 10010, except for the different structures of the mounting ends. Thus, for the sake of brevity, those details included above may not be repeated.

The insulative housing 20100 of the electrical connector 20010 may be similar to the insulative housing 10100 of the electrical connector 10010. Thus, for the sake of brevity, those details included above may not be repeated. The insulative housing 20100 differs from the insulative housing 10100 in that (1) the insulative housing 20100 is configured for a straddle mount application; and (2) portions of the first wall 20107a and the second wall 20107b of the insulative housing 20100 adjacent to the divider 20105a do not protrude outwardly away from the first slot 20103a (e.g., the insulative housing 20100 does not have an outwardly protruding portion), rather, the insulative housing 20100 includes the first channel 20110a and the second channel 20110b adjacent to the divider 20105a and extending into the first wall 20107a and the second wall 20107b in the vertical direction from the first slot 20103a, respectively. The first channel 20110a and the second channel 20110b serve the same purpose as the first channel 10110a and the second channel 10110b, and thus may not be repeated herein. It should be appreciated that in some other embodiments, the insulative housing 20100 may include portions similar to the first bulge 10109a and the second bulge 10109b. It should also be appreciated that in some other embodiments, similar to the insulative housing 20100, the insulative housing 10100 may be devoid of the first bulge 10109a and the second bulge 10109b.

### Fourth Exemplary Embodiment

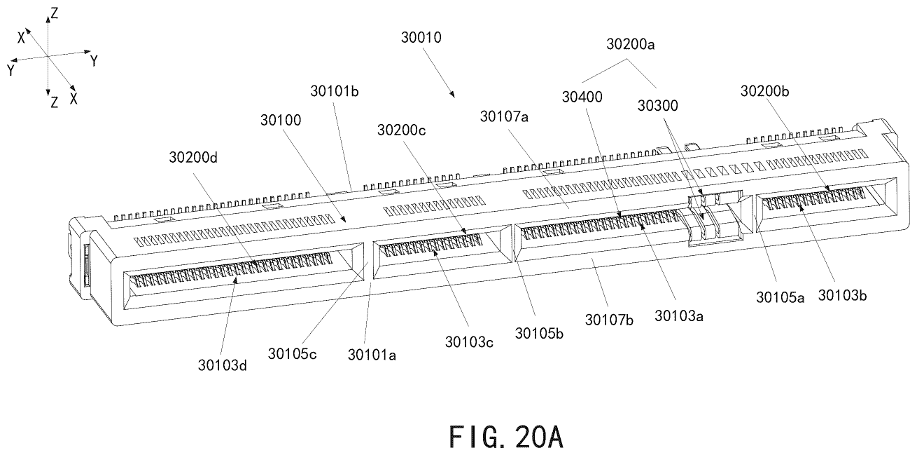

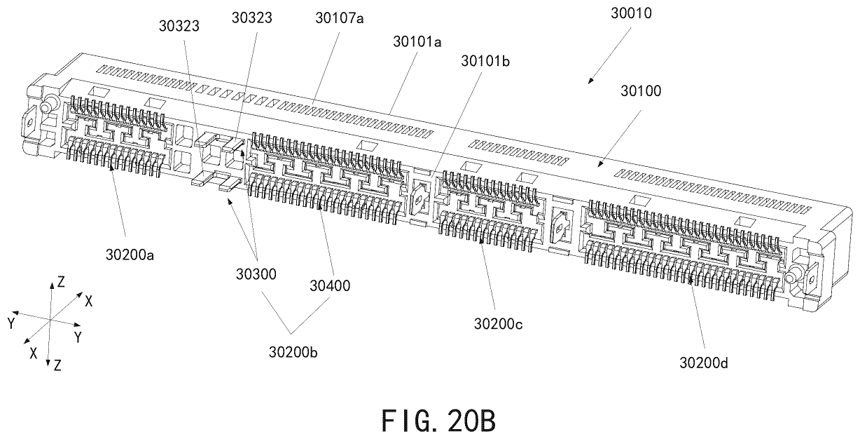

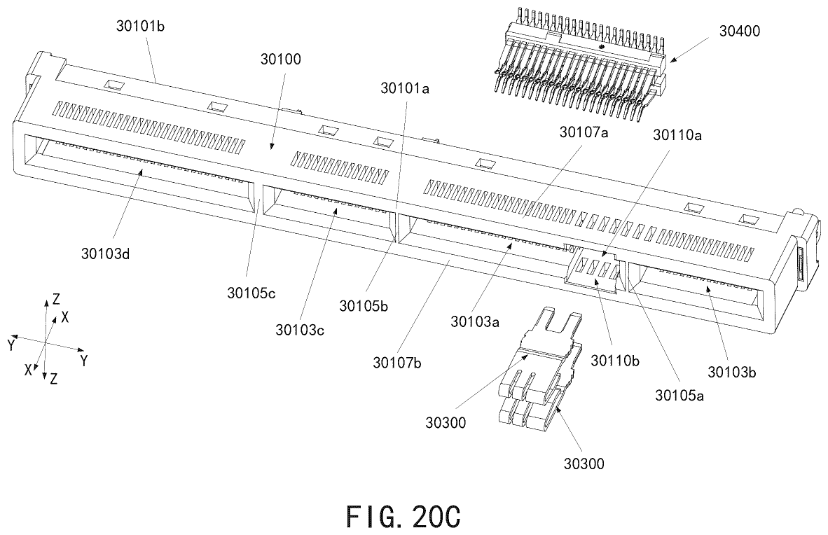

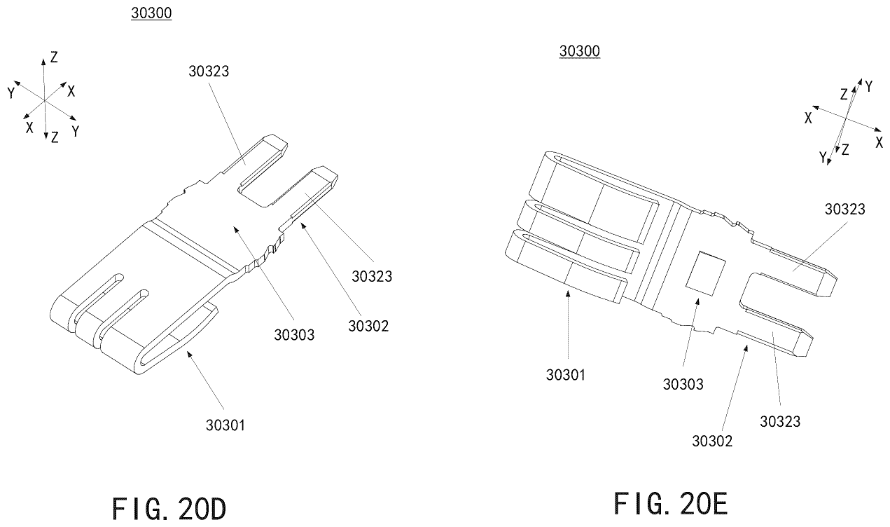

FIGS. 20A to 20E illustrate an electrical connector 30010 according to a fourth embodiment of the present application. Similar to FIGS. 4A to 19E, a lateral direction X-X, a longitudinal direction Y-Y, and a vertical direction Z-Z are defined in FIGS. 20A to 20E. The lateral direction X-X, the longitudinal direction Y-Y, and the vertical direction Z-Z are perpendicular to each other. The lateral direction X-X may refer to a width direction of the electrical connector 30010. The longitudinal direction Y-Y may refer to a length direction of the electrical connector 30010. The vertical direction Z-Z may refer to a height direction of the electrical connector 30010.

Similar to the electrical connector 10 shown in FIGS. 4A to 12B, the electrical connector 10010 shown in FIGS. 13A to 18G, and the electrical connector 20010 shown in FIGS. 19A to 19E, the electrical connector 30010 may be used in the electronic system 1 to mate with the electrical component 3 (e.g., the second circuit board 30 shown in FIGS. 2A and 2B and the second circuit board 30′ shown in FIGS. 3A and 3B). Thus, for the sake of brevity, those details included above may not be repeated.

As shown in FIGS. 4A to 19E and 20A to 20E, aspects of the electrical connector 30010 may be similar to those of the electrical connectors 10, 10010, and 20010. Thus, for parts or portions of the electrical connector 30010 that are identical or similar to those of the electrical connectors 10, 10010, and 20010, the identical or similar parts or portions of the electrical connector 30010 may be labeled in FIGS. 20A to 20E with the reference signs that label the parts or portions of the electrical connector 10 in FIGS. 4A to 12B plus “30000 (thirty thousand)” so as to label the identical or similar parts or portions of the electrical connector 30010. For the sake of brevity, the details of these identical or similar parts or portions may not be repeated.

As shown in FIGS. 20A to 20E, the electrical connector 30010 may be a card edge connector, specifically a vertical type (VT) connector. The electrical connector 30010 enables the aforementioned second circuit board 30 or 30′ and another circuit board to be arranged to be perpendicular to each other.

Similar to the electrical connectors 10, 10010, and 20010, the electrical connector 30010 includes an insulative housing 30100 and a plurality of conductive elements disposed in the insulative housing 30100.

As shown in FIGS. 20A to 20C, similar to the electrical connectors 10, 10010, and 20010, the insulative housing 30100 of the electrical connector 30010 includes a first face 30101a and a second face 30101b opposite to each other in the lateral direction X-X, and a first slot 30103a, a second slot 30103b, a third slot 30103c, and a fourth slot 30103d recessed into the insulative housing 30100 from the first face 30101a in the lateral direction X-X, respectively. The insert portions 36a, 36b, 36c, and 36d of the second circuit board 30 or 30′ may be inserted into the first slot 30103a, the second slot 30103b, the third slot 30103c, and the fourth slot 30103d, respectively. The second slot 30103b and the first slot 30103a are separated by the divider 30105a in the longitudinal direction Y-Y, the first slot 30103a and the third slot 30103c are separated by the divider 30105b in the longitudinal direction Y-Y, and the third slot 30103c and the fourth slot 30103d are separated by the divider 30105c in the longitudinal direction Y-Y.

Similar to the plurality of conductive elements of the electrical connector 20010, the plurality of conductive elements of the electrical connector 30010 includes a first group of conductive elements 30200a disposed in a first slot 30103a, a second group of conductive elements 30200b disposed in a second slot 30103b, a third group of conductive elements 30200c disposed in a third slot 30103c, and a fourth group of conductive elements 30200d disposed in the fourth slot 30103d. The first group of conductive elements 30200a, the second group of conductive elements 30200b, the third group of conductive elements 30200c, and the fourth group of conductive elements 30200d of the electrical connector 30010 may be similar to the first group of conductive elements 20200a, the second group of conductive elements 20200b, the third group of conductive elements 20200c, and the fourth group of conductive elements 20200d of the electrical connector 20010, respectively. Thus, for the sake of brevity, those details included above may not be repeated.

Each of the plurality of conductive elements of the electrical connector 30010 includes a mating end having a mating contact portion, a mounting end opposite to the mating end, and an intermediate portion connecting the mating end to the mounting end. The mating end may be configured to mate with a corresponding conductive portion of the electrical component 3 such as the aforementioned second circuit board 30 and 30′. Each conductive element is held in the insulative housing 30100 with the mating contact portion of the mating end exposed in a corresponding slot for electrical contact with a corresponding conductive portion of the second circuit board 30 or 30′. Unlike the plurality of conductive elements of the electrical connector 20010, the mating end of each of the plurality of conductive elements of the electrical connector 30010 is configured for a vertical mount application so as to mate with a corresponding conductive portion of another circuit board.

Taking the first group of conductive elements 30200a as an example, as shown in FIGS. 20A to 20C, the first group of conductive elements 30200a of the electrical connector 30010 includes first conductive elements 30300 and a plurality of second conductive elements 30400. Aspects of the mating end 30301 and the intermediate portion 30303 of the first conductive element 30300 of the electrical connector 30010 may be similar to those of the mating end 20301 and the intermediate portion 30303 of the electrical connector 30010, respectively. Thus, for the sake of brevity, those details included above may not be repeated.

The first conductive element 30300 differs from the first conductive element 20300 in that the mounting legs 30323 of the mounting end 30302 of the first conductive element 30300 are configured for a vertical mount application. In particular, the mounting legs 30323 of the first conductive elements 30300 extends from the insulative housing 30100 in the lateral direction X-X and are not curved.

Similar to the first conductive element 20300, the first conductive element 30300 is configured to be directly inserted into the insulative housing 30100, rather than to be held together with the plurality of second conductive elements 30400 in the insulative housing 30100 by a assembly housing. For example, the intermediate portion 30303 of the first conductive element 30300 may be configured to engage an inner wall of a corresponding channel of the insulative housing 30100 such that the first conductive element 30300 is held in the insulative housing 30100.

Aspects of the plurality of second conductive elements 30400 of the electrical connector 30010 may be similar to those of the plurality of second conductive elements 20400 of the electrical connector 20010, except for the different structures of the mounting ends. Thus, for the sake of brevity, those details included above may not be repeated.

The insulative housing 30100 of the electrical connector 30010 may be similar to the insulative housing 20100 of the electrical connector 20010. Thus, for the sake of brevity, those details included above may not be repeated. The insulative housing 30100 differs from the insulative housing 20100 in that the insulative housing 30100 is configured for a vertical mounting application. Similar to the insulative housing 20100, portions of the first wall 30107a and the second wall 30107b of the insulative housing 30100 adjacent to the divider 30105a do not protrude outwardly away from the first slot 30103a (e.g., the insulative housing 30100 does not have outwardly protruding portions); rather, the insulative housing 30100 includes the first channel 30110a and the second channel 30110b adjacent to the divider 30105a and extending into the first wall 30107a and the second wall 30107b in the vertical direction from the first slot 30103a, respectively. The first channel 30110a and the second channel 30110b serve the same purpose as the first channel 20110a and the second channel 20110b, and thus may not be repeated herein. It should be appreciated that in some other embodiments, the insulative housing 30100 may include portions similar to the first bulge 10109a and the second bulge 10109b.

### Fifth Exemplary Embodiment

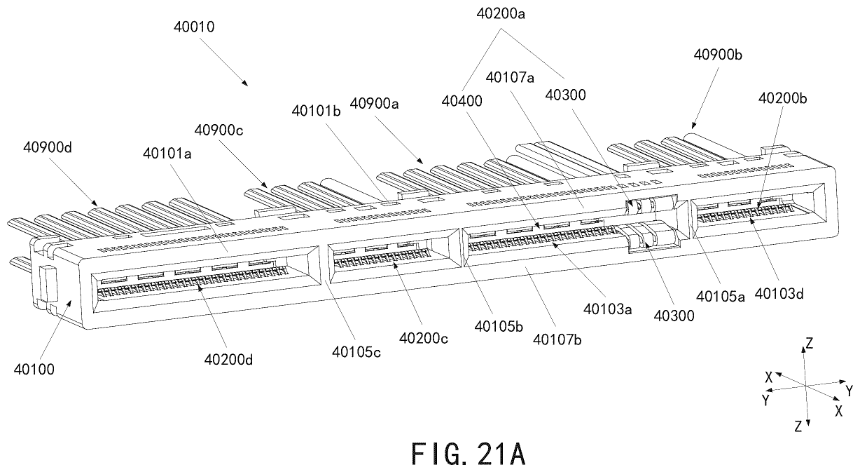

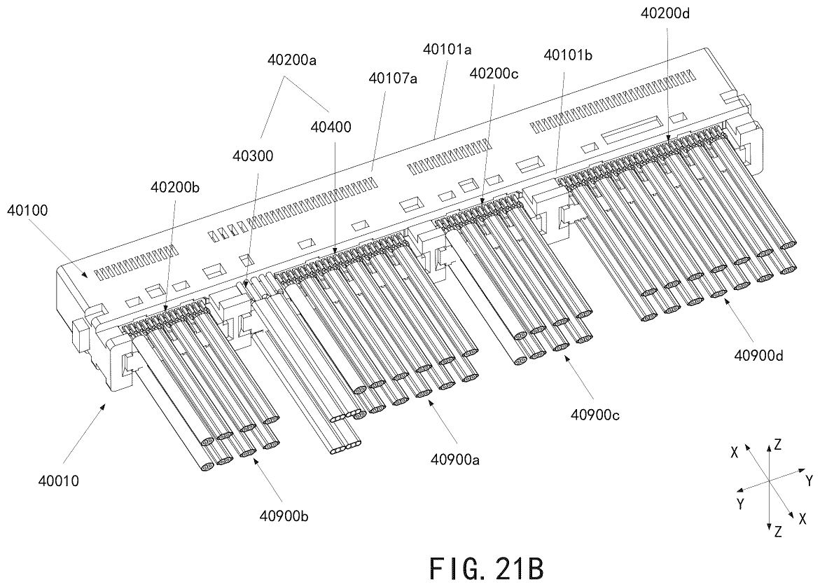

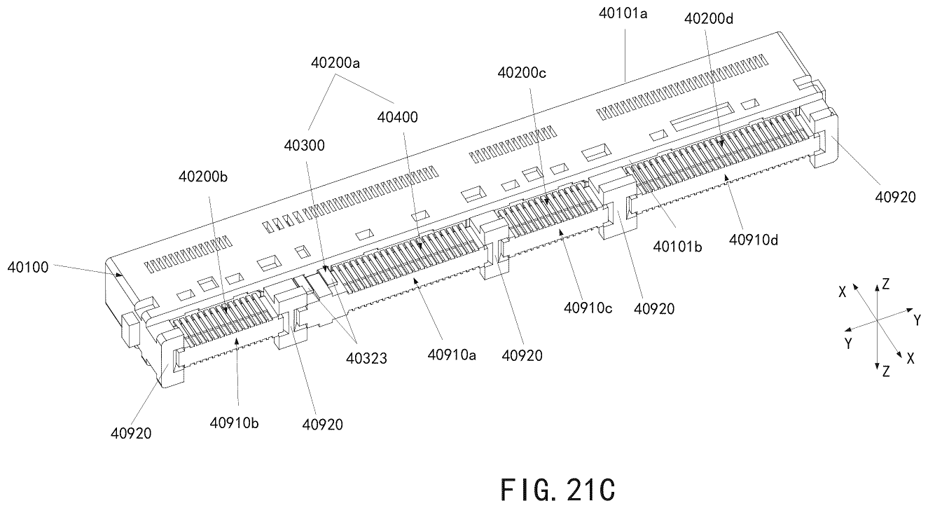

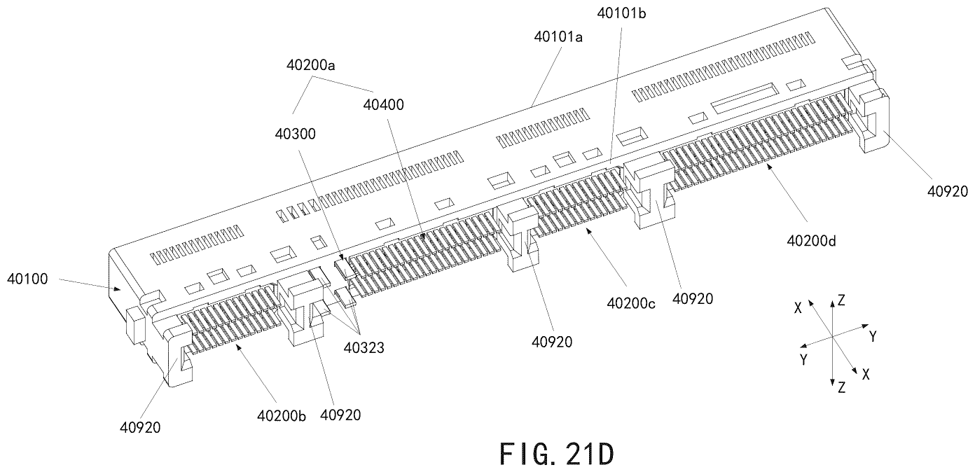

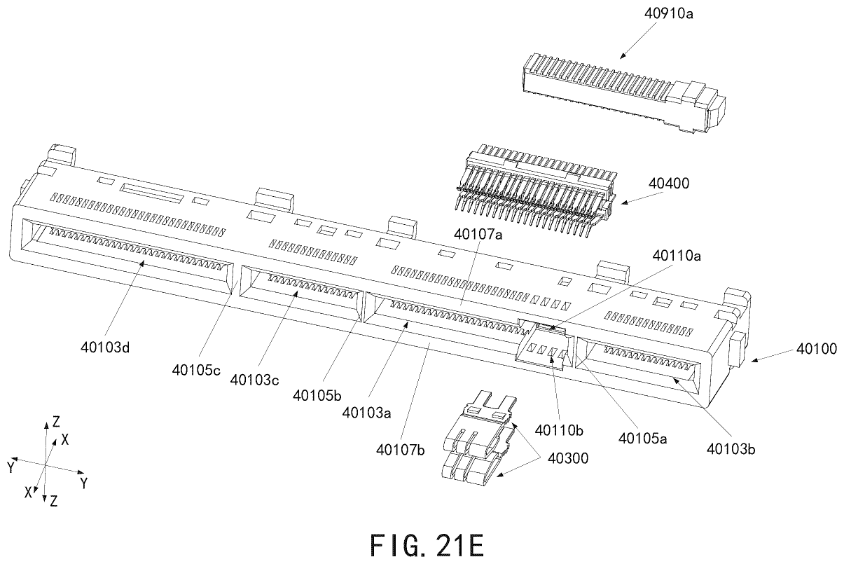

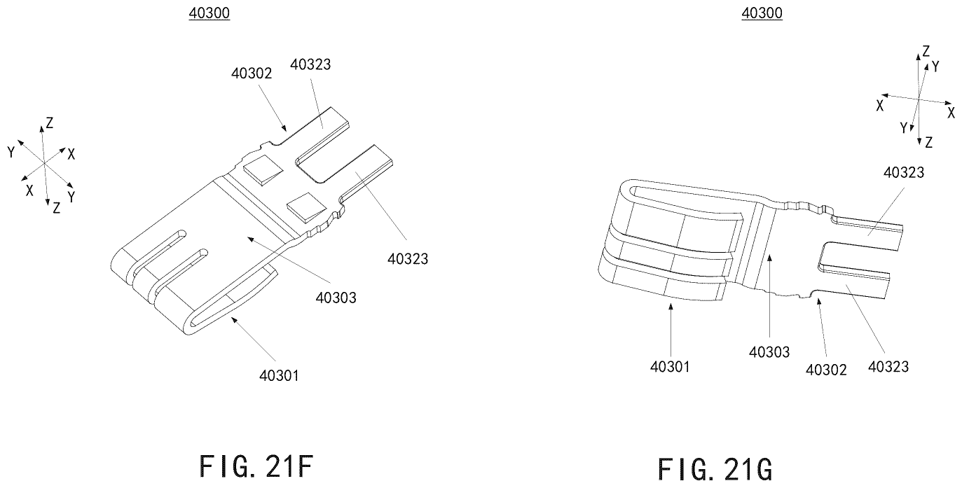

FIGS. 21A to 21G illustrate an electrical connector 40010 according to a fifth embodiment of the present application. Similar to FIGS. 4A to 20E, a lateral direction X-X, a longitudinal direction Y-Y, and a vertical direction Z-Z are defined in FIGS. 21A to 21G. The lateral direction X-X, the longitudinal direction Y-Y, and the vertical direction Z-Z are perpendicular to each other. The lateral direction X-X may refer to a width direction of the electrical connector 40010. The longitudinal direction Y-Y may refer to a length direction of the electrical connector 40010. The vertical direction Z-Z may refer to a height direction of the electrical connector 40010.

Similar to the electrical connector 10 shown in FIGS. 4A to 12B, the electrical connector 10010 shown in FIGS. 13A to 18G, the electrical connector 20010 shown in FIGS. 19A to 19E, and the electrical connector 30010 shown in FIGS. 20A to 20E, the electrical connector 40010 may be used in the electronic system 1 to mate with the electrical component 3 (e.g., the second circuit board 30 shown in FIGS. 2A and 2B and the second circuit board 30′ shown in FIGS. 3A and 3B). Thus, for the sake of brevity, those details included above may not be repeated.

As shown in FIGS. 4A to 20E and 21A to 21G, aspects of the electrical connector 40010 may be similar to those of the electrical connectors 10, 10010, 20010, and 30010. Thus, for parts or portions of the electrical connector 40010 that are identical or similar to those of the electrical connectors 10, 10010, 20010, and 30010, the identical or similar parts or portions of the electrical connector 40010 may be labeled in FIGS. 21A to 21G with the reference signs that label the parts or portions of the electrical connector 10 in FIGS. 4A to 12B plus “40000 (forty thousand)” so as to identify the identical or similar parts or portions of the electrical connector 40010. For the sake of brevity, the details of these identical or similar parts or portions may not be repeated.

As shown in FIGS. 21A to 21G, the electrical connector 40010 may be a card edge connector, specifically a cable type connector. The electrical connector 40010 enables the aforementioned second circuit board 30 or 30′ to be connected to a cable, thereby connecting the second circuit board 30 or 30′ to another electrical component via the cable. It should be appreciated that the cable may be part of the electrical connector 40010 or may be a separate component.

Similar to the electrical connectors 10, 10010, 20010, and 30010, the electrical connector 40010 includes an insulative housing 40100 and a plurality of conductive elements disposed in the insulative housing 40100.

As shown in FIGS. 21A to 21G, similar to the electrical connectors 10, 10010, 20010, and 30010, the insulative housing 40100 of the electrical connector 40010 includes a first face 40101a and a second face 40101b opposite to each other in the lateral direction X-X, and a first slot 40103a, a second slot 40103b, a third slot 40103c, and a fourth slot 40103d recessed into the insulative housing 40100 from the first face 40101a in the lateral direction X-X, respectively. The insert portions 36a, 36b, 36c, and 36d of the second circuit board 30 or 30′ may be inserted into the first slot 40103a, the second slot 40103b, the third slot 40103c, and the fourth slot 40103d, respectively. The second slot 40103b and the first slot 40103a are separated by the divider 40105a in the longitudinal direction Y-Y, the first slot 40103a and the third slot 40103c are separated by the divider 40105b in the longitudinal direction Y-Y, and the third slot 40103c and the fourth slot 40103d are separated by the divider 40105c in the longitudinal direction Y-Y.

Similar to the plurality of conductive elements of the electrical connector 20010, the plurality of conductive elements of the electrical connector 40010 includes a first group of conductive elements 40200a disposed in the first slot 40103a, a second group of conductive elements 40200b disposed in the second slot 40103b, a third group of conductive elements 40200c disposed in the third slot 40103c, and a fourth group of conductive elements 40200d disposed in the fourth slot 40103d. The first group of conductive elements 40200a, the second group of conductive elements 40200b, the third group of conductive elements 40200c, and the fourth group of conductive elements 40200d of the electrical connector 40010 may be similar to the first group of conductive elements 20200a, the second group of conductive elements 20200b, the third group of conductive elements 20200b, the third group of conductive elements 20200c and the fourth group of conductive elements 20200d, respectively. Thus, for the sake of brevity, those details included above may not be repeated.

Each of the plurality of conductive elements of the electrical connector 40010 includes a mating end having a mating contact portion, a mounting end opposite to the mating end, and an intermediate portion connecting the mating end to the mounting end. The mating end may be configured to mate with a corresponding conductive portion of the electrical component 3 such as the aforementioned second circuit board 30 and 30′. Each conductive element is held in the insulative housing 40100 with the mating contact portion of the mating end exposed in a corresponding slot for electrical contact with a corresponding conductive portion of the second circuit board 30 or 30′. Unlike the plurality of conductive elements of the electrical connector 20010, the mating end of each of the plurality of conductive elements of the electrical connector 40010 is configured to connect with a cable. As shown in FIG. 21B, the mounting ends of the first group of conductive elements 40200a, the second group of conductive elements 40200b, the third group of conductive elements 40200c, and the fourth group of conductive elements 40200d of the electrical connector 40010 are connected to a first group of cables 40900a, a second group of cables 40900b, a third group of cables 40900c, and a fourth group of cables 40900d, respectively. The first group of cables 40900a, the second group of cables 40900b, the third group of cables 40900c, and the fourth group of cables 40900d may be any suitable type of cables.

Taking the first group of conductive elements 40200a as an example, as shown in FIGS. 21A to 21G, the first group of conductive elements 40200a of the electrical connector 40010 includes first conductive elements 40300 and a plurality of second conductive elements 40400. Aspects of the mating end 40301 and the intermediate portion 40303 of the first conductive element 40300 of the electrical connector 40010 may be similar to those of the mating end 20301 and the intermediate portion 20303 of the first conductive element 20300 of the electrical connector 20010, respectively. Thus, for the sake of brevity, those details included above may not be repeated.

The first conductive element 40300 differs from the first conductive element 20300 in that the mounting legs 40323 of the mounting end 40302 of the first conductive element 40300 are configured to connect with a cable.

Similar to the first conductive element 20300 of the electrical connector 20010, the first conductive element 40300 is configured to be directly inserted into the insulative housing 40100, rather than to be held together with the plurality of second conductive elements 40400 in the insulative housing 40100 by a assembly housing. For example, the intermediate portion 40303 of the first conductive element 40300 may be configured to engage an inner wall of a corresponding channel of the insulative housing 40100 such that the first conductive element 40300 is held in the insulative housing 40100.

Aspects of the plurality of second conductive elements 40400 of the electrical connector 40010 may be similar to those of the plurality of second conductive elements 20400 of the electrical connector 20010, except for the difference structures of the mounting ends. Thus, for the sake of brevity, those details included above may not be repeated.

The insulative housing 40100 of the electrical connector 40010 may be similar to the insulative housing 20100 of the electrical connector 20010. Thus, for the sake of brevity, those details included above may not be repeated. The insulative housing 40100 differs from the insulative housing 20100 in that the insulative housing 40100 is configured for a cable connection application. Similar to the insulative housing 20100, portions of the first wall 40107a and the second wall 40107b of the insulative housing 40100 adjacent to the divider 40105a do not protrude outwardly away from the first slot 40103a (e.g., the insulative housing 40100 does not have outwardly protruding portions); rather, the insulative housing 40100 includes the first channel 40110a and the second channel 40110b adjacent to the divider 40105a and extending into the first wall 40107a and the second wall 40107b in the vertical direction from the first slot 40103a, respectively. The first channel 40110a and the second channel 40110b serve the same purpose as the first channel 20110a and the second channel 20110b, and thus may not be repeated herein. It should be appreciated that in some other embodiments, the insulative housing 40100 may include portions similar to the first bulge 10109a and the second bulge 10109b.

The electrical connector 40010 further differs from the electrical connector 20010 in that the electrical connector 40010 includes a first mounting end support member 40910a, a second mounting end support member 40910b, a third mounting end support member 40910c, and a fourth mounting end support member 40910d. The first mounting end support member 40910a, the second mounting end support member 40910b, the third mounting end support member 40910c, and the fourth mounting end support member 40910d may be mounted to the insulative housing 40100 and support the mounting ends of the first group of conductive elements 40200a, the mounting ends of the second group of conductive elements 40200b, the mounting ends of the third group of conductive elements 40200c, and the mounting ends of the fourth group of conductive elements 40200d, respectively. This facilitates the connection of corresponding cables with the mounting ends. An overmold member (not shown) may be disposed on the insulative housing 40100 after the cables are connected to the mounting ends of the conductive elements to surround and secure the connection site. As shown in FIGS. 21C and 21D, the first mounting end support member 40910a, the second mounting end support member 40910b, the third mounting end support member 40910c, and the fourth mounting end support member 40910d may be held by retention arms 40920 extending from the second face 40101b of the insulative housing 40100 in the lateral direction X-X so as to be mounted to the insulative housing 40100.

Although details of specific configurations of the electronic system 1 and the electrical connector 10, 10010, 20010, 30010, 40010 are described above, it should be appreciated that such details are provided solely for purposes of illustration, as the concepts disclosed herein are capable to be implemented in other manners. In that respect, the various electronic system 1 and electrical connector, 10010, 20010, 30010, 40010 designs described herein may be used in any suitable combination, as aspects of the present disclosure are not limited to the particular combinations shown in the drawings.

### CONCLUSION

The present disclosure has been described by the above embodiments, but it should be understood that a variety of variations, modifications and improvements may be made according to the teaching of the present disclosure by those skilled in the art, and all of these variations, modifications and improvements fall within the spirit and the scope of protection of the present disclosure. The scope of protection of the present disclosure is defined by the appended claims and its equivalent scope. The above embodiments are only for the purpose of illustration and description, and are not intended to limit the present disclosure to the scope of the described embodiments.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. An electrical connector, comprising:
a housing comprising a mating face having an upper wall and a lower wall, first and second slots in the mating face and between the upper wall and lower wall, and a divider joining the upper wall and lower wall and separating the first slot and second slot, wherein the upper wall comprises a first channel connected to the first slot, and the lower wall comprises a second channel connected to the first slot; and
a plurality of conductive elements held by the housing, each of the plurality of conductive elements comprising a mating end having a mating contact portion curving into the first slot or the second slot, a mounting end opposite to the mating end, and an intermediate portion joining the mating end and the mounting end, wherein:
the plurality of conductive elements comprise first conductive elements and second conductive elements;
each first conductive element is wider than each second conductive element; and
the first conductive elements are disposed in the first channel or second channel.

2. The electrical connector of claim 1, wherein:
the first conductive elements are configured for power transmission in the range of 25 W to 200 W; and
the second conductive elements are configured for signal transmission at a speed in the range of 25 GT/s to 112 GT/s.

3. The electrical connector of claim 1, wherein:
the first conductive elements are disposed between a first portion of the second conductive elements and a second portion of the second conductive elements;
the mating contact portions of the mating ends of the first portion of the second conductive elements and the first conductive elements curve into the first slot; and
the mating contact portions of the mating ends of the second portion of the second conductive elements curve into the second slot.

4. The electrical connector of claim 1, wherein:
the mating contact portions of the plurality of first conductive elements are disposed in first rows on opposite sides of the first slot;
the mating contact portions of the plurality of second conductive elements are disposed in second rows aligned with respective first rows; and
the mating contact portion of each first conductive element is wider than the mating contact portion of each second conductive element.

5. The electrical connector of claim 1, wherein for each first conductive element:
the mating end comprises a first contact finger and two second contact fingers;
the first contact finger comprises a mating contact portion;
each of the two second contact fingers comprises a mating contact portion narrower than the mating contact portion of the first contact finger; and
the first contact finger is disposed closer to the divider than the two second contact fingers.

6. The electrical connector of claim 5, wherein:
the mating contact portions of the first contact finger and an adjacent second contact finger of the two second contact fingers are separated from each other by a first pitch; and
the mating contact portions of the two second contact fingers are separated from each other by a second pitch that is less than the first pitch.

7. The electrical connector of claim 5, wherein:
the mounting end comprises mounting legs extending from the intermediate portion out of the housing, and the intermediate portion comprises an edge extending between the mounting legs.

8. The electrical connector of claim 7, wherein:
the housing comprises an integral member configured to retain the first conductive element in the housing; and
the integral member of the housing comprises openings through which the mounting legs extend out of the housing.

9. The electrical connector of claim 1, wherein:
the upper wall of the housing comprises a first bulge bounding the first channel; and
the lower wall of the housing comprises a second bulge bounding the second channel.

10. The electrical connector of claim 1, wherein:
each first conductive element comprises a plurality of metal sheets.

11. The electrical connector of claim 1, wherein:
each first conductive element is thicker than each second conductive element.

12. An electronic system comprising:
the electrical connector of claim 1; and
a printed circuit board comprising an edge inserted into the electrical connector, the edge of the printed circuit board comprising a first portion inserted into the first slot of the electrical connector, a second portion inserted into the second slot of the electrical connector, and a notch receiving the divider, the first portion of the edge comprising signal contact pads and at least one power contact pad aligned along the edge, wherein:
each of the at least one power contact pad spans a width that corresponds to a plurality of the signal contact pads.

13. A lead assembly comprising:
a unitary housing comprising a first segment and a second segment extending from the first segment;
a plurality of first conductive elements held by the first segment of the housing, each of the plurality of first conductive element comprising a mating end having a mating contact portion, a mounting end opposite to the mating end, and an intermediate portion joining the mating end to the mounting end; and
a plurality of second conductive elements held by the second segment of the housing, each of the plurality of second conductive element comprising a mating end having a plurality of mating contact portions, a mounting end opposite to the mating end, and an intermediate portion joining the mating end to the mounting end, wherein:
the mating contact portions of the plurality of second conductive elements are separated from each other by a center-to-center distance; and
for each of the plurality of first conductive elements, the mating contact portions are separated from each other by a center-to-center distance that is greater than the center-to-center distance of the mating contact portions of the plurality of second conductive elements.

14. The lead assembly of claim 13, wherein:
each mating contact portion of the plurality of first conductive element is wider than the mating contact portion of each of the plurality of second conductive element.

15. The lead assembly of claim 13, wherein:
each of the plurality of first conductive elements is configured for power transmission; and
at least a portion of the plurality of second conductive elements is configured for signal transmission.

16. The lead assembly of claim 13, wherein for each first conductive element:
the mating end comprises a first contact finger and a second contact finger narrower than the first contact finger and disposed closer to the plurality of second conductive elements than the first contact finger.

17. The lead assembly of claim 16, wherein:
the intermediate portion is disposed on the first segment of the housing;
each of the first contact finger and second contact finger comprises a straight portion, a curved portion, and a mating contact portion; and
for each of the first contact finger and second contact finger:
the straight portion extends from the intermediate portion away from the first segment of the housing;
the curved portion connects the straight portion and the contact portion; and
the mating contact portion extends from the curved portion towards the first segment of the housing.

18. The lead assembly of claim 16, wherein for each first conductive element:
the mounting end comprises two mounting legs each extending from the intermediate portion, the two mounting legs comprising opposing edges;
the intermediate portion comprises an edge extending between the two mounting legs; and
the first segment of the housing comprises a supporting portion having a protrusion extending into a space between the two mounting legs and abutting both the opposing edges of the two mounting legs and the edge of the intermediate portion.

19. The lead assembly of claim 18, wherein:
the first segment of the housing further comprises a retaining portion extending from the supporting portion; and
the retaining portion surrounds and retains a portion of each of the two mounting legs of the first conductive element.

20. A printed circuit board comprising:
a first surface;
a second surface opposite the first surface; and
an edge joining the first surface and second surface, wherein:
each of the first surface and second surface comprises a plurality of contact pads aligned along the edge joining the first surface and second surface; and
a first portion of the plurality of contact pads are disposed according to a standard and comprise a power contact pad spanning locations of a plurality of contact pads according to the standard.
